(19) United States
(12) Patent Application Publication
(10) Pub. No.: US 2008/0163073 A1
(43) Pub. Date: Jul. 3, 2008

(54) SYSTEM AND METHOD FOR PROVIDING MULTIPLE PARTICIPANTS WITH A CENTRAL ACCESS PORTAL TO GEOGRAPHIC POINT OF INTEREST DATA

(75) Inventors: Mary R. Becker, Fairlee, VT (US); Craig Patrick Sabbey, Lebanon, NH (US); Jay W. Undercoffler, Grantham, NH (US); Richard Cohen, Norwich, VT (US); Rik Temmink, Wokingham (GB); David Goldberg, West Lebanon, NH (US); Michelle Jones, Enfield, NH (US); Roger W. Brown, West Lebanon, NH (US); Jennifer Parker, Manchester, NH (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 11/939,435

(22) Filed: Nov. 13, 2007

Related U.S. Application Data
(60) Provisional application No. 60/858,613, filed on Nov. 13, 2006.
(60) Provisional application No. 60/949,757, filed on Jul. 13, 2007.

(51) Int. Cl. G06F 3/048; G06F 15/16

(52) U.S. Cl. 715/753

(57) ABSTRACT

A system and method of providing multiple participants with a centrally accessible content portal for geographic point of interest (POI) data, for subsequent use in creating map-based or spatial applications. Different entities can dynamically upload, update, retrieve, and use digital map and POI data. Additional features include the ability to handle the large amounts of POI data needed by multiple Application Developers, including data that is dynamic, or frequently changing; the ability to update POI attribute information and deliver it to the Application Developers; the ability to associate multiple points of entry (POE) with a POI, and to aggregate data from multiple Content Providers; and the use of a common geocoding engine and common digital map reference across all Content Providers, which ensures the consistency of the geocoding throughout all the POI data.

### CLAIM OF PRIORITY

This application claims the benefit of U.S. Provisional Patent Application titled “SYSTEM AND METHOD FOR PROVIDING MULTIPLE PARTICIPANTS WITH A CENTRAL ACCESS PORTAL TO GEOGRAPHIC POINT OF INTEREST DATA”; Inventors: Mary R. Becker, Roger Brown, Jennifer Parker LaFlamme, Craig Sabbey, Jay Undercoffler, Richard Cohen, and Rik Temmink; Application No. 60/858,613; Filed Nov. 13, 2006; and also claims the benefit of U.S. Provisional Patent Application titled “SYSTEM AND METHOD FOR PROVIDING MULTIPLE PARTICIPANTS WITH A CENTRAL ACCESS PORTAL TO GEOGRAPHIC POINT OF INTEREST DATA”; Inventors: Mary R. Becker, Craig Patrick Sabbey, Jay W. Undercoffler, Richard Cohen, Rik Temmink, David Goldberg, Roger W. Brown and Jennifer Parker; Application No. 60/949,757; Filed Jul. 13, 2007; each of which applications are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is generally related to electronic maps, electronic documents, and electronic databases, and specifically to a system and method for providing multiple participants with a central access portal to geographic point of interest (POI) data, for subsequent use in creating map-based software applications.

### BACKGROUND

The use of digital geographic or map data has become commonplace in modern society. Commonly referred to as “electronic maps” or “digital maps”, the map data is used in a wide variety of applications. A typical application is within the travel industry, where digital maps are used to research travel destinations, resort facilities, and alternate routes. Internet-based companies often use digital maps to direct customers to theaters, stores, restaurants, and other commercial businesses. Digital maps are also often used in industrial settings, for example, to calculate routes for delivery drivers, or to provide directions for emergency and medical crews to follow when responding to emergency calls.

Increasingly, digital maps have included a greater variety of data content, including additional points of interest (PO's) such as street addresses, buildings, transportation networks, water bodies, parklands, other three-dimensional objects, political districts, census data, demographic information, commercial businesses, and entertainment facilities, for the purpose of supporting the latest applications. The variety of different uses for the map data has also expanded to include such applications as in-car driving assistance; PDA-based navigation; access from mobile and cellular telephones, and locally-focused news, media, and information services. With this increase in utility it has become evident that many of the latest software applications need to combine the underlying map data with other sources of location-related information to provide a useful end-product.

To date, no single company has been able to meet the growing demand for precise positional accuracy and regularly updated information about the newest business, recreational, and critical services. The job of collecting, validating, categorizing, and geocoding individual POI information has largely remained a manual task, dependent upon applications from multiple different corporate entities, each of which may use their own diverse taxonomies, and their unique geocoding engines. Some of the problems that are particularly relevant to delivering POI content include:

The collection and validation of POI data includes large amounts of data, and much of that data is dynamic, or frequently changing. For example, on any given day thousands of POIs, such as business establishments, may be opened, closed, or re-branded.

POI attribute information (for example, a business' hours of operation, inventory, amenities, or use restrictions) must be captured and maintained. This information is of critical importance to both the navigation environment and anybody else who may interact with those POIs. Attribute information must not only be collected when the POI is initially entered into the database, but must be subsequently maintained and updated, sometimes several times a day.

Present systems afford little or no support for a POI to include multiple points of entry (POE) into the location. For example, a POI such as a hospital, airport or shopping center will usually have multiple points of entering the facility, but these multiple entryways are often not entered in the database.

When POI data is aggregated from multiple Content Providers, using the POI data requires an initial searching for those varied sources, i.e. finding out which sources offers which location data for that particular Application Developer to use. However, once the sources are found and acquired, there is no common terminology among the divergent content. This requires the Application Developer to devote efforts to sort, parse, and merge the content data sets. The Application Developer must then maintain separate lists of who, when, and how they last downloaded a particular data component.

When geocoding is used in a traditional manner, the content is geocoded off-line and then returned to the provider for review. However, using traditional methods there is often a large time lapse of several days between the initial collection and the final delivery of the geocoded content.

Since different or divergent geocoding engines are often used, many of today's POI systems offer sets of content that have not been geocoded. Even if they have been geocoded, they may have been geocoded against different map databases, from different map providers. As such, there is no way to determine the consistency of the geocoding results from one set of content to another, or how the geocoding will mesh with the particular mapping engine that a software Application Developer will later use.

Since POI Content Providers have had to rely on diverse sources for geocoding, editing and distribution of their content, there is no central point for Content Providers to geocode, update, edit, and then distribute their content. Similarly, Application Developers who may later want to use the POI data have no central point that offers them diverse POI content, geocoded on a unified geocoding engine and a single map source. Nor do Application Developers have any way to manage their content subscriptions across multiple content data sets and Content Providers.

Generally speaking, POI content data sets are offered only on a piece-meal basis, with no global categorization, and no consistent geocoding sources.

The above areas are some of those which embodiments of the present invention are designed to address.

### SUMMARY OF THE INVENTION

Described herein is a system and method of providing multiple participants with a centrally accessible content portal for geographic point of interest (POI) data, for subsequent use in creating map-based or spatial applications. In accordance with an embodiment, the system allows different entities to dynamically upload, update, retrieve, and use digital map and POI data. Advantages of the present invention include the ability to handle the large amounts of POI data needed by multiple Application Developers, even though much of that data is dynamic, or frequently changing; the ability to update POI attribute information and deliver it to the Application Developer; the ability to associate multiple points of entry (POE) with a POI, and to aggregate data from multiple Content Providers; and the use of a common geocoding engine and common digital map reference across all Content Providers, which ensures the consistency of the geocoding throughout all the POI data.

### BRIEF DESCRIPTION OF THE FIGURES

FIG. 1 shows an illustration of a system in accordance with an embodiment, including a portal, for providing multiple participants with a central access portal to geographic point of interest (POI) data.

FIG. 2 shows another illustration of a system in accordance with an embodiment, including a portal, for providing multiple participants with a central access portal to geographic point of interest (POI) data.

FIG. 3 shows a flowchart of a method for uploading or creating POI content for subsequent use with a central portal in accordance with an embodiment.

FIG. 4 shows a flowchart of a method for modifying POI content at a central portal in accordance with an embodiment.

FIG. 5 shows a flowchart of a method for managing subscriptions to POI content at a portal in accordance with an embodiment.

FIG. 6 shows a screenshot 402 of a POI content portal in accordance with an embodiment, including initial login fields. It also shows that any user can search for and view content sets that are published in the catalog via company, date or keyword search.

FIG. 7 shows a screenshot 403 of a Content Provider's POI content portal in accordance with an embodiment once a user, in this case a Content Provider, has logged into the system. This Content Provider screen shows how a Content Provider can access additional screens via tabs to manage their POI content and the subscribers to that content.

FIG. 8 shows a screenshot 406 of a Content Provider's POI content portal in accordance with an embodiment, including a screen that displays all the POI content data sets provided by a particular Content Provider and managed by that Content Provider, with a high level descriptive summary of each content, including the overall geocode quality of the content, geographic coverage, upload status and overall Application Developer use of content.

FIG. 9 shows a screenshot 408 of a Content Provider's POI content portal in accordance with an embodiment, including a Content Provider screen, and illustrates the ability to upload a content set. In some embodiments of the invention, the system allows a Content Provider to input content description, keywords, specify a URL, determine file format, whether or not to geocode, to include attributes in validation, to select categories, to associate an icon with a specific set of content and allows the user to select the Field Map option. In some embodiments of the invention, the system provides an API for the automated upload/download of content sets.

FIG. 10 shows a screenshot 410 of a Content Provider's POI content portal in accordance with an embodiment, including a Content Provider screen, and illustrates the ability of a Content Provider to choose to map their content column headers to the required ContentLink column headers.

FIG. 11 shows a screenshot 414 of a Content Provider's POI content portal in accordance with an embodiment, including a Content Provider screen, and illustrates the ability of a Content Provider to choose to map their content column headers to the required ContentLink column headers.

FIG. 12 shows a screenshot 416 of a Content Provider's POI content portal in accordance with an embodiment, including a Content Provider screen, together with downloadable Upload Error reports, and with an upload status icon in the background.

FIG. 13 shows a screenshot 420 of a Content Provider's POI content portal in accordance with an embodiment, including a Content Provider screen, and illustrates the ability to manage content icons via add, edit or delete.

FIG. 14 shows a screenshot 422 of a Content Provider's POI content portal in accordance with an embodiment, including a Content Provider screen, which displays a summary of the geographic coverage, categories, and attributes of the POI within a content data set and summary of the quality of the geocoding for the content set. As shown in FIG. 14, this screen also allows a Content Provider to manage the visibility and access state of a specific content set, and to view and optionally download icons that are associated with this content. A Content Provider can also access multiple tabs/screens that allow them to edit and to validate individual POI, and to manage subscribers and monitor usage for the content set. It will be illustrated in a separate screen within the Application Developer functionality that a modification with read-only access with the exception of the ability to download icons, of this Content Summary screen is available to an Application Developer.

FIG. 15 shows a screenshot 424 of a Content Provider's POI content portal in accordance with an embodiment, including a Content Provider screen, which shows how a Content Provider can disable a content set, maintaining it and all of it's user history, but preventing any subscribers use or action including viewing editing and downloading from being taken on that disabled set. In an embodiment, the content is enabled by clicking on the “enable” button.

FIG. 16 shows a screenshot 426 of a Content Provider's POI content portal in accordance with an embodiment, including a Content Provider dialog, which shows that a Content Provider can replace all of the entries within a content set, or optionally to update a content set, while maintaining the meta-data and user history. In an embodiment, a Content Provider may use an API to automate the replace functionality.

FIG. 17 shows a screenshot 428 of a Content Provider's POI content portal in accordance with an embodiment, including a Content Provider screen, which shows that a Content Provider can delete a specific content set from the system.

FIG. 18 shows a screenshot 432 of a Content Provider's POI content portal in accordance with an embodiment, including a Content Provider dialog, which shows that a Content Provider can edit the general information for a content set, including associating content with icons including a KMZ icon.

FIG. 19 shows a screenshot 434 of a Content Provider's POI content portal in accordance with an embodiment, including a Content Provider dialog, which allows a Content Provider to select the tags that will be utilized in catalog searches.

FIG. 20 shows a screenshot 436 of a Content Provider's POI content portal in accordance with an embodiment, including a Content Provider dialog, which allows a Content Provider to determine whether the content will be published in the catalog and whether that content will be freely available or available only by subscription. It will be evident that a Content Provider does not have to publish in the catalog to grant access to a subscribing Application Developer.

FIG. 21 shows a screenshot 440 of a Content Provider's POI content portal in accordance with an embodiment, including a Content Provider screen, which allows a Content Provider to download icons that they have associated with this content. It will be illustrated in a separate screen within the Application Developer functionality that a modification of this Content Summary screen is available to an Application Developer.

FIG. 22 shows a screenshot 442 of a Content Provider's POI content portal in accordance with an embodiment, including a screen that allows a Content Provider to view the list of POI with a view of those points on map. In an embodiment of the system, the Content Provider is able to page through their content set and to set the number of locations to be viewed on the map. It will be illustrated in a separate screen within the Application Developer functionality that, in accordance with an embodiment, a modification (read-only) of this Location List screen is available to an Application Developer.

FIG. 23 shows a screenshot 444 of a Content Provider's POI content portal in accordance with an embodiment, including a screen that allows a Content Provider to page through the content set and to show a different map view based on the POI now presented in the list. It will be illustrated in a separate screen within the Application Developer functionality that in accordance with an embodiment, a modification (read-only) of this Location List screen is available to an Application Developer

FIG. 24 shows a screenshot 448 of a Content Provider's POI content portal in accordance with an embodiment, including a Content Provider's dialog that allows a Content Provider to filter the POI so that a subset of the POI is returned for review or for download. It will be illustrated in a separate screen within the Application Developer functionality that, in accordance with an embodiment, a modification (read-only) of this Location List screen is available to an Application Developer.

FIG. 25 shows a screenshot 450 of a Content Provider's POI content portal in accordance with an embodiment, including a screen that shows a filtered subset of the POI that has been returned for review or for download and shows the ability to turn off that filter. It will be illustrated in a separate screen within the Application Developer functionality that, in accordance with an embodiment, a modification (read-only) of this Location List screen is available to an Application Developer.

FIG. 26 shows a screenshot 452 of a Content Provider's POI content portal in accordance with an embodiment, including a Content Provider's dialog that allows a Content Provider to download a subset of the POI, either by means of the filtered choice, manually selected POI, or the entire content set. It will be illustrated in a separate screen within the Application Developer functionality that, in accordance with an embodiment, a modification (read-only) of this Location List screen is available to an Application Developer.

FIG. 27 shows a screenshot 456 of a Content Provider's POI content portal in accordance with an embodiment, including a Content Provider's dialog that allows a Content Provider to select the download format. It will be evident that other formats can be used in addition to those shown. It will be illustrated in a separate screen within the Application Developer functionality that, in accordance with an embodiment, a modification (read-only) of this Location List screen is available to an Application Developer.

FIG. 28 shows a screenshot 460 of a Content Provider's POI content portal in accordance with an embodiment, including a screen that allows a Content Provider to select either by filter criteria, manual selection, or all of the POI in the content set, specific POI to which to apply a specific category.

FIG. 29 shows a screenshot 464 of a Content Provider's POI content portal in accordance with an embodiment, including a screen that allows a Content Provider to select POI for validation either by filter criteria, manual selection, or all of the POI in the content set.

FIG. 30 shows a screenshot 466 of a Content Provider's POI content portal in accordance with an embodiment, including a Content Provider's Add Address dialog that allows a Content Provider to add a new POI to the content set by entering address information, to optionally allow the new entry to be geocoded, and to add all attributes including points of entry. The new entry is immediately available to subscribers to the content set.

FIG. 31 shows a screenshot 468 of a Content Provider's POI content portal in accordance with an embodiment, including a Content Provider Manually Place Position dialog that allows a Content Provider to add a new POI to the content set and to set the address precision of the newly added POI, by entering a latitude and longitude to add a new POI to the content set and then setting the Precision appropriately. Alternatively, the Content Provider can click and drag the map icon to the correct location for the POI and the latitude and longitude fields will populate accordingly. Once the Content Provider saves this dialog, the Content Provider can then enter all of the attribute information including points of entry and address text information. Once the entry is saved, the portal makes the new entry immediately available to subscribing Application Developers.

FIG. 32 shows a screenshot 470 of a Content Provider's POI content portal in accordance with an embodiment, including a screen that allows a Content Provider to manually select locations for deletion from the content set. Optionally, the Content Provider can also use the filter functionality to select a subset of the content for deletion. The updated content set is immediately available to subscribed users.

FIG. 33 shows a screenshot 472 of a Content Provider's POI content portal in accordance with an embodiment, including a screen that allows a Content Provider to choose multiple POI entries for editing. Optionally the Content Provider can utilize the filter functionality to select a subset of the content for editing.

FIG. 34 shows a screenshot 474 of a Content Provider's POI content portal in accordance with an embodiment, including a screen that allows a Content Provider multiple means to update the geographic location of the POI location, to update the attributes of a selected POI location, or to add or delete points of entry.

FIG. 35 shows a screenshot 476 of a Content Provider's POI content portal in accordance with an embodiment, including a Content Provider's dialog that gives a Content Provider the details of the geocoding.

FIG. 36 shows a screenshot 478 of a Content Provider's POI content portal in accordance with an embodiment, including a screen that allows a Content Provider to report geocoding issues directly from the portal.

FIG. 37 shows a screenshot 482 of a Content Provider's POI content portal in accordance with an embodiment, including a screen that allows for a Content Provider to see when a POI location has been last validated and who submitted the most recent validation information.

FIG. 38 shows a screenshot 484 of a POI content portal in accordance with an embodiment, including a screen that allows a Content Provider to create multiple points of entry for a POI location, and to give each of the point of entry a specific name.

FIG. 39 shows a screenshot 490 of a POI content portal in accordance with an embodiment, including a screen with a Content Provider Validation Tab, together with a summary of POI locations that have been validated and returned to the system, and are awaiting action from the Content Provider. The Content Provider can select all or a subset of the returned POI locations for review by using the check boxes or by utilizing the filter dialog. The Content Provider can then choose to review, accept or reject the changes that have been submitted. Alternatively, the Content Provider can flag POI locations for future work.

FIG. 40 shows a screenshot 492 of a POI content portal in accordance with an embodiment, including a screen with a Content Provider Validation Tab, together with a summary of POI locations that are still open or out for validation and the corresponding Validation Wizard URL. The Content Provider can select all or a subset of the open POI locations by using the check boxes or the filter dialog. Alternatively, the Content Provider can flag POI locations for future work or review. The Content Provider can also close POI locations from the validation process.

FIG. 41 shows a screenshot 496 of a POI content portal in accordance with an embodiment, including a Content Provider filter dialog that allows a Content Provider to filter POI locations in either their Opened or Returned validation lists.

FIG. 42 shows a screenshot 502 of a POI content portal in accordance with an embodiment, including a screen that allows a Content Provider to review a POI location that has been returned from the validation process, together with the Content Provider's action buttons including Skip, Flag & Skip, Reject and Accept. The Content Provider can view both the POI information that is currently contained in the content set and that was sent to the location manager, and the information that has been returned by the location manager to the Content Provider. The Content Provider can then take the appropriate action to skip, flag, reject, or to accept the returned information. In an embodiment, a Content Provider may further edit the returned information before accepting that information.

FIG. 43 shows a screenshot 504 of a POI content portal in accordance with an embodiment, including a screen for a Validation Wizard, in particular Page 1 of the Location Managers Validation Wizard showing a choice of languages.

FIG. 44 shows a screenshot 506 of a POI content portal in accordance with an embodiment, including another screen for the Location Managers Validation Wizard that presents the address information of the location for confirmation of the location's continued existence.

FIG. 45 shows a screenshot 508 of a POI content portal in accordance with an embodiment, including another screen for the Location Managers Validation Wizard that presents the address information of the location for confirmation.

FIG. 46 shows a screenshot 512 of a POI content portal in accordance with an embodiment, including another screen for the Location Managers Validation Wizard that presents an interactive map showing the geocoded point of the location for confirmation, which can be corrected by the user by clicking on the map icon and moving that icon to the correct point. The user can also reset the map icon to its original point.

FIG. 47 shows a screenshot 514 of a POI content portal in accordance with an embodiment, including another screen for the Location Managers Validation Wizard, which, at the discretion of the Content Provider, presents the attributes (non-geographic location information) to the user for confirmation.

FIG. 48 shows a screenshot 518 of a POI content portal in accordance with an embodiment, including another screen for the Location Managers Validation Wizard which presents a page that the user can optionally input contact information and additional information about the location.

FIG. 49 shows a screenshot 520 of a POI content portal in accordance with an embodiment, including another screen for the Location Managers Validation Wizard, which presents a summary of the information including any changes that have been made by the user.

FIG. 50 shows a screenshot 522 of a POI content portal in accordance with an embodiment, including another screen for the Location Managers Validation Wizard acknowledgment that the changes by the user have been submitted.

FIG. 51 shows a screenshot 524 of a POI content portal in accordance with an embodiment, including another screen for the Location Managers Validation Wizard that presents the address information of the location for confirmation that the location no longer exists.

FIG. 52 shows a screenshot 530 of a POI content portal in accordance with an embodiment, including similar pages in the wizard for use in the Italian language.

FIG. 53 shows another screenshot 532 of a POI content portal in accordance with an embodiment, for use in the Italian language.

FIG. 54 shows another screenshot 534 of a POI content portal in accordance with an embodiment, for use in the Italian language.

FIG. 55 shows another screenshot 540 of a POI content portal in accordance with an embodiment, for use in the Italian language.

FIG. 56 shows a flowchart of a method for allowing a user or Application Developer to search for POI content at a central portal in accordance with an embodiment.

FIG. 57 shows a screenshot 542 of a POI content portal in accordance with an embodiment, including an Application Developer interaction screen for use by an Application Developer in viewing the catalog and available content data set offerings.

FIG. 58 shows a screenshot 544 of a POI content portal in accordance with an embodiment, including a screen that allows an Application Developer to search for a matching content data set within the catalog.

FIG. 59 shows a screenshot 546 of a POI content portal in accordance with an embodiment, including a screen that displays matching content data sets within the catalog that meet the search criteria.

FIG. 60 shows a screenshot 552 of a POI content portal in accordance with an embodiment, including a screen that allows an Application Developer to view their subscribed or public content data sets together with a high level descriptive summary of each content, including the overall geographic coverage, access and download history of content.

FIG. 61 shows a screenshot 554 of a POI content portal in accordance with an embodiment, including a content summary screen that allows an Application Developer or user to view contact information for the Content Provider company, a high level overview of the quality of the geocoding, content description and keywords, a summary of the geographic coverage, categories and attributes of the POI within a content data set they are subscribed to.

FIG. 62 shows a screenshot 558 of a POI content portal in accordance with an embodiment, including an Application Developer (App Dev) Content Summary page with associated icons and ability to download icons.

FIG. 63 shows a screenshot 562 of a POI content portal in accordance with an embodiment, including a content locations screen that allows an Application Developer to view a map of content they are subscribed to together with a corresponding list of POI including a summary of the details of the geocoding accuracy, input address details, and categories.

FIG. 64 shows a flowchart of a method for allowing a user or Application Developer to download POI content or a subset of the content at a central portal in accordance with an embodiment.

FIG. 65 shows a screenshot 564 of a POI content portal in accordance with an embodiment, including a screen that allows an Application Developer to view, filter and optionally download POI entries within a selected content data set.

FIG. 66 shows a screenshot 570 of a POI content portal in accordance with an embodiment, including a screen that allows an Application Developer to filter the POI so that a subset of the POI is returned for review or for download of that subset.

FIG. 67 shows a screenshot 572 of a POI content portal in accordance with an embodiment, including a screen that shows the returned results of the filter settings and a download dialog that allows an Application Developer to optionally download the filtered list, the entire list, or just a manually selected list.

FIG. 68 shows a screenshot 574 of a POI content portal in accordance with an embodiment, including an Application Developer Download page, together with KML and KMZ options. It will be evident that other formats can be used in addition to those shown.

FIG. 69 shows a screenshot 580 of a POI content portal in accordance with an embodiment, including a screen that allows a Content Provider to add or to remove a subscribing Application Developer's company, and to see a high overview of each subscribing company's access and downloads, as well as contact information.

FIG. 70 shows a screenshot 582 of the POI content portal in accordance with an embodiment, including a screen that allows a Content Provider to see all of the content to which an individual Application Developer subscribing company, (in this example Tele Atlas Demo Company) has been granted access. In accordance with an embodiment, this screen also allows a Content Provider to grant access to that subscribing company to more of the Content Provider's content sets and to also remove access, and to set an expiration date for each subscription.

FIG. 71 shows a screenshot 584 of a POI content portal in accordance with an embodiment, including a screen that allows a Content Provider to view all subscribing Application Developer companies to a specific set of content, (in this example, Parks and Monuments) and to add a subscribing Application Developer's company drawn from the Content Provider's master My Subscribers list. In accordance with an embodiment, this screen also allows a Content Provider to access information about a specific subscribing company by clicking on the company name and to also add a new subscribing Application Developer's company to the master My Subscribers list.

FIG. 72 shows a screenshot 590 of a POI content portal in accordance with an embodiment, including a screen that allows a Content Provider to view the number of times the content set has been downloaded by all Application Developers which have been granted access, in this example the content set is “Parks and Monuments.”

FIG. 73 shows a flowchart of a method for creating a company to provide POI content at a central portal in accordance with an embodiment.

FIG. 74 shows a flowchart of a method for creating a Company Administrator for a specific company at a central portal in accordance with an embodiment.

FIG. 75 shows a flowchart of a method for creating a Content Provider or Application Developer for a specific company at a central portal in accordance with an embodiment.

FIG. 76 shows a screenshot 594 of a POI content portal in accordance with an embodiment that allow a Global Administrator access management screens for the system including company and user administration, reports and announcements.

FIG. 77 shows a screenshot 598 of a POI content portal in accordance with an embodiment that allow a Global Administrator to search for a company or user with the system.

FIG. 78 shows a screenshot 602 of a POI content portal in accordance with an embodiment that allow a Global Administrator to create a new company and assign roles to that company, in this example a Content Provider company. It will be evident that a company can have multiple roles and that each company will have a minimum of two roles, Company Administrator being required for all accounts. As shown in FIG. 78, the Global Administrator can also disable a company and/or control a company's ability to publish content to the catalog.

FIG. 79 shows a screenshot 604 of a POI content portal in accordance with an embodiment that shows a summary of a new company's account, once the company has been created in the system. As shown in FIG. 79, the Global Administrator has the ability to edit the company information.

FIG. 80 shows a screenshot 608 of a POI content portal in accordance with an embodiment that allow a Global Administrator to create and to edit users for a company and assign those users the appropriate roles. As shown in FIG. 80, the Global Administrator can also inactivate a user, reset their password, or delete the user from the system.

FIG. 81 shows a screenshot 612 of a POI content portal in accordance with an embodiment that allow a Global Administrator to view and download system use reports. It will be evident that additional reports may be added as needed.

FIG. 82 shows a screenshot 614 of a POI content portal in accordance with an embodiment that allow a Global Administrator to create and set priority levels for system announcements. As shown in FIG. 82, the Global Administrator can edit and delete announcements.

FIG. 83 shows a screenshot 616 of a POI content portal in accordance with an embodiment that allow a Company Administrator to access screens to view and to manage company information and users within their company's account in the system.

FIG. 84 shows a screenshot 620 of a POI content portal in accordance with an embodiment that allows a Company Administrator to access a dialog that allows the Company Administrator to edit their company information.

FIG. 85 shows a screenshot 622 of a POI content portal in accordance with an embodiment that allows a Company Administrator to access a dialog that allows the Company Administrator to add, to delete and to manage their users within the system. In an embodiment, a Company Administrator can disable a user, reset a password, and reassign user roles.

FIG. 86 shows a screenshot 624 of a POI content portal in accordance with an embodiment that allows all system users to access system announcements.

FIG. 87 shows a screenshot 626 in accordance with an embodiment where a user who has both the Content Provider and Application Developer roles has the ability to select a view and interact with content according to role. For example, the user can select the Content Provider role view (in this case, Content I Offer), and create, add, edit and manage the content and subscribers, whereas when the Application Developer role view is selected (in this case, Content I Receive), interaction with the content is limited to read-only access and other role specific restrictions.

FIG. 88 shows a screenshot 628 in accordance with an embodiment where content can be designated as “Featured” or, in some embodiments, differentiated in a variety of ways to determine order and/or display characteristics in the catalog for the purpose of marketing campaigns or other businesses reasons.

### DETAILED DESCRIPTION

As described above, digital maps have become commonplace in modern society, and include an ever greater variety of data content and points of interest (POIs). The variety of different uses for these maps has also expanded. However, to date, no single company has been able to meet the growing demand for precise positional accuracy and regularly updated information about the newest business, recreational, and critical services; and other POI information. In accordance with an embodiment of the present invention, a system and a method is described which provides multiple participants with a centrally accessible content portal of geographic point of interest (POI) data, for subsequent use in creating map-based applications. Advantages of the present invention include:

The system can handle large amounts of POI data. Any portion of the POI information in a particular entry can be easily updated and delivered to the Application Developer, either by subscription means, or by the Application Developer requesting and downloading revised content data sets. In accordance with an embodiment, an attribute is a specific portion of the data. The address information, in addition to any other attribute, can be edited.

Multiple points of entry can be associated with a single POI.

POI data can be aggregated from multiple Content Providers.

Geocoding can be performed on-the-fly as new POI content is uploaded.

A common geocoding engine can be used across all of the Content Providers.

Access to the POI data can be provided via a portal, for example a Web portal, which allows for a central repository that POI Content Providers and users can use to share POI content.

The system and the portal can include a user-friendly interface, together with search facilities and easy means of uploading, editing, and downloading content.

In accordance with some embodiments, the system can include some or all of the following additional features:

POI validator: A Content Provider can verify that the location information for their content is correct by asking people with knowledge of the specific locations to review the information and make corrections where necessary. For example, if the content comprises several store locations, the Content Provider can have their store managers review and update the information for their specific locations.

KML download: Downloading content or a location in Keyhole Markup Language (KML) format allows users to display the location data in Earth browsers (such as, for example, Google Earth, Google Maps, or another type of Earth browser). Navigation device download: the system allows end-users to download content in the propriety format for specific navigation devices such as OV2 format for TomTom devices and additional download formats for other devices.

Icon upload/download: A Content Provider can specify one or more icons that can then be associated with their content. If icons have been associated with content, Application Developers can download the content icons and use them to represent the content locations on maps. A Content Provider can also specify one of the content's icons to be a KMZ icon. Application Developers can use the Keyhole Markup Zipfile (KMZ) icon to represent the content locations in Earth browsers, for example, Google Earth.

Upload Error reports: If errors are encountered while uploading a content file, the system can generate an Upload Error report, which describes the errors and their locations in the file. The report can then be viewed and optionally downloaded to facilitate fixing entries in the upload file.

Addition of URL to content description: This URL is available via the catalog and allows a Content Provider to point the user to more information about their company and their content via a link to their own web site.

It will be evident that additional benefits and advantages will be apparent from the description provided herein.

### Glossary

The following section defines some of the terms used in the context of this document:

Digital Map Provider—A digital map provider is a commercial, governmental, or other type of entity or POI Content Provider which develops, maintains, and provides a file-of-reference or digital base map, or supplies the data that comprises a file-of-reference or digital base map. Digital map providers can also act as third-party file providers in certain instances. An example of a commercial digital map provider is Tele Atlas.

Third-Party Content Provider/Content Provider—A third-party Content Provider, Content Provider, or POI Content Provider, is a commercial, governmental, or other type of entity, usually although not always separate from the digital map provider, that provides third-party data, for example POI content, for use with the file-of-reference or digital base map.

Application Developer—An Application Developer is a commercial, governmental, or other type of entity that utilizes any of the digital base map or third-party data or POI data content for use in its own geographic or map-based software applications. In some instances Application Developers may also act as POI Content Providers, and vice versa. As described herein, Application Developers are considered subscribers when they use the portal to subscribe to sets of POI content.

Global Administrator—the Global Administrator is the overall administrator of the web portal, and is responsible for creating and activating companies as necessary within the application. In some embodiments, the Global Administrator is an individual who, once agreements have been reached, creates a company profile within the portal and assigns the appropriate role to that company. They can also create a Company Administrator and other users for the newly created company. The Global Administrator can also review overall usage reports for the ContentLink application. The Global Administrator can create application announcements that are displayed to the user upon login.

Company Administrator—A Company Administrator is an individual within a specific company who can add and manage users, and who can give those users roles for their company only, within the portal.

Subscriber—A company who has been assigned the Application Developer role and has been granted a subscription to content by a Content Provider.

File-of-Reference—A file-of-reference is a geospatial database, data structure, or other document used to store digital map data. As used herein, a file-of-reference may sometimes be referred to as a digital base map, and is typically provided and marketed by the digital map provider. An example of a file-of-reference is the Tele Atlas base map.

Third-Party File—A third-party file is also a geospatial database, data structure, document, or digital map used for permanent storage of a document owner's geographic data, the difference being that the data in a third-party file is being supplied by a third-party for use with the file-of-reference. A third-party file can also be a POI content data set uploaded from a Content Provider onto the portal.

Map—As used herein, the term “map” is a generic term that is used to refer to a geospatial database, digital map, or the map data contained therein.

Map Object—A map object is any map item, or more appropriately any data object instantiated within a geospatial database or map.

Feature/Geographic Feature—A geographic feature, also referred to as a feature, is an idealized map representation of an actual object from the real world, which is useful to that map representation. Features can be point features, or they can have other dimensions. In some instances a feature might not be actually visible in the real world, but can still be represented in a map model.

Location—A location is where a feature is in the real world, which is a distinct concept from the feature itself. For example, while a feature may be a particular restaurant, its location can be specified as a latitude, longitude (lat/long) coordinate pair, or as coordinates from some geodetic referencing system, or as a human readable address, (for example, “322 Battery Street in San Francisco”).

Point of Interest—A point of interest (POI) is a special type of point or other feature. A POI can comprise other, more specific types of features, such as a restaurant, hotel, or museum. In accordance with an embodiment, a POI is any specific point location or location that someone may find useful or interesting, for example a point on the Earth representing the location of the Space Needle, or a location on Mars representing the location of the mountain, Olympus Mons.

### Centralized Content Portal

In accordance with an embodiment, the system includes a point of interest (POI) content portal. The content portal acts as a single point of entry for POI Content Providers to collect, validate geocode, categorize and distribute their data to Application Developers. Content Providers are subsequently able to receive feedback back into their own master file(s) without having to reload entire sets of data. This can be done either by incremental uploading, by editing of existing entries, or by the addition or deletion of entries. The content portal also allows Application Developers to have a single point of entry to search for, preview, and download diverse content data sets, and to subsequently manage their use of provider content. Content Providers can receive active reporting of their data uploads, of the subscribers use of that data, and of their individual download histories.

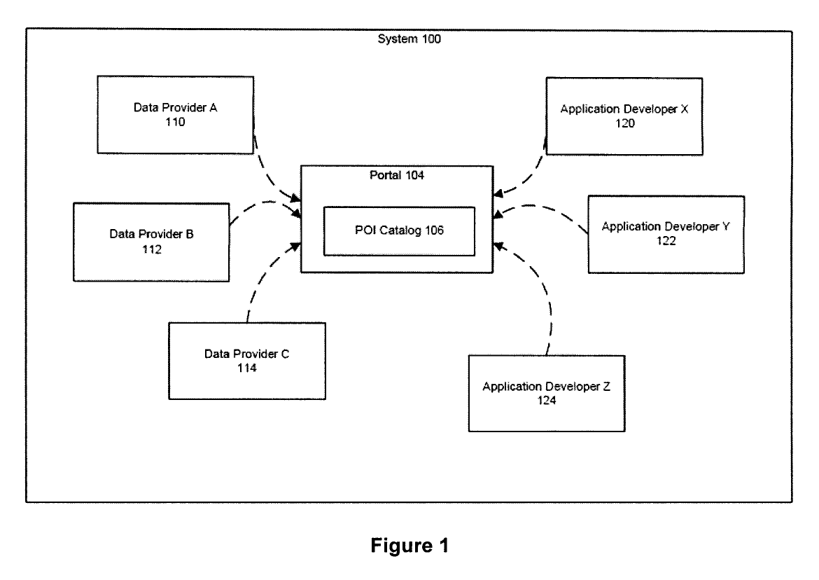

FIG. 1 shows an illustration of a system in accordance with an embodiment, including a portal for providing multiple participants with central access to geographic point of interest (POI) data. As shown in FIG. 1, the system 100 comprises a portal 104, for example a Web portal application, which can be deployed on a Web server, application server, or other type of computer server or computer network. The portal includes or provides access to a catalog 106 of POI data content. Content Providers (for example, Content Providers A 110, B 112, and C 114) can upload content data sets, i.e. sets of their POI data, to the portal. The content data sets can then be published and appear in the catalog as available for downloading. Application Developers (for example, Application Developers X 120, Y 122, and Z 124), after establishing a subscription with the Content Provider, can subsequently access the catalog and retrieve selected POI content data sets for use in their own software applications. In the case of a Web-based portal, each of the parties can access the portal through standard Internet means, for example via a Web browser, the Hypertext Transfer Protocol (HTTP), the Hypertext Markup Language (HTML), or other similar means.

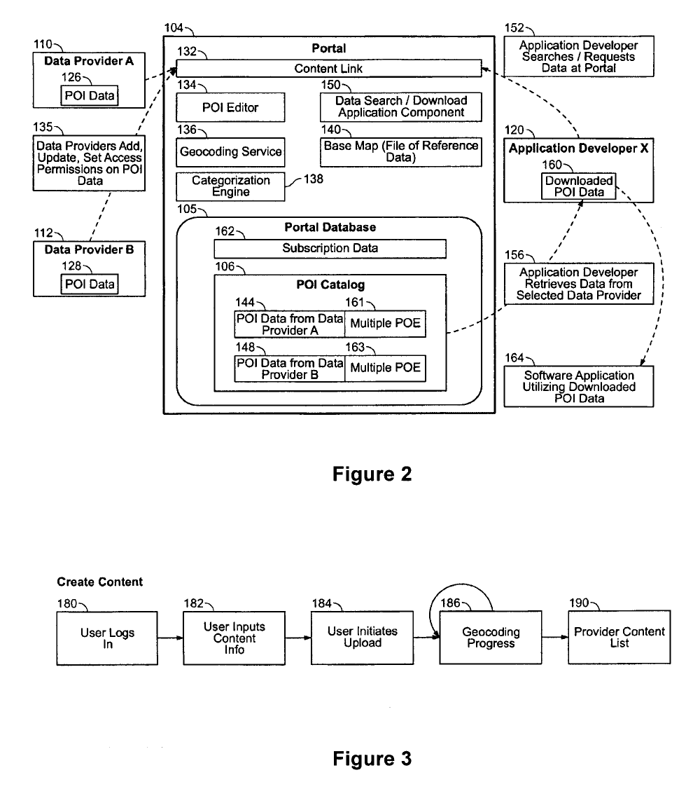

FIG. 2 shows another illustration of a system in accordance with an embodiment, including a portal for providing multiple participants with access to geographic point of interest (POI) data. As shown in FIG. 2, the portal 104 comprises a content link interface 132, and a POI editor 134. POI Content Providers 110, 112 can upload or otherwise send updates 135 of their own POI data 126, 128 to the portal via the content link interface and the POI editor. The content link interface provides the communications means for uploading the content data sets, POI entries, and other data; while the POI editor provides a graphical user interface (GUI) means for configuring the content data sets and the individual POI entries. Each set of POI data typically includes information about one or more locations. A location represents a single piece of POI data. A set of POI data content can include multiple POI entries and thus multiple (in some instances many hundreds or thousands) of locations. In accordance with an embodiment, the information that is associated with each location typically includes an address, geocode results, and any categorization data for that location.

As also shown in FIG. 2, in accordance with an embodiment the portal also comprises a geocoding engine, or a geocoding service 136. The geocoding engine or service assigns a geographic point (for example, a latitude/longitude value) to a particular location, using a base map 140 as a reference. As described above, an example of a base map that can be used with the system is the Tele Atlas base map, although other base maps and files-of-reference can optionally be used. The output of the geocoding process includes an indication of the accuracy of the match between the address of the location and its assigned geographic point.

In accordance with some embodiments, the portal also comprises a categorization engine 138. The categorization engine is used to define a standard or common taxonomy, i.e. to assign categories to a location for the purposes of subsequent classification/grouping of that location. For example, a restaurant location might be categorized as “Restaurant:Italian” or “Restaurant:Chinese” to indicate the particular type of food that is served there.

When the data has been uploaded by a Content Provider, it can be displayed in the POI content catalog 106. In accordance with an embodiment, the content catalog represents a collection of locations, or location sets, that are treated as a single entity. In addition to the individual locations, the content catalog can include meta-data describing the entire collection (for example, a description or selected keywords), or alternatively subsets of the collection. In accordance with an embodiment, the content catalog is stored in a portal database 105, or another form of database, at a computer server, network server, or in a similar or other form of storage. The content catalog can include subsets or subcatalogs 144, 148 of POI data content from each of the plurality of Content Providers. Optionally, each location entry can also include multiple points of entry (POE) 161,163 into that location.

Once the data has been uploaded and cataloged, Application Developers 120 and other software developers and users can then access the portal and the POI data stored thereon. In accordance with an embodiment, the Application Developer can use a data search component 150 at the portal to search for 152, and to retrieve 156, data content from the portal. The downloaded POI data 160 can then be used by the Application Developer to develop or enhance their own software applications 164.

In accordance with an embodiment, an Application Developer can request subscriptions to specified POI data content from specified data providers. To record this subscription, the system includes a subscription data 162 that is stored at the portal. The subscription data can be modified by the owner of the content at any time to manage access to their data.

In accordance with an embodiment, the Content Provider can edit a single entry or multiple entries; can add or delete entries; or can edit attributes on the portal itself, without having to reload (i.e. download, modify, or upload) their master content file. These edits can be made to any of their content data sets loaded on the portal, including those sets of data which the Content Provider has made available to their subscribers. Content Providers can also upload sets of POI content, geocode their content in real time (using the geocoding engine or geocoding service), and then edit any data entries for which the geocoding results are not considered optimum. Content Providers can add or delete individual listings in their content and have the results reflected immediately in the data they provide to their users. The system thus provides the Content Provider with immediate feedback regarding the quality of their content, and also gives the Content Provider an immediate way to correct any incorrect data issues. Content Providers also have the ability to enter and to edit customized attribute information to any of their content data sets loaded on the portal, and to have those edited results reflected immediately in the data they provide to their subscribed users.

The advantages of using the system include that published data made available via the content link interface can be searched via a free-text or keyword search. The common taxonomy can also be used throughout the system and across otherwise diverse content data sets. If the Content Provider has chosen or opted to use the common taxonomy (i.e. the standard categories understood by the system), then their content can be searched via that taxonomy. In this manner, an Application Developer can see what data is newly available from preferred Content Providers, in addition to discerning the arrival of new Content Providers and new content data sets. The Application Developer is also able to browse a brief synopsis of each content data set, including the quality of the geocoding in that content data set, and the geographic coverage of the data set. The use of a common taxonomy also allows for merging divergent content data sets.

An additional advantage of the system is that all of the content data sets on the portal can be geocoded by the same geocoding and mapping engine or service. The use of the same engine across sets of content allows consistent and uniform output that can be utilized by Content Providers to maintain their data in a coherent manner. The use of a common geocoding engine allows both the Content Providers and the Application Developers to be confident that the POI data will be displayed correctly on maps in any of the software applications that are developed.

### Geocoding Service

As described above, the portal can comprise a common geocoding engine or geocoding service, which assigns a geographic point (for example, a latitude/longitude value) to a location, using a base map as a reference. In accordance with an embodiment, the geocoding service accepts addresses from any of the countries that the base map covers, and returns a match at the country level or better. Return values can also include:

A location's latitude and longitude.

An indication of the match level or precision (for example at the block, street, or Zip Code level).

If the geocode result is based on an address point match, the address point identifier can also be returned.

A product version identifier of the base map data in use.

When the data is subsequently used to find locations (as distinct from geocoding them), then the system can also be configured to provide:

Multiple results when there is ambiguity.

A standardized, formatted address string for each returned result

An indication of the match quality, in terms of confidence of the match (for example, a percentage certainty, or whether the match is an ambiguous or exact one).

An indication of the granularity of the match, in terms of the geographic scope represented by the coordinate returned, including for example an exact point, an interpolated point, a street midpoint or “centroid”, a Postal Code centroid, or a city centroid.

In accordance with some embodiments, the geocoding service can accept a street address including the house number as input, rather than requiring those to be separate inputs. The geocoding service can also accept as input an unparsed full address (including city, state, etc.). In some embodiments, the geocoding service allows free-text strings to be entered by the Content Provider which are then parsed into standard address parts. For example, an input “101 Lafayette St., Lebanon, N.H., 03766 USA” will be returned by the geocoding service as:
Country: USA
Postal Code: 03766
State/Province: New Hampshire
City: Lebanon
Street: Lafayette Street
House Number: 101

In accordance with some embodiments, the geocoding engine or service can be made available as class or code libraries that are deployed locally on the content portal, and that can be updated as new revisions become available. Alternately, the geocoding service can be made available as a web service that is maintained and loaded with the most recently available data. Reverse geocoding also allows the system to return both a formatted address and the address decomposed into standard parts as shown in the above example.

### Content Provider Interface

As described above, each of the participants, including Content Providers and Application Developers, interact via the content portal.

Whether the participant is considered a Content Provider or an Application Developer is based primarily on whether the user is either providing, or using, data content at that particular moment in time. The terms “Content Provider” and “Application Developer” are thus interchangeable to a certain extent depending on the particular scenario.

In the role of Content Provider, a user manages content for the purpose of providing that data to Application Developers. Tasks that are essential to the Content Provider include uploading files containing content, verifying or modifying a location's geocode results, assigning categories to a location, and granting subscriptions to content. In accordance with an embodiment, the Content Provider uploads their primary list of locations. They can then optionally edit locations falling below a provider-determined level of precision by utilizing the POI editor. In accordance with other embodiments the portal can generate e-mails with secure map links which allow for participants to obtain real-time feedback into the Content Provider's master database. If coverage and geocode information has changed since the previous edit, then the portal will automatically update and change the appropriate catalog description.

FIG. 3 shows a flowchart of a method for uploading or creating POI content for subsequent use with a central portal in accordance with an embodiment. As shown in FIG. 3, in step 180, the user logs into the system and navigates to an Upload Content page. In step 182, the user indicates a content data filename and default categorizations to use for the new locations. In step 184, the user then initiates the content upload. In accordance with some embodiments, in step 186, the user receives continual progress reports while the locations in the data file are geocoded. In step 190, when the content is finished being processed, the user is directed to a Provider Content page (which now includes the newly uploaded or created content).

Once the content has been uploaded at least once, the Content Provider can subsequently log in and make edits as necessary to the content stored on the portal.

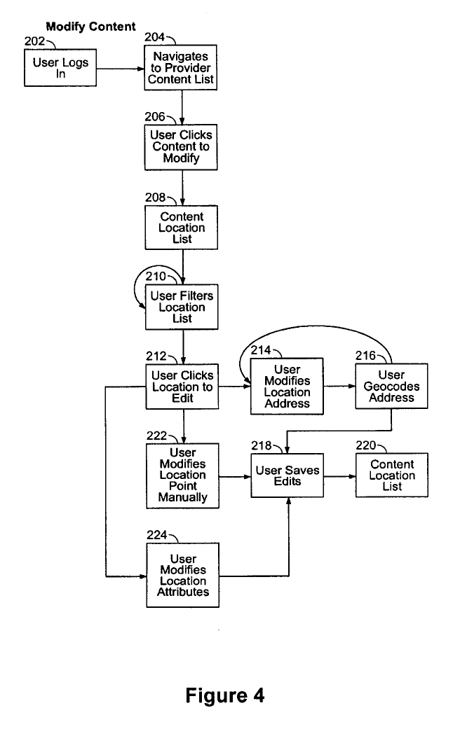

FIG. 4 shows a flowchart of a method for modifying POI content at a central portal in accordance with an embodiment. As shown in FIG. 4, in step 202, the user logs into the system. In step 204, the user then navigates to the Provider Content page. In accordance with an embodiment, step 204 can be automatically performed by the system, or can be omitted, so that the user is taken directly to a “My Content” page upon log in. In step 206, the user clicks on the content of interest, and in step 208 navigates to the list of locations for that content. In step 210, the user indicates any filter criteria (for example, a specific content category, particular geocode results, or partial address data) to alter the returned list of locations. This step can be optionally repeated with additional filtering criteria, narrowing or broadening the criteria until the desired set of locations is displayed. In step 212, the user indicates a specific location for editing, and then navigates to the Edit Location page. In step 214, the user modifies, for example, the address data for the location. In step 216, the user can then instruct the system to initiate a dynamic geocode. In step 218, the user verifies the new geographic point on the displayed map and then in step 220 saves their changes. In accordance with some embodiments, the above technique can be modified to allow add or delete functionality, including for example adding or deleting a POI from within a set of content. Steps 214-218 can also be modified to allow a user to, e.g. just modify the address and save it. An example of such a modification might include a street name that is spelled incorrectly, but is not so poorly spelled to impact the success of the geocoding.

In each of the above embodiments, the step of geocoding can be either performed automatically by the system, or alternatively can be designed as an optional feature that can be performed by the system upon request from the user. In accordance with some embodiments, in step 222, the user can optionally choose to modify a location point manually, prior to saving the data, and can then bypass the automatic geocoding process. In accordance with some embodiments, in step 224, the user can also modify location point attributes prior to saving the data.

Once the data has been uploaded to the content portal, and optionally edited or modified, it can then be shared with the Application Developer community, either by publishing in the catalog or by providing it through private subscription.

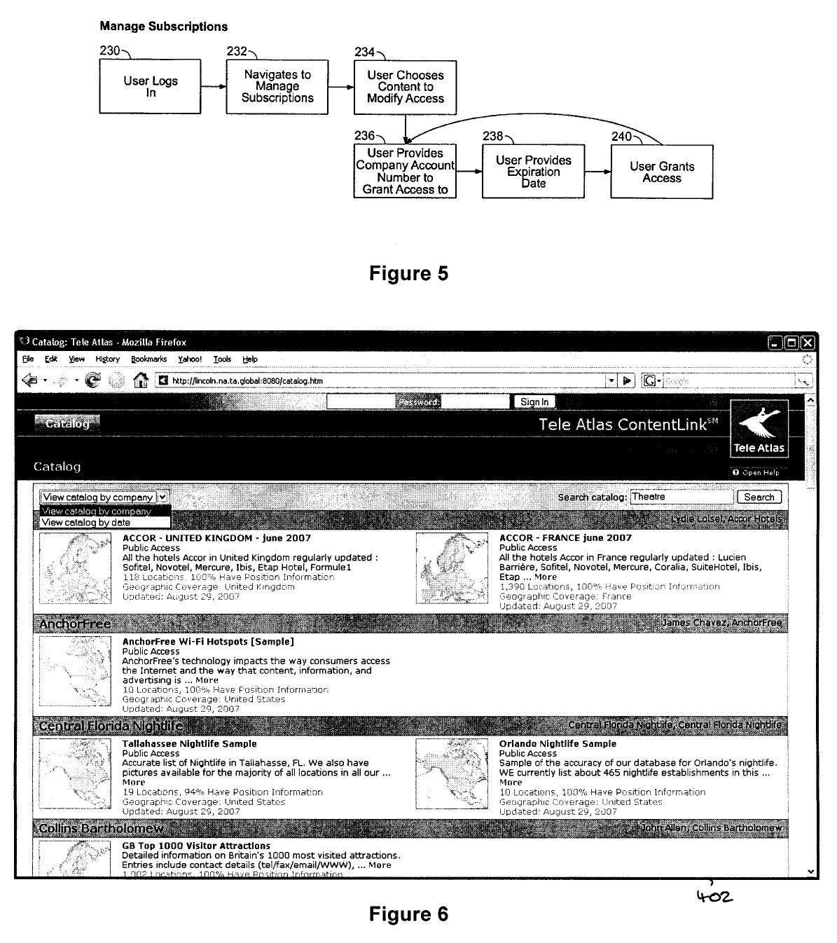

FIG. 5 shows a flowchart of a method for allowing a provider to manage subscriptions to all of their POI content, at a portal in accordance with an embodiment. As shown in FIG. 5, in step 230, the user logs into the system, and then, in step 232, navigates to the Manage Subscriptions page. In step 234, the user selects the POI content data set to which access should be modified, and in step 236 indicates the account number of the company he/she wishes to denote as a subscriber to this content. In step 238, an expiration date can be set for each subscription. In step 240, access is granted by the system to the company of the Application Developer that is associated with the company account number, so that they can access and download the content data set.

FIG. 6 shows a screenshot 402 of a Content Provider's POI content portal in accordance with an embodiment. As shown in FIG. 6, the system presents the user with available content data sets from a variety of different Content Providers, including in this example Accor, AnchorFree and others. As shown in FIG. 6, any user can search for and view different content data sets within the catalog. Upon login the user can then be taken to their own “My Content” content page. In an embodiment, a user may have to be logged into the portal before being able to view and to search the catalog.

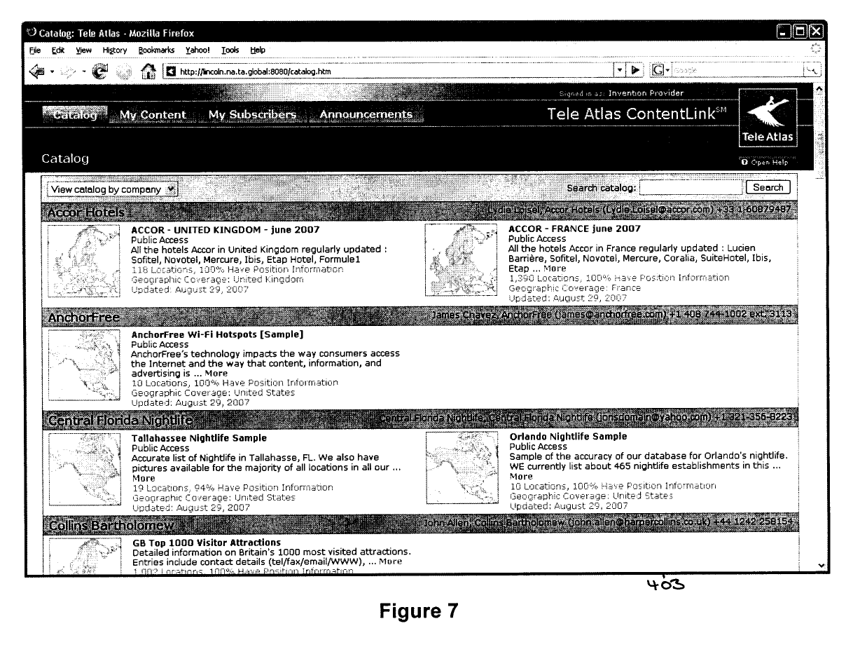

FIGS. 7-38 show screenshots of a POI content portal in accordance with an embodiment, that will go through pages for a Content Provider.

FIG. 7 shows a screenshot 403 of a Content Provider's POI content portal in accordance with an embodiment, including a screen that shows where a Content Provider accesses their content management pages, including pages to manage their content, subscribers to their content, and access to system announcements.

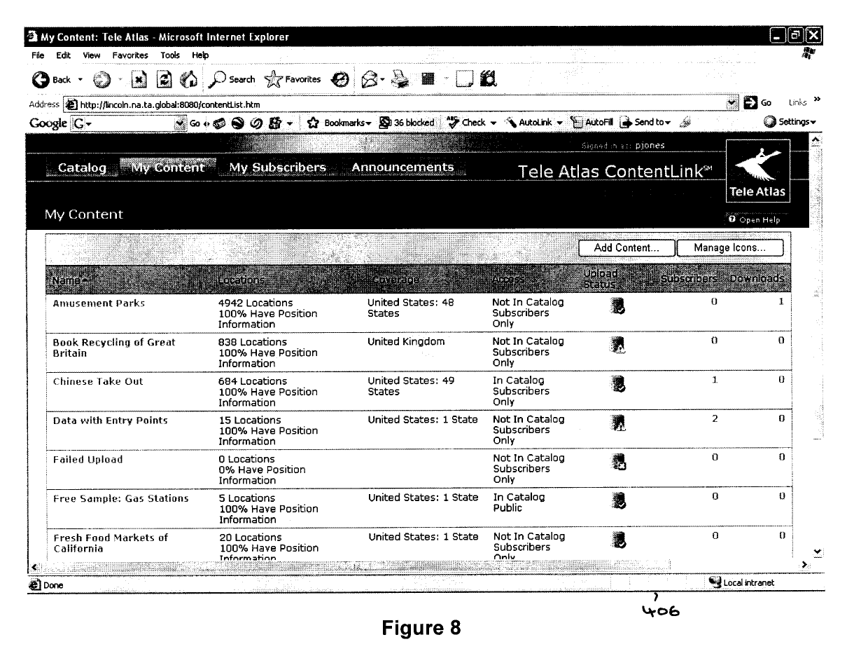

FIG. 8 shows a screenshot 406 of a Content Provider's POI content portal in accordance with an embodiment, including a Content Provider screen that displays all of the POI content data sets provided by a particular Content Provider and manageable by the Content Provider. As shown in FIG. 8, each content data set in the portal catalog can include a plurality of locations. Using this screen, the system allows a Content Provider to see information about content data sets they have uploaded including the number of locations, their geographic distribution, the number of locations successfully geocoded, and the level to which those locations have been geocoded via the portal's geocoding service. A high-level descriptive summary can also be provided for each content, including overall geocode quality, geographic coverage, and Application Developer use. Any icon or upload status that is associated with the content can also be provided.

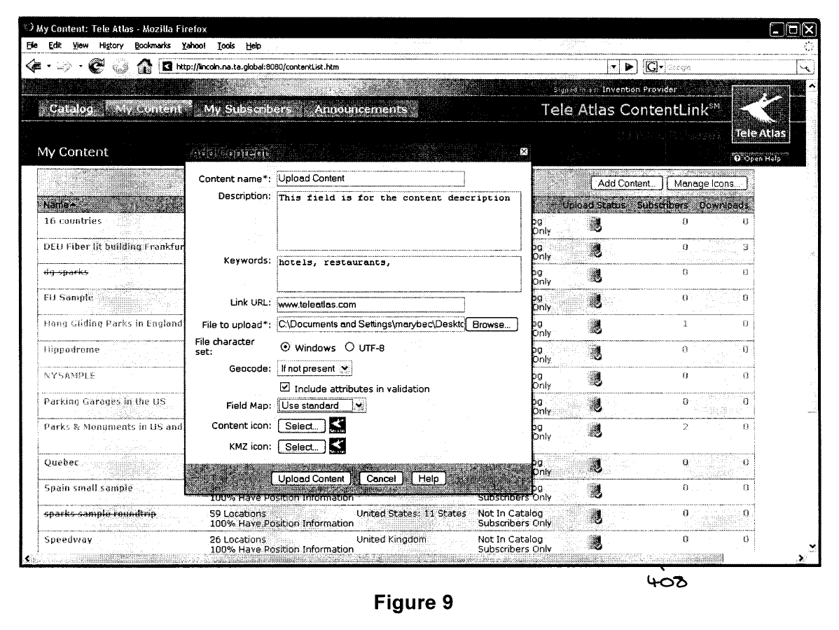

FIG. 9 shows a screenshot 409 of a Content Provider's POI content portal in accordance with an embodiment, including a Content Provider screen dialog that allows a Content Provider to upload content to the system. As shown in FIG. 9, using the Add Content dialog box, the Content Provider can enter the name of the content set, a description of the content set, supply their company or other appropriate URL for display, and set the character set of the content. The Add Content dialog box also allows a Content Provider to tell the system whether to Geocode All POI entries even if a latitude and longitude are input in the appropriate fields within the data, or to only geocode POI entries that have blank entries in the latitude and longitude fields. The Add Content dialog also allows a Content Provider to associate their custom column headers to the appropriate system column headers or, if the Content Provider has already utilized the system content headers, to use the standard association. The Add Content dialog also allows a Content Provider to select both a standard icon and a KMZ icon to associate with the content.

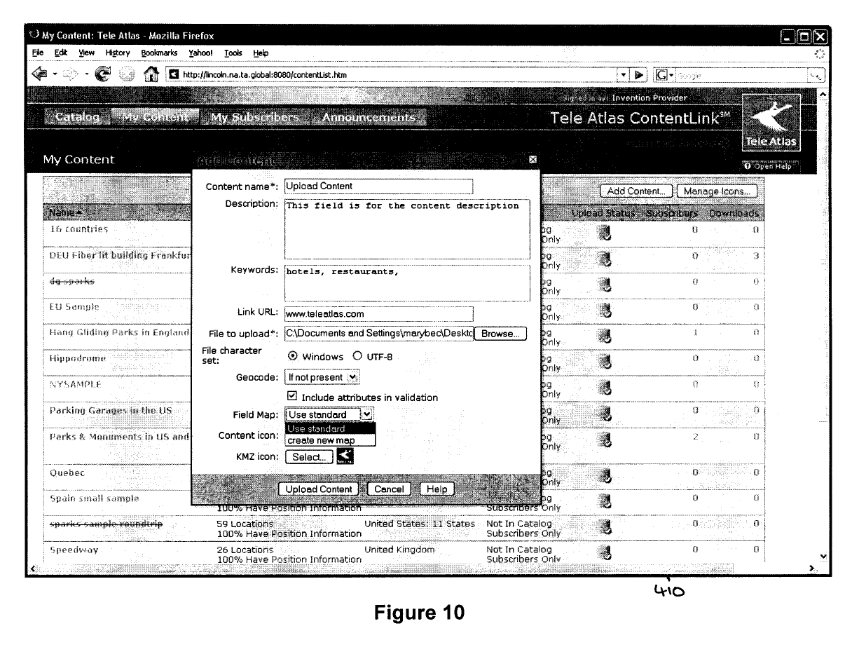

FIG. 10 shows a screenshot 410 of a Content Provider's POI content portal in accordance with an embodiment, including a Content Provider screen dialog that shows a Content Provider utilizing the option to associate their custom column headers to the appropriate system column headers or, if the Content Provider has already utilized the system content headers, to use the standard mapping.

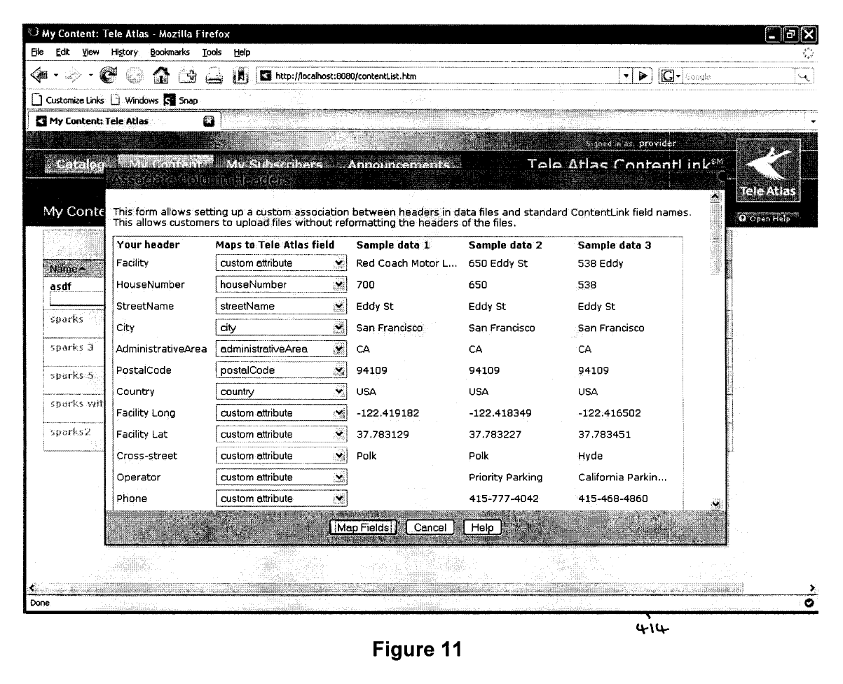

FIG. 11 shows a screenshot 414 of a Content Provider's POI content portal in accordance with an embodiment, including a Content Provider Associate Column Header screen dialog that shows the system whereby a Content Provider can associate their custom column headers to the appropriate system column headers. The system will suggest an association that can be overwritten by the Content Provider. As shown in FIG. 11, the Associate Column Header dialog will also give an example of the content within each field of the Content Provider's content set to aid in the selection of the appropriate column headers. The Associate Column Header dialog will also allow a Content Provider to skip a column in their content for upload.

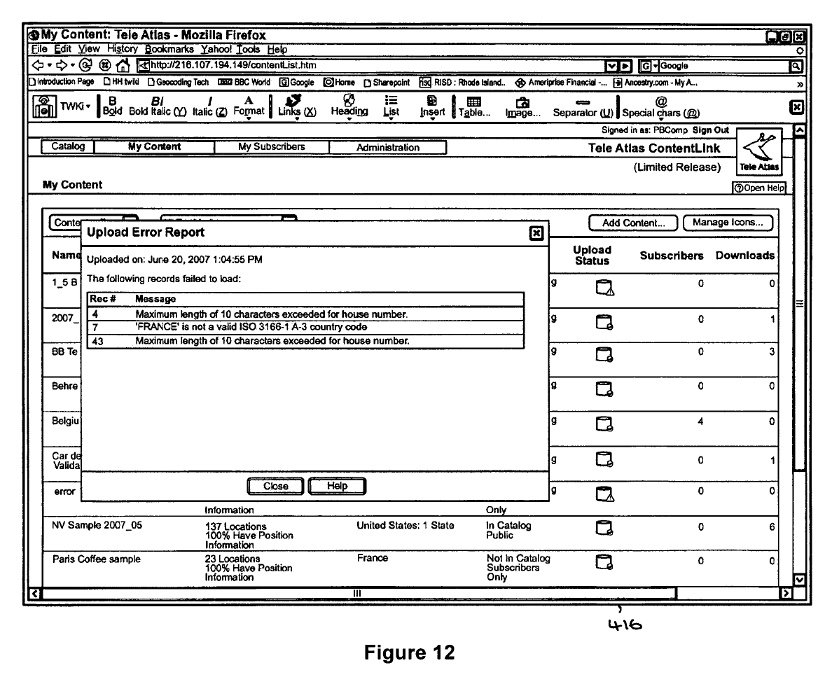

FIG. 12 shows a screenshot 416 of a Content Provider's POI content portal in accordance with an embodiment, including a Content Provider Upload Error Report screen dialog that shows that the system can generate a downloadable report that indicates to the Content Provider any issues with specific entries in their data upload, including specific information for why a specific POI entry failed to upload. For example, if the Content Provider has input an incorrect ISO-3-digit country code. Once a Content Provider has corrected the entries and uploaded them to the system, the updated content set is immediately available via the portal to subscribing Application Developers.

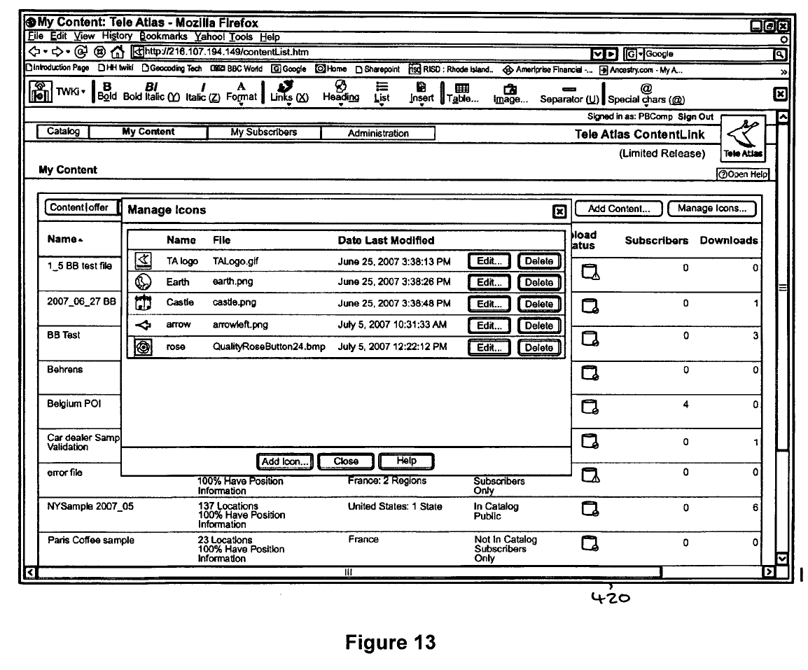

FIG. 13 shows a screenshot 420 of a Content Provider's POI content portal in accordance with an embodiment shows a Content Provider dialog that gives the Content Provider the ability to upload, edit and to delete icons to their account in the system. One or more of these icons may then be associated with a specific content set, designated as a KMZ icon for a specific content set, and made available for download by a subscribing Application Developer.

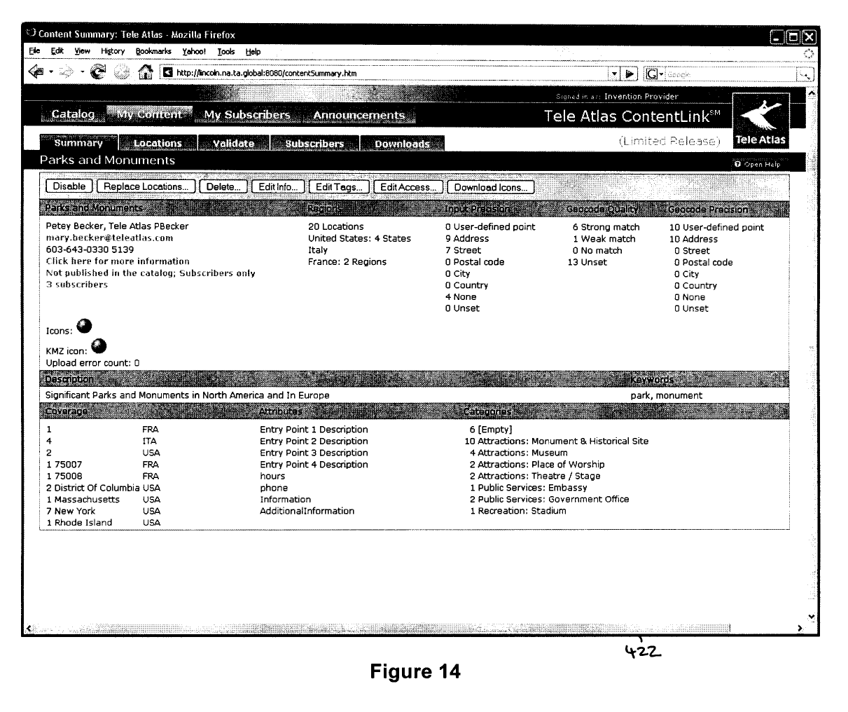

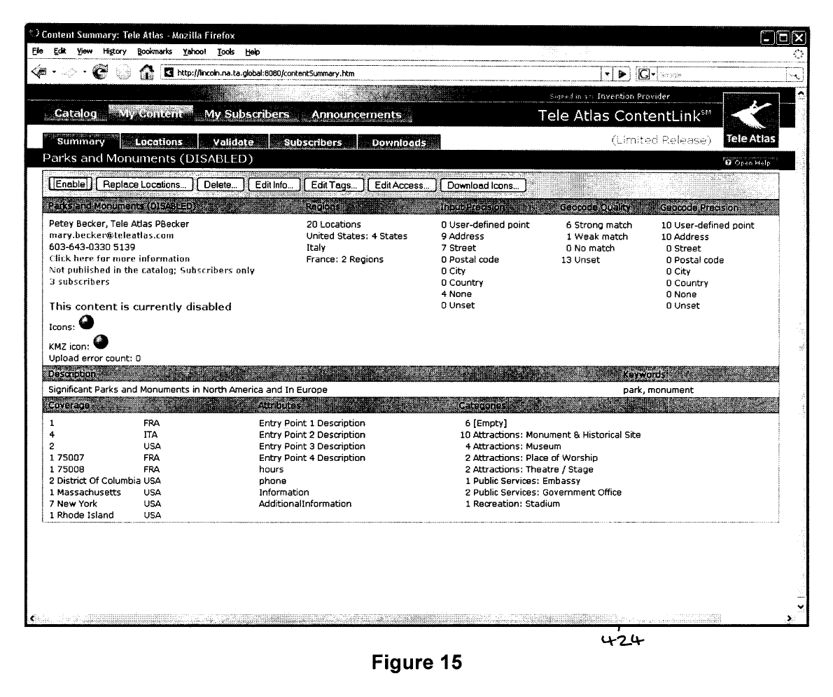

FIG. 14 shows a screenshot 422 of a Content Provider's POI content portal in accordance with an embodiment shows a Content Provider's Content Summary page. As shown in FIG. 14, the Content Provider's Content Summary page displays the coverage and attributes of the POI within a content data set as well as summaries of the quality of the geocoding for the content set, of the address level of the original input, of the geocode quality, and of the geocode precision. The Content Provider's Content Summary page also shows a summary of catalog status including available contact information, and current number of subscribers to the content set. The Content Provider's Content Summary page also shows any icons that have been associated by the Content Provider to the content set. This screen also allows a Content Provider to manage the visibility and access state of a specific content set and also gives access to a Content Provider to other tabs/screens that allow a Content Provider to edit and to validate individual POI, and to multiple tabs/screens where a Content Provider can manage subscribers and monitor usage for the content set. The details for this functionality follow in FIGS. 15-21.

FIG. 15 shows a screenshot 424 of a Content Provider's POI content portal in accordance with an embodiment shows a Content Provider's Content Summary page with the content set in the DISABLED state. This state allows a Content Provider to remove a content set from any subscriber interaction, including viewing and downloading, and while maintaining it with the system. The DISABLED content state also maintains all user history and meta-data. In an embodiment, the content is enabled by clicking on the “enable” button.

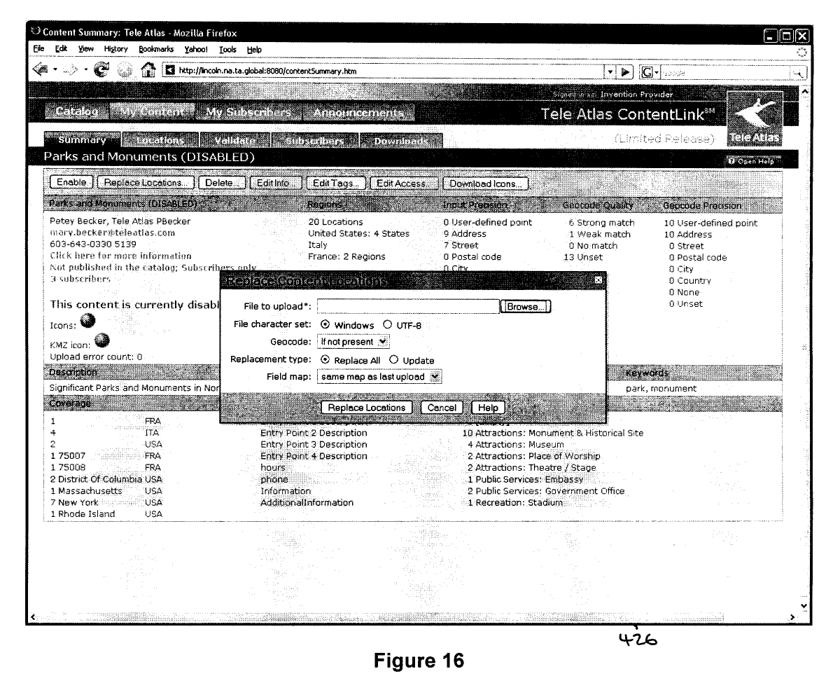

FIG. 16 shows a screenshot 426 of a Content Provider's POI content portal in accordance with an embodiment including a Content Provider Replace Content Locations dialog, which shows that a Content Provider can upload a content file that will either replace all of the entries within a content set, or optionally to update a subset of the content set, while maintaining the meta-data and user history. As shown in FIG. 16, The Content Provider Replace Content Locations dialog also allows a Content Provider to choose to use the standard association/map of column headers to the system required column headers or to create a new association. The Content Provider may choose to create a new association/map, or to use the original association/map used for the original upload. The Content Provider will then be able to modify any associations as appropriate. In an embodiment, a Content Provider may use an API to automate the Replace Content Locations functionality.

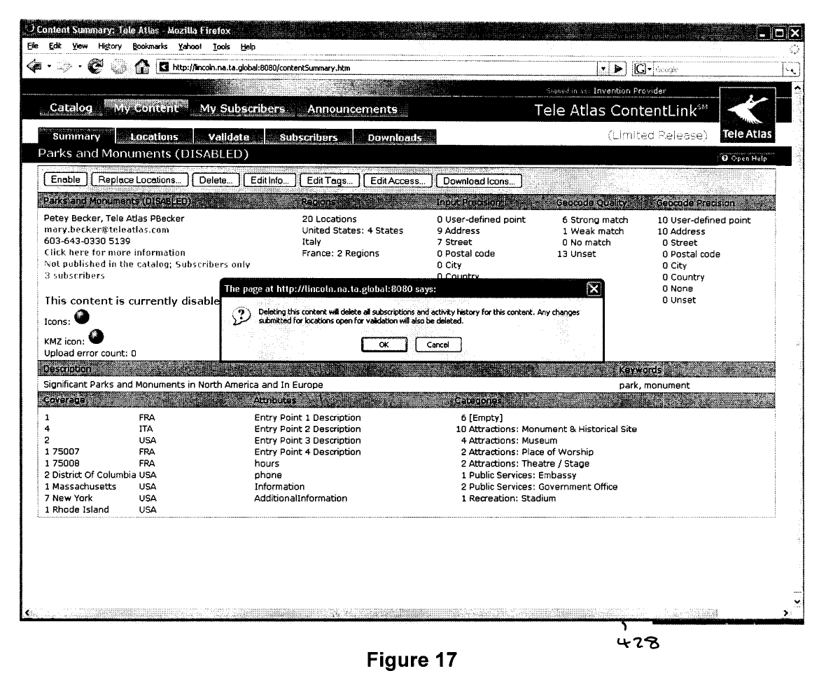

FIG. 17 shows a screenshot 428 of a Content Provider's POI content portal in accordance with an embodiment including a Content Provider Delete dialog, which allows a Content Provider to completely delete a content set from the system. This delete will remove all user subscription and download history, as well as the meta-data for the content.

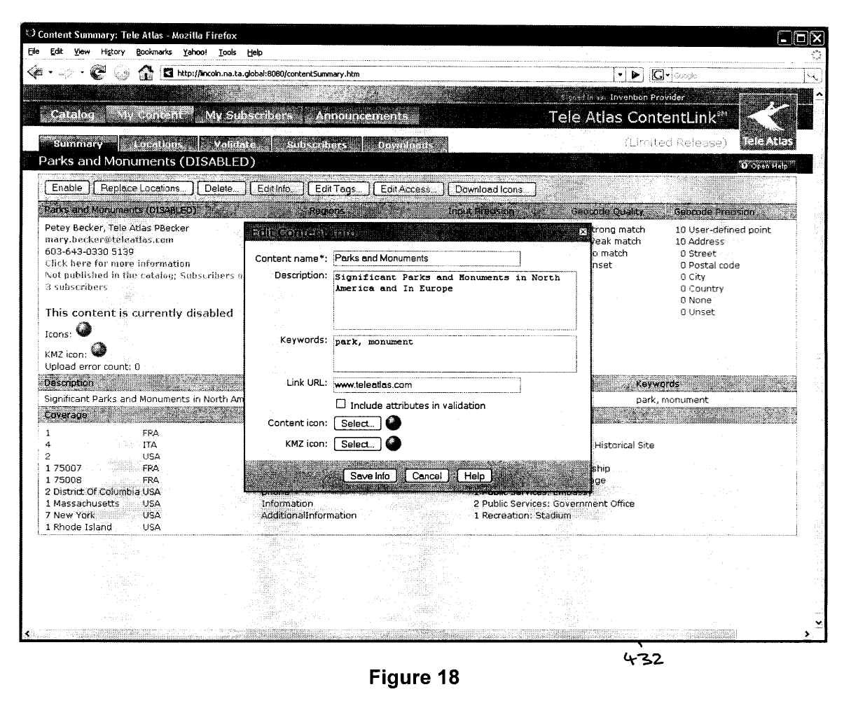

FIG. 18 shows a screenshot 432 of a Content Provider's POI content portal in accordance with an embodiment including a Content Provider Edit Content Info dialog, which allows a Content Provider to edit the content name, content description, content keywords, the URL associated with the content, to change the status of attributes for validation, and to select/change icons to associate with the content.

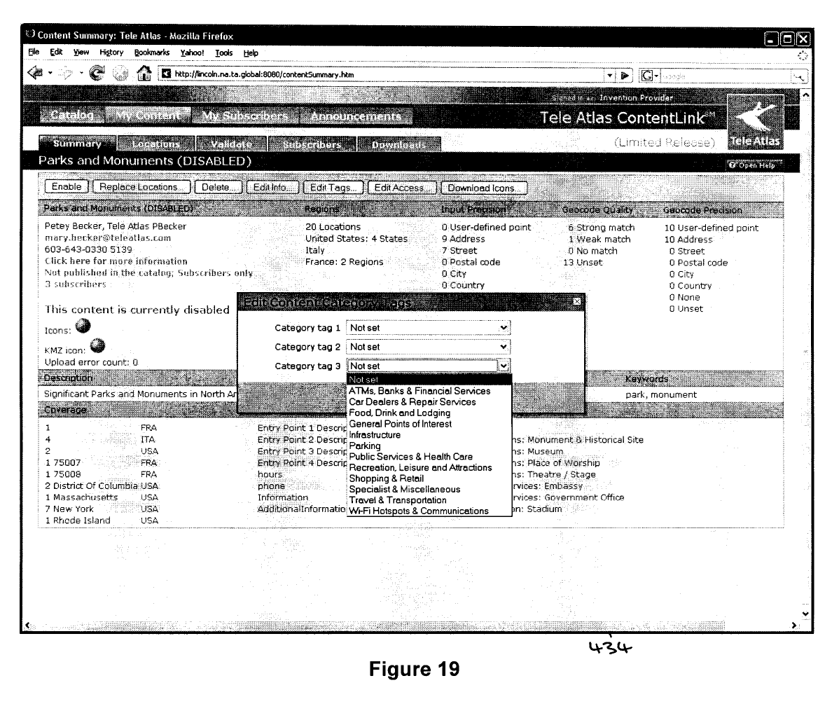

FIG. 19 shows a screenshot 434 of a Content Provider's POI content portal in accordance with an embodiment including a Content Provider Edit Content Category Tags dialog which allows a Content Provider to select tags that aid in the catalog search. These are high-level tags that group content into genres that enable a catalog search by such genre. It will be evident that the list of content tags may evolve from the current list shown in the screenshot. In an embodiment, the functionality attached to each content set that supports the search functionality in the catalog may be expanded to include other methods and options.

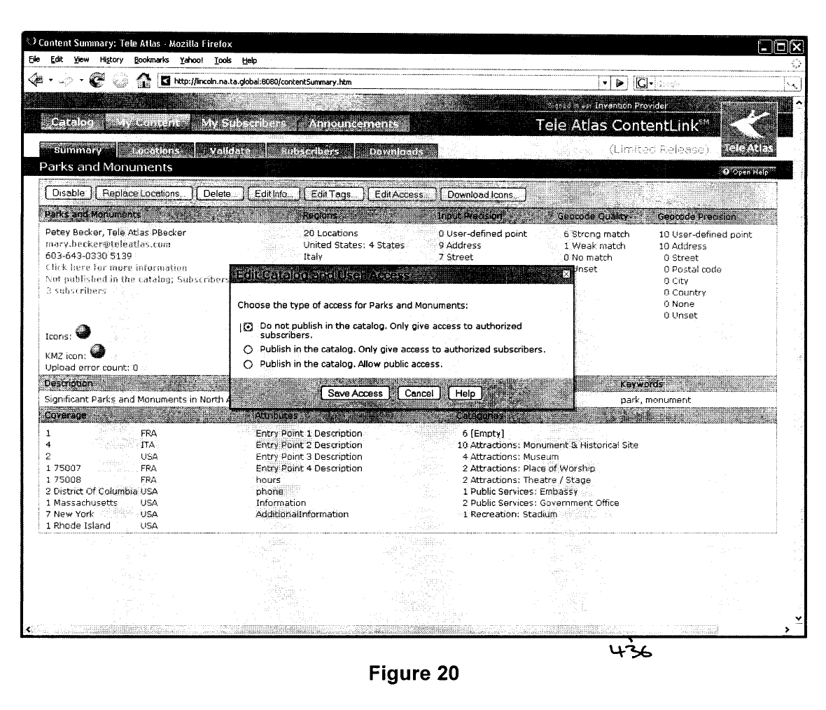

FIG. 20 shows a screenshot 436 of a Content Provider's POI content portal in accordance with an embodiment including a Content Provider's Edit Catalog and User Access dialog which allows a Content Provider to determine whether the content will be published in the catalog and whether that content will be freely available or available only by subscription. The system also allows a Content Provider to create a non-published customized content set for a specific subscribing Application Developer. The system also allows a Content Provider to publish a small sub-set of their content and make that content a free sample to all Application Developers.

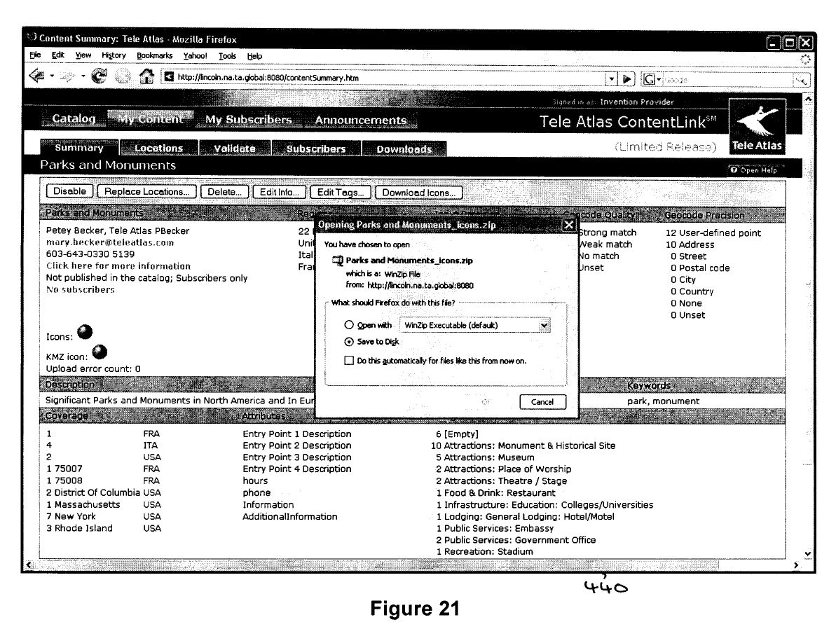

FIG. 21 shows a screenshot 440 of a Content Provider's POI content portal in accordance with an embodiment including a Content Provider's Download Icons functionality that allows a Content Provider to download icons that the Content Provider has uploaded to the system and has associated with this content set.

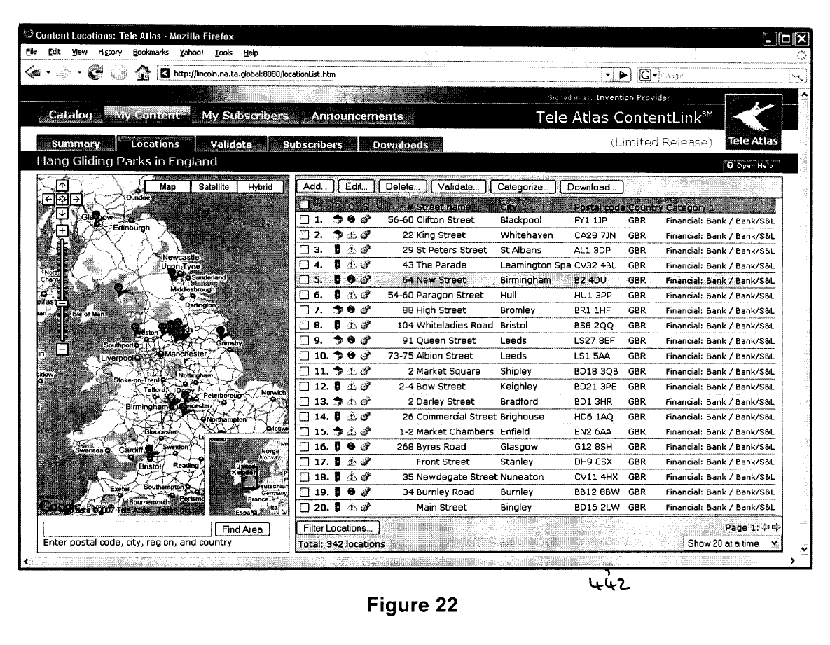

FIGS. 22-37 are screenshots of a POI content portal in accordance with an embodiment, that allow a Content Provider to review, edit, validate, and download either subsets or individual POI entries within a content set.

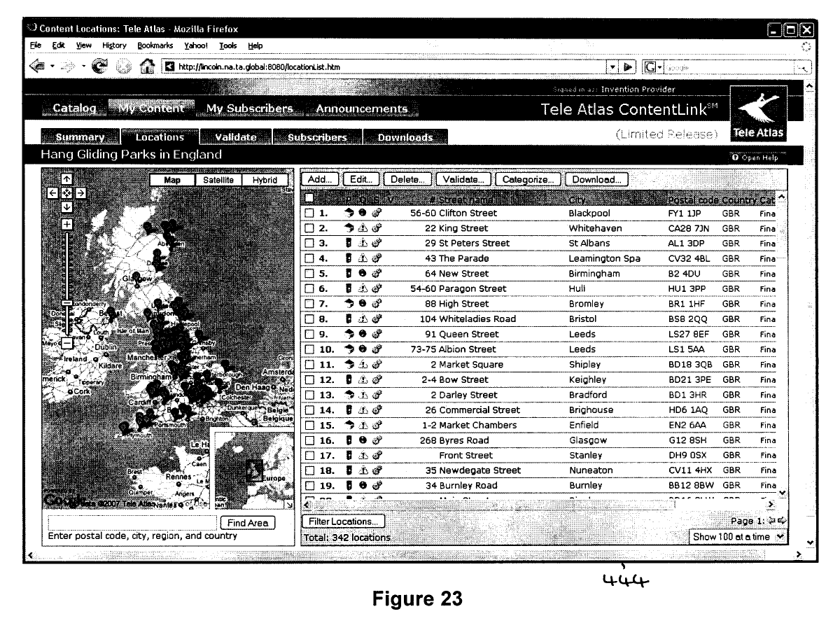

FIG. 22 shows a screenshot 442 of a Content Provider's POI content portal in accordance with an embodiment, including a screen that allows a Content Provider to view a list of POI with a view of those points on map. As shown in FIG. 22, the screen also gives the Content Provider a quick graphical display of the geocoding level and validation status via icons. It also shows categories associated with the POI as well as the input address information for the POI. The screen also gives the Content Provider multiple means of selecting, and then acting upon those selections. FIGS. 23-37 will detail the options available to a Content Provider from this screen.

FIG. 23 shows a screenshot 444 of a Content Provider's POI content portal in accordance with an embodiment, including a screen that allows a Content Provider to page through the content set and to show a different map view based on the POI presented in the list. As shown in FIG. 23, this screen also shows that a Content Provider can optionally choose to show a range of POI in the list from 25-100, now set at 100, where in the previous screen only 25 POI were displayed. The number of POI in the list is also reflected in the number of points shown on the map.

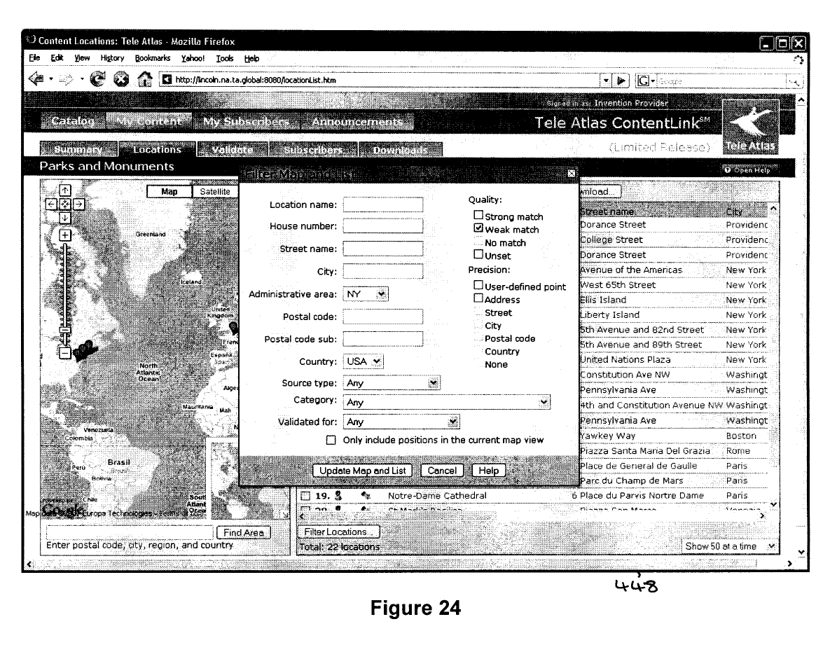

FIG. 24 shows a screenshot 448 of a Content Provider's POI content portal in accordance with an embodiment, including a Content Provider's Filter dialog that allows a Content Provider to filter the POI so that a subset of the POI is returned for review or for download. As shown in FIG. 24, the filter allows a Content Provider to search for POI by any of the address components, by geocode source type, by category, by validation date, as well as by levels of geocode quality and precision. The filter also allows a provider to sort only on the locations in the current map view or list and not the entire content set. A filtered search will update the map view.

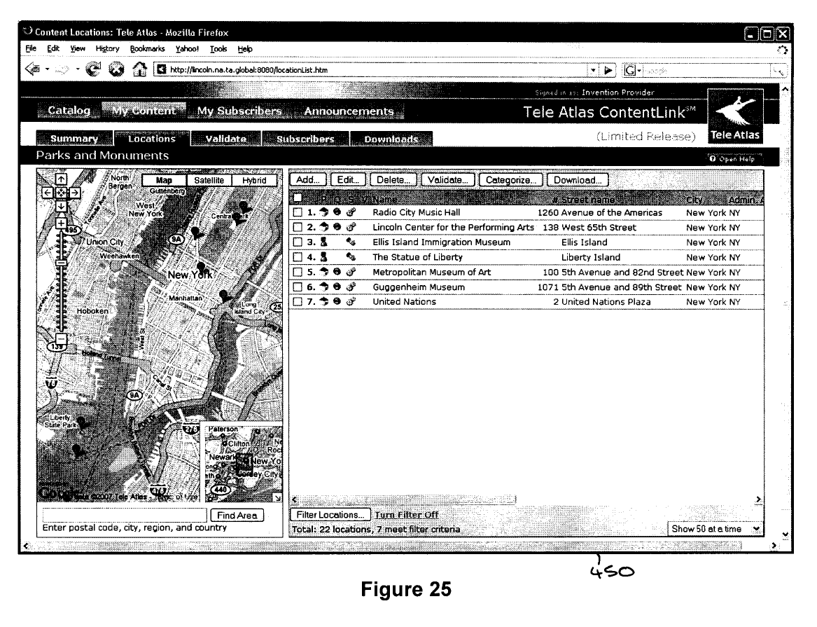

FIG. 25 shows a screenshot 450 of a Content Provider's POI content portal in accordance with an embodiment, including the results of a filtered search by a Content Provider. This Content Provider screen also shows the number of POI locations that meet the filter criteria and give the option next to the filter button to turn off the filter and return to the full content set list.

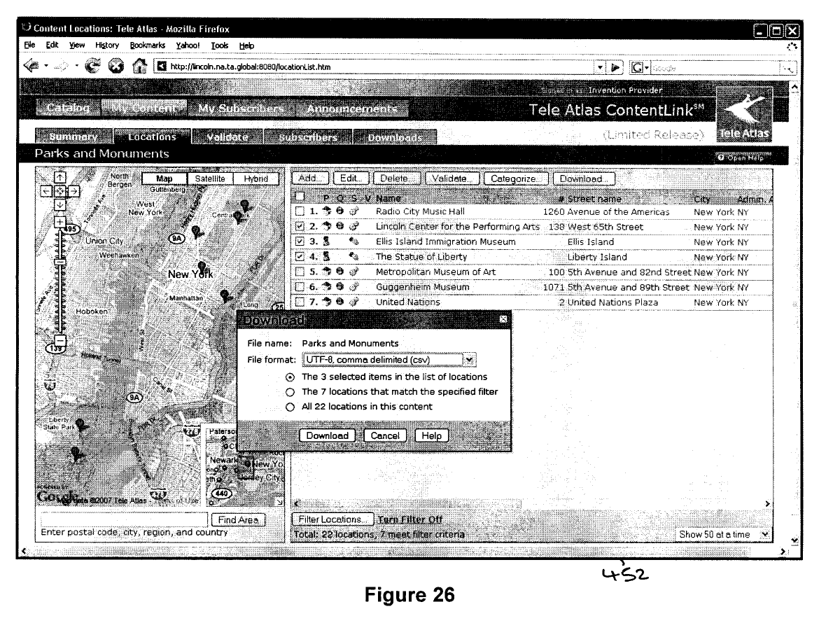

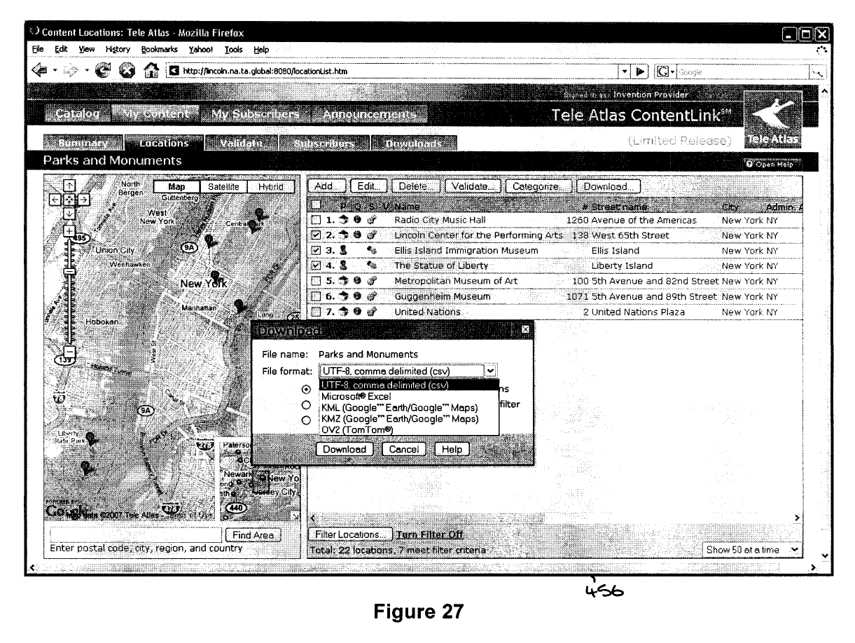

FIG. 26 shows a screenshot 452 of a Content Provider's POI content portal in accordance with an embodiment including a Content Provider dialog that allows a Content Provider to download a subset of the POI, either by means of the filtered choice, manually selected POI, or the entire content set. As shown in FIG. 27, the dialog also allows a Content Provider to choose the download format.

FIG. 27 shows a screenshot 456 of a Content Provider's POI content portal in accordance with an embodiment including a Content Provider dialog that allows a Content Provider to select the download format. It will be evident that other formats can be used in addition to those shown. As mentioned in FIG. 26, the dialog also allows a provider to select the subset of the content or all of the content for download.

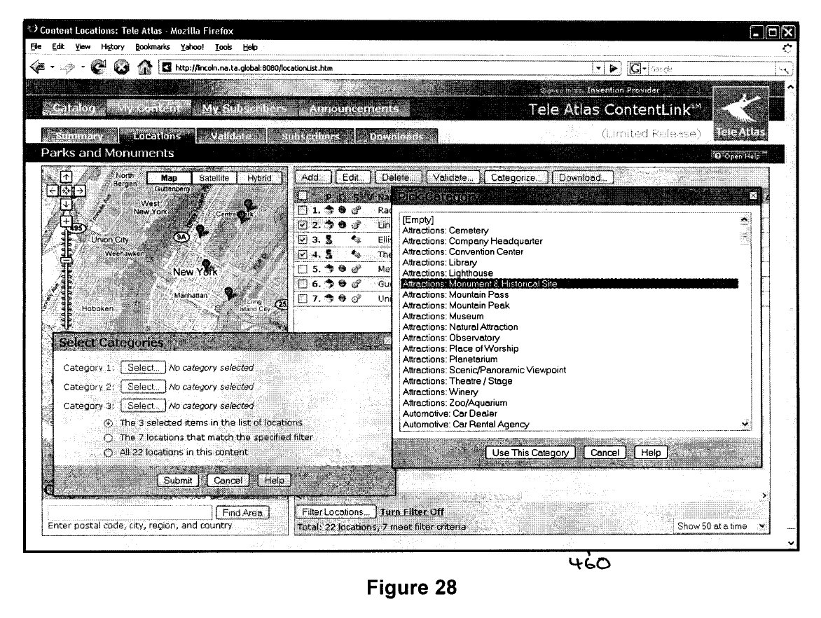

FIG. 28 shows a screenshot 460 of a Content Provider POI content portal in accordance with an embodiment, including a Content Provider Pick Categories dialog that allows a Content Provider to select POI locations to categorize either by filter criteria, manual selection, or all of the POI in the content set. A Content Provider can then optionally select up to three categories to apply to those POI.

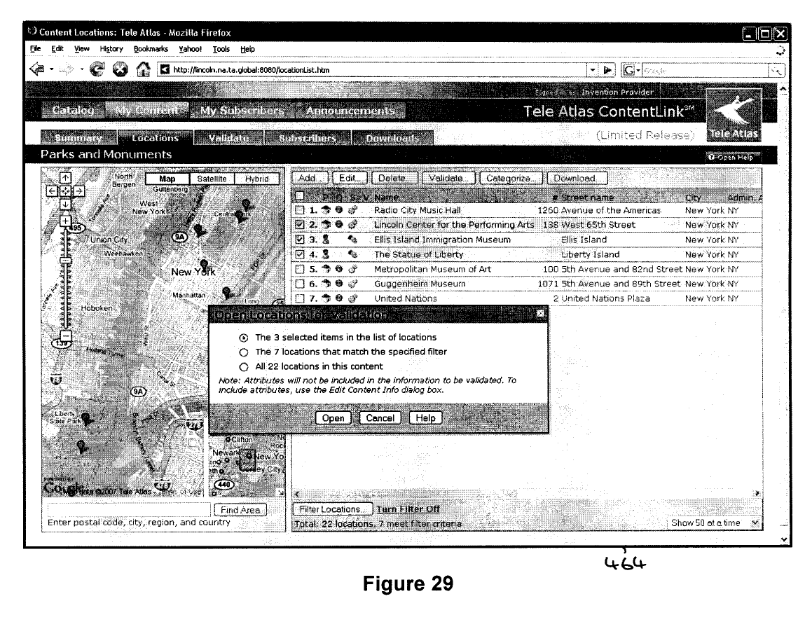

FIG. 29 shows a screenshot 464 of a Content Provider's POI content portal in accordance with an embodiment, including a Content Provider Open Locations for Validation dialog that allows a Content Provider to select POI for validation either by filter criteria, manual selection, or all of the POI in the content set. As shown in FIG. 29, the Open Locations for Validation dialog also indicates whether the Content Provider has optionally chosen to include the attributes for the POI in the validation process. Once POI have been opened for validation, an icon reflecting the validation status (open, returned, accepted) of the POI appears in the “V” field in the POI location list. In an embodiment, when a location is selected for validation the system automatically generates a secure URL for that location that will link the location manager to the POI validation wizard specifically for that location.

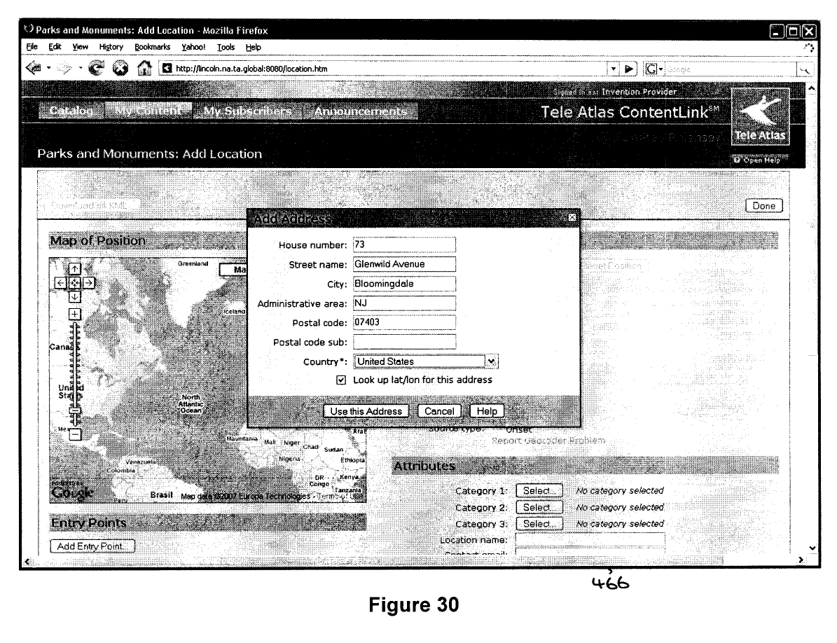

FIG. 30 shows a screenshot 466 of a Content Provider's POI content portal in accordance with an embodiment, including a Content Provider's Add Address dialog that allows a Content Provider to add a new POI to the content set by entering address information, to optionally allow the new entry to be geocoded, and to add all attributes including entry points. The new entry is immediately available to subscribers to the content set. The address information does not have to be complete for the POI entry to be created in the content set.

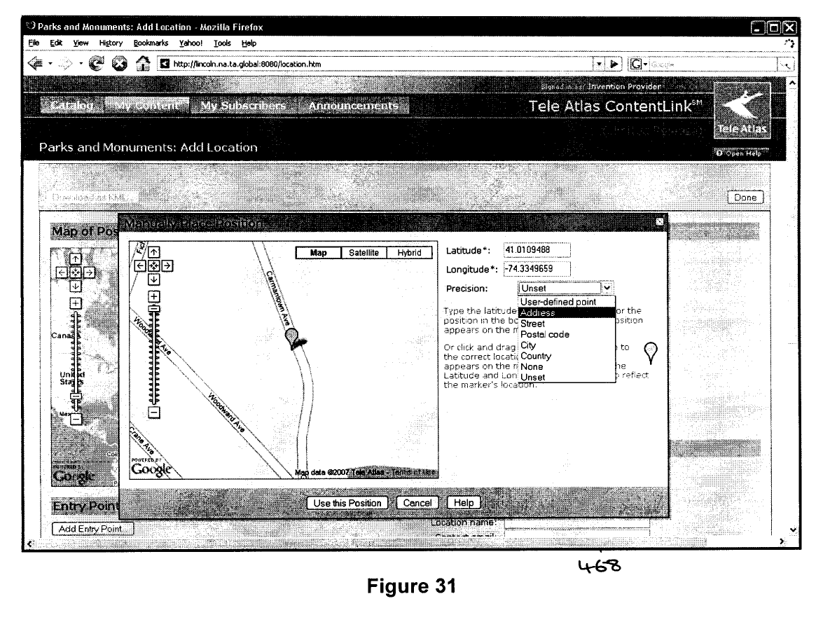

FIG. 31 shows a screenshot 468 of a Content Provider's POI content portal in accordance with an embodiment, including a Content Provider Manually Place Position dialog that allows a Content Provider manually enter a latitude and longitude to add a new POI to the content set and to manually set the address precision of the newly added POI. Alternatively the Content Provider can click and drag the map icon to the correct location for the POI and the latitude and longitude fields will populate accordingly. The Content Provider can then enter all of the attribute information including entry points and address text information. The new entry is immediately available to subscribers to the content set.

FIG. 32 shows a screenshot 470 of a Content Provider's POI content portal in accordance with an embodiment, including a screen that allows a Content Provider to manually select locations for deletion from the content set. Optionally, the Content Provider can also use the filter functionality to select a subset of the content for deletion. The updated content set is immediately available to subscribed users.

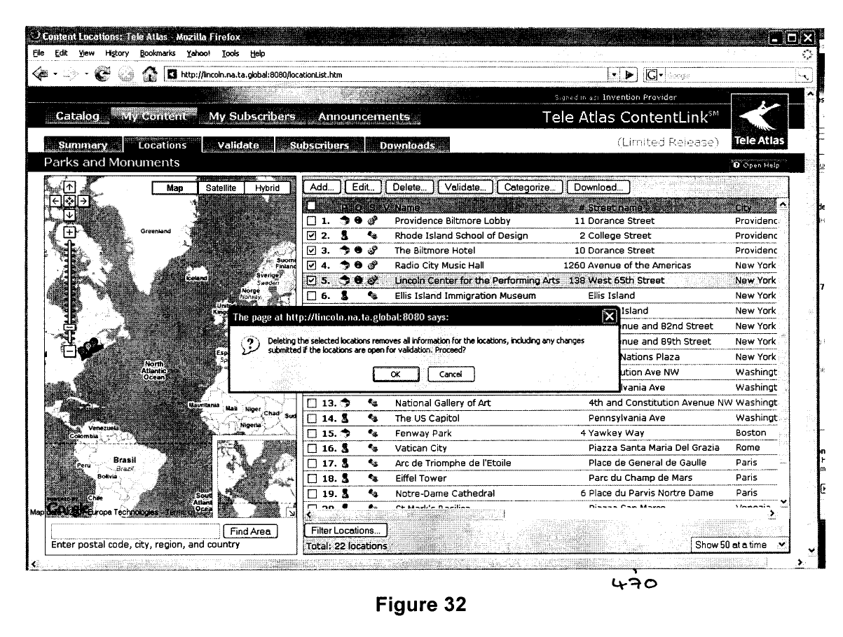

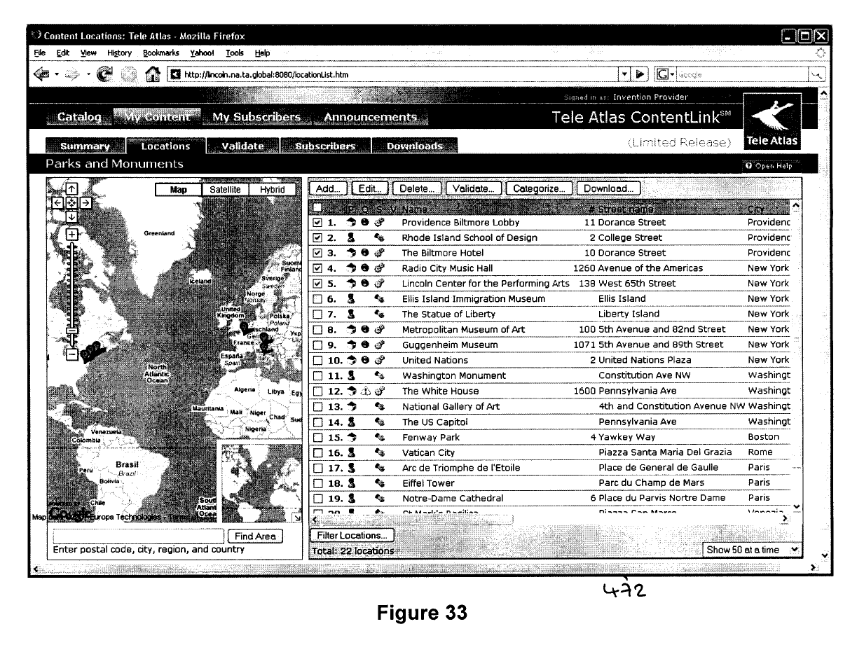

FIG. 33 shows a screenshot 472 of a Content Provider's POI content portal in accordance with an embodiment, including a screen that allows a Content Provider to choose multiple POI entries for editing. Optionally the Content Provider can utilize the filter functionality to select a subset of the content for editing. Once the selection is made, the system will page through each of the editing screens for the selected POI, allowing the Content Provider to move to the next or to go back to the previous POI, until the Content Provider indicates that they are done.

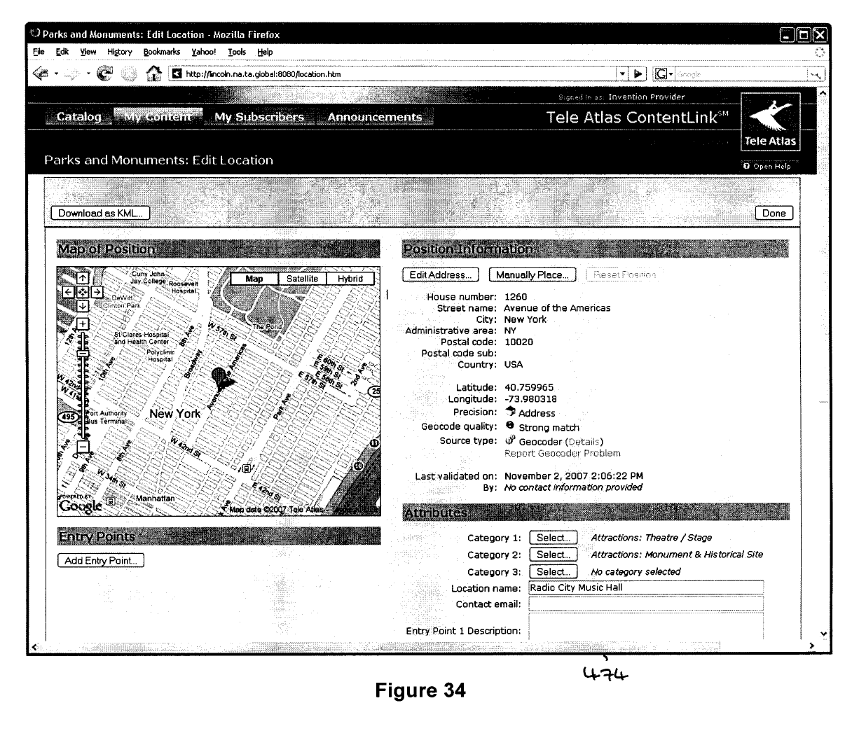

FIG. 34 shows a screenshot 474 of a Content Provider's POI content portal in accordance with an embodiment, including a screen that allows a Content Provider multiple means to update the geographic location of the entry, to update the attributes of a selected POI, or to add or delete entry points. This screen displays all of the information in the system tied to the specific POI. This screen also allows a user to download the individual location as a KML file. Once a Content Provider has edited and saved the entries to the system, the updated content set is immediately available via the portal to subscribing Application Developers.

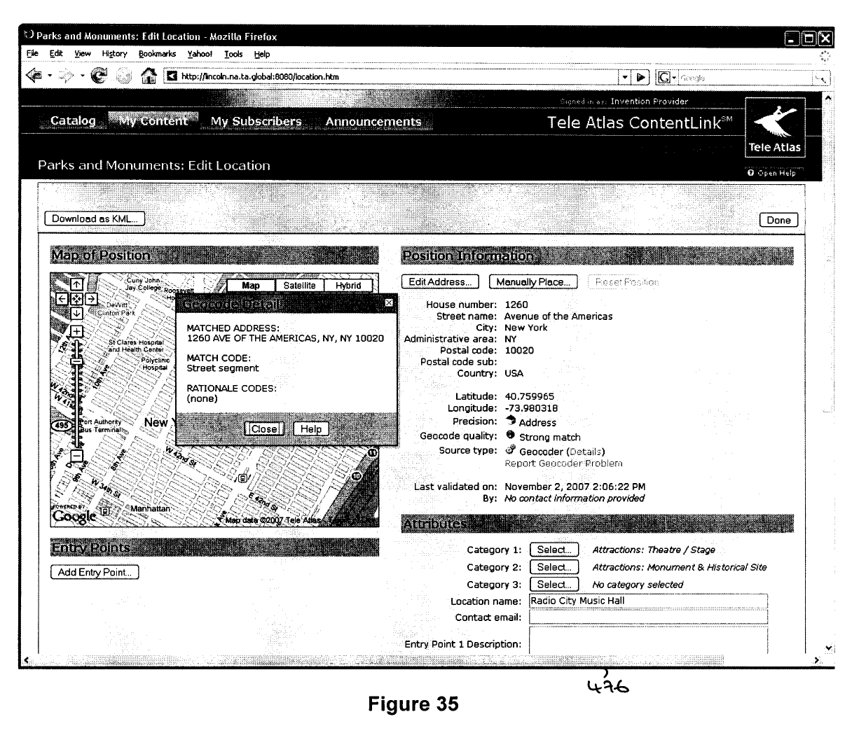

FIG. 35 shows a screenshot 476 of a Content Provider's POI content portal in accordance with an embodiment, including a Content Provider's dialog that gives a Content Provider the details of the geocoding. This information will allow a Content Provider to adjust/edit any details of the address that may be incorrect, allowing the system to return a higher level geocode and a more precise and accurate position on the map. Once a Content Provider has edited and saved the entries to the system, the updated content set is immediately available via the portal to subscribing Application Developers.

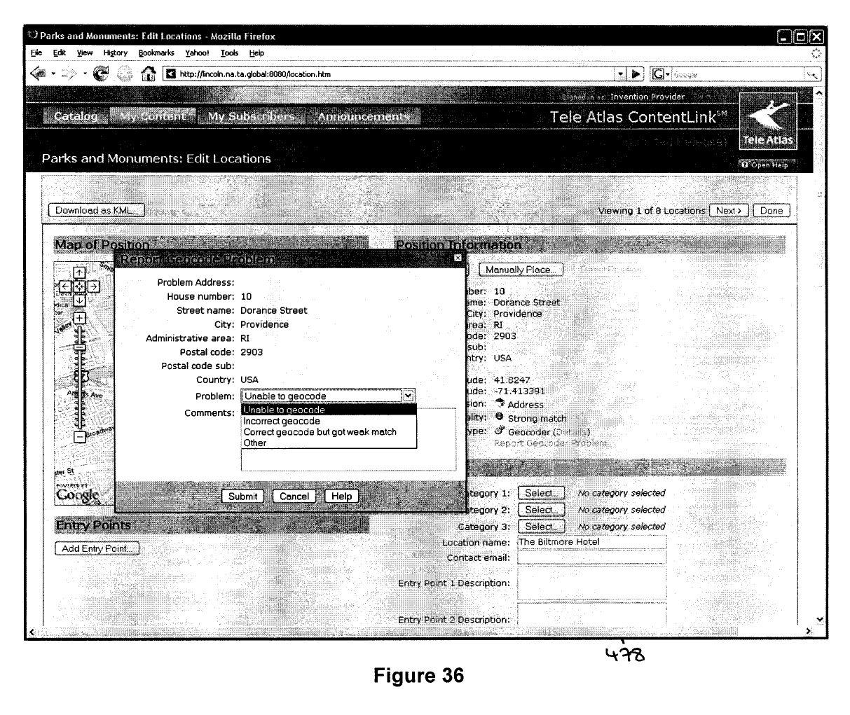

FIG. 36 shows a screenshot 478 of a Content Provider's POI content portal in accordance with an embodiment, including a screen that allows a Content Provider to report geocoding issues directly from the portal. The Report Geocode Problem dialog allows a Content Provider to give direct feedback about the base map data, including a set selection of typical issues as well as a field for comments.

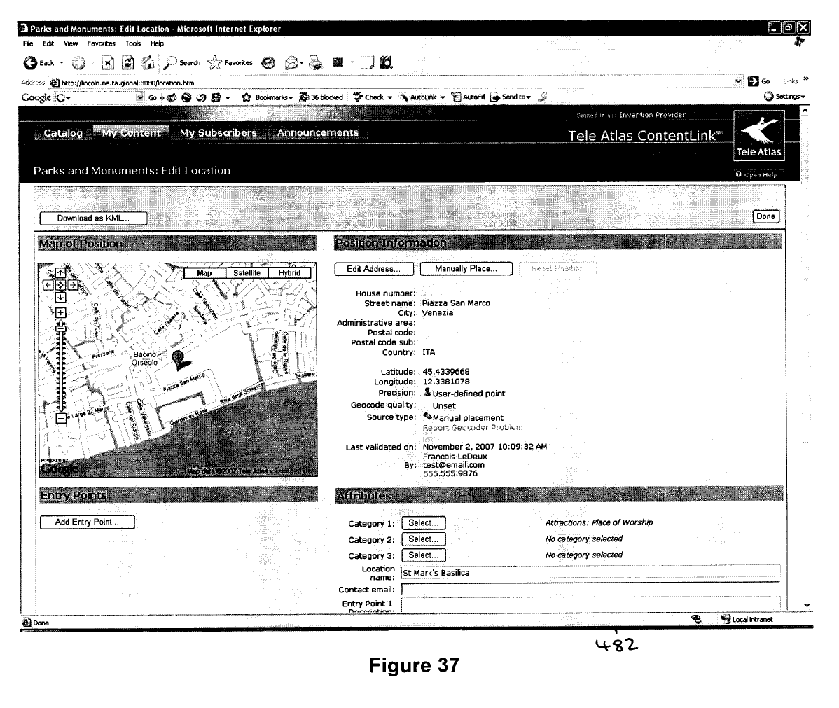

FIG. 37 shows a screenshot 482 of a Content Provider's POI content portal in accordance with an embodiment, including a POI Edit Location screen that allows for a Content Provider to see when a location has been last validated and who submitted the most recent validation information. The validation information will help a Content Provider determine whether or not to select a POI for validation, for example if the POI has not been validated within a certain period, or if the POI has never been sent out for validation. As shown in FIG. 37, the Content Provider's Location Edit screen also supplies the contact information, if the POI location manager chose to include the information upon validation.

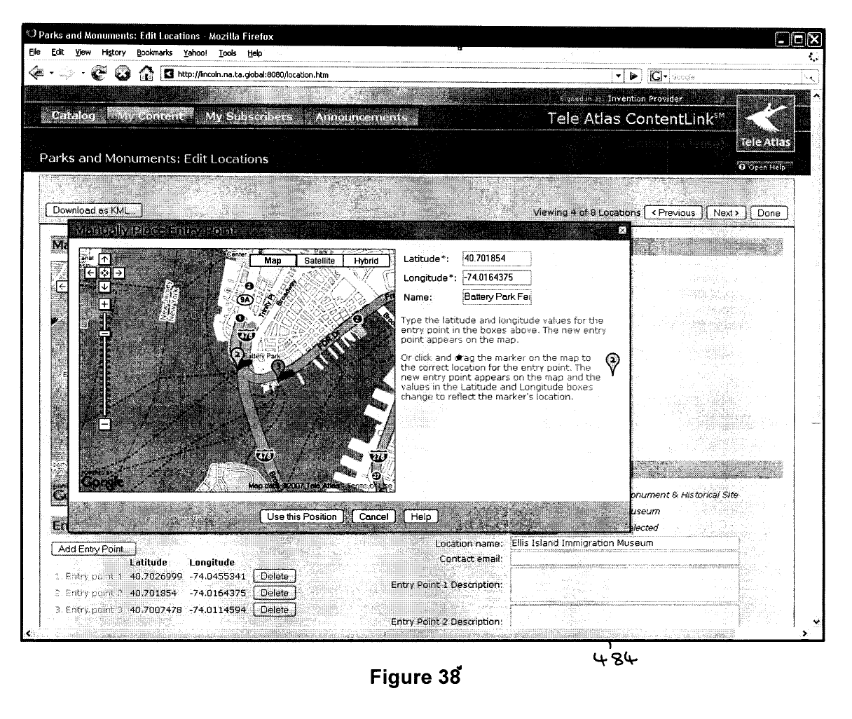

FIG. 38 shows a screenshot 484 of a Content Provider's POI content portal in accordance with an embodiment including a screen that allows a Content Provider to create multiple entry points for a location, and to give each of the entry points a specific name. As shown in FIG. 38, the Content Provider can create multiple points of entry either by entering latitude and longitude into the fields shown, or by clicking and dragging the entry point icon on the map. The Content Provider has the option of entering a name for the entry point, in this example “Battery Park Ferry.” Once a Content Provider has edited and saved the entries to the system, the updated content set is immediately available via the portal to subscribing Application Developers.

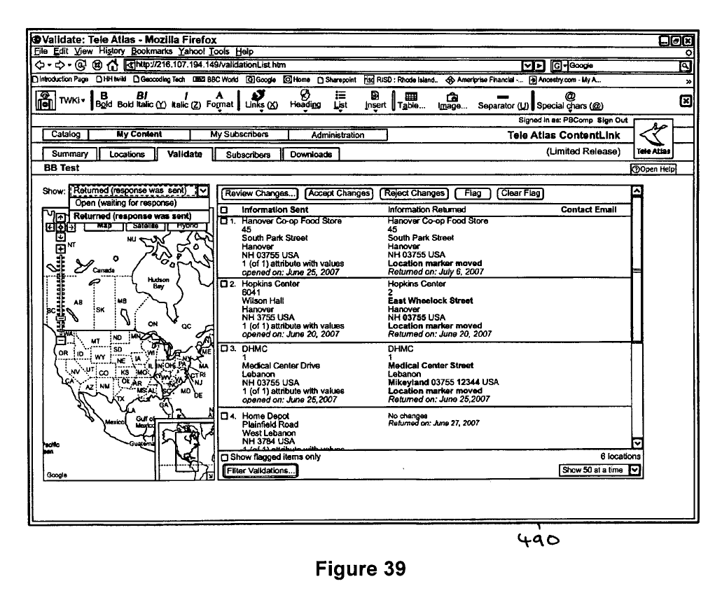

FIGS. 39-42 are screenshots of a POI content portal in accordance with an embodiment that illustrate the POI Validation functionality.

FIG. 39 shows a screenshot 490 of a POI content portal in accordance with an embodiment, including a screen with a Content Provider Validation Tab, together with locations that have been returned to the system. POI locations that have been validated by POI location managers are shown both in the POI location list and are also represented on the map. As shown in FIG. 39, the RETURNED view gives the Content Provider a summary of any changes that have been made, indicates when no changes have been made, and provides a side by side summarized comparison of the address details for before validation (as the POI currently appears in the content set) and after validation (with input from the POI location manager). The RETURNED view also gives the Content Provider access to a set of actions that they can take that will affect the state of the validation information including but not limited to selecting for review, accepting or rejecting changes, flagging an entry and removing a flag. The Content Provider can also use the filter functionality to sort the RETURNED list. The Content Provider can choose how many POI locations are viewed at the time and can page through the RETURNED list.

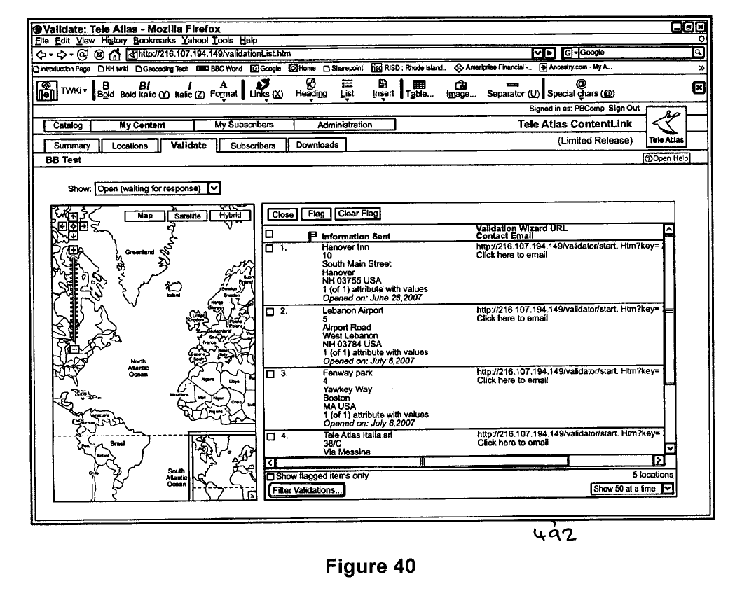

FIG. 40 shows a screenshot 492 of a POI content portal in accordance with an embodiment, including a screen with a Content Provider Validation Tab, together with locations that are still open or out for validation. As shown in FIG. 40 the OPEN view shows the Content Provider the current POI address information in the content set, a count of attributes with values, and date when the POI was opened for validation. The OPEN view also allows a Content Provider to click on a link that generates an email message that contains the secure system-generated URL for the POI Validation Wizard. The OPEN view also allows a Content Provider to close or to flag validation for a single location, a subset of the OPEN list, or all of the OPEN POI in the list. The Content Provider can also use the filter functionality to sort the OPEN list. The Content Provider can choose how many POI locations are viewed at the time and can page through the OPEN list.

FIG. 41 shows a screenshot 496 of a POI content portal in accordance with an embodiment, including a Content Provider filter dialog that allows a Content Provider to filter POI locations in either their OPEN or RETURNED validation lists. As shown in FIG. 41, the filter allows a Content Provider to search for POI by any of the address components, by geocode source type, by category, by validation date, as well as by levels of geocode quality and precision. The filter also allows a provider to sort only on the locations in the current map view or list and not the entire content set. A filtered search will update the map view.

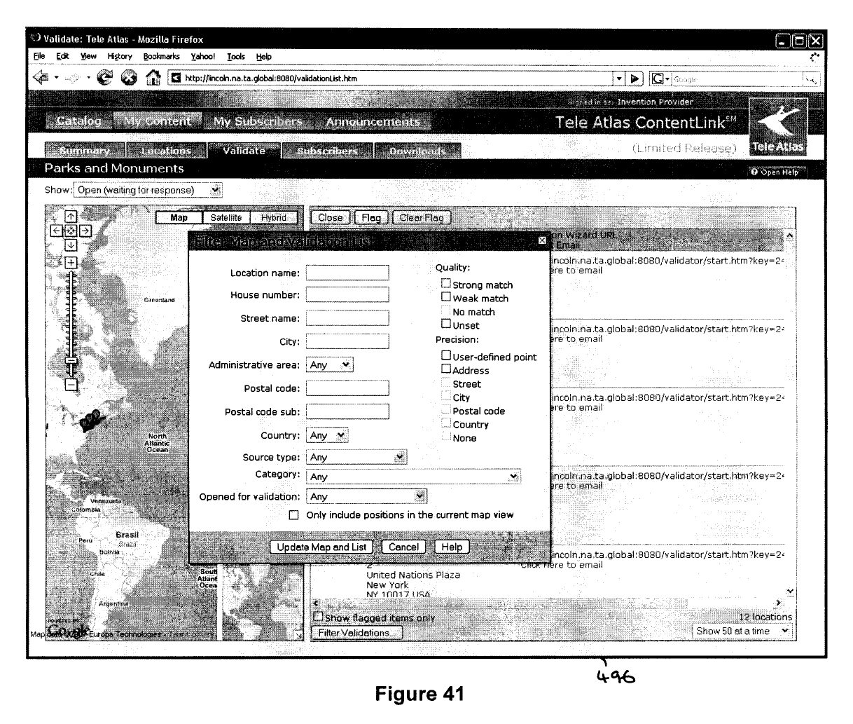

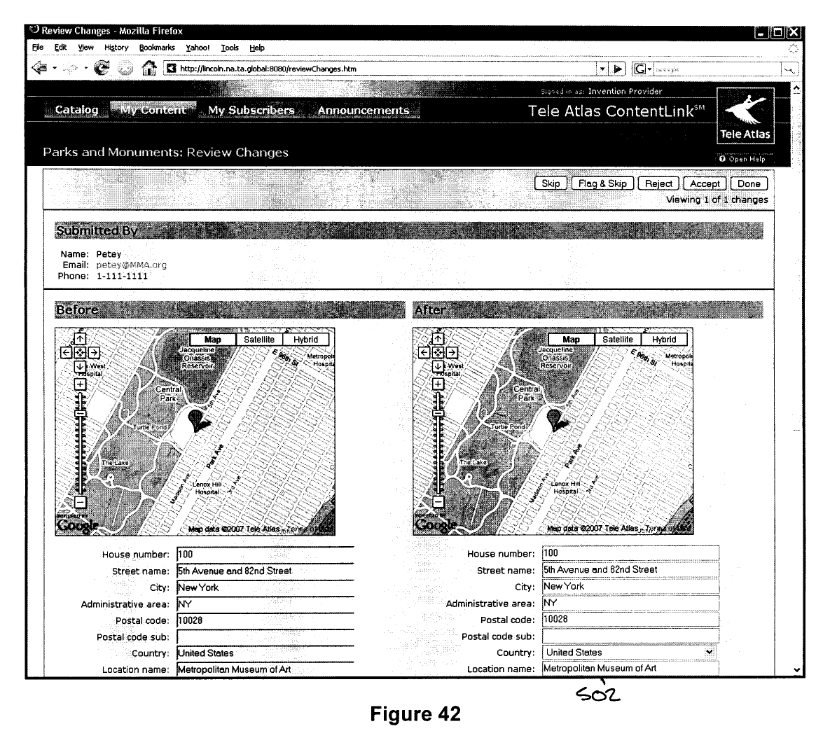

FIG. 42 shows a screenshot 502 of a POI content portal in accordance with an embodiment, including a screen that allows a Content Provider to review changes for a POI location that has been returned for validation, together with action buttons including Skip, Flag & Skip, Reject and Accept. As shown in FIG. 42, the screen provides a side-by-side comparison of the state of the POI address, location, and attribute information in the content with the suggested, if any, changes input by the POI location manager. The screen also allows a Content Provider to further edit the returned information if desired. Once the Content Provider reviews the returned POI information, the Content Provider can choose to skip, to flag and skip the information, which will maintain the POI location in the RETURNED list for further review. The Content Provider can also Accept or Reject the information. If the Content Provider accepts the Returned information for the POI location, the system will overwrite the old entry for the POI in the content set with the accepted information, update the icon on the master POI location list page, and include the details of the validation on the POI Location page. The validated and accepted information is immediately available to subscribed Application Developers. If the Content Provider rejects the RETURNED information about a POI location, no change is made to the POI entry in the content for that POI, and the POI is removed from the validation list. Once the information about the POI location has been accepted, the system makes the updated information immediately available via the portal to subscribing Application Developers.

FIGS. 43-55 are screenshots of a POI content portal in accordance with an embodiment that illustrate the Validation Wizard functionality.

FIG. 43 shows a screenshot 504 of a POI content portal in accordance with an embodiment, including a screen for a Validation Wizard, in particular Page 1 of the Location Managers Validation Wizard showing a choice of languages. In an embodiment, the system detects the native language of the location manager's browser and sets the Wizard to that language. The location manager has the ability to select a different language.

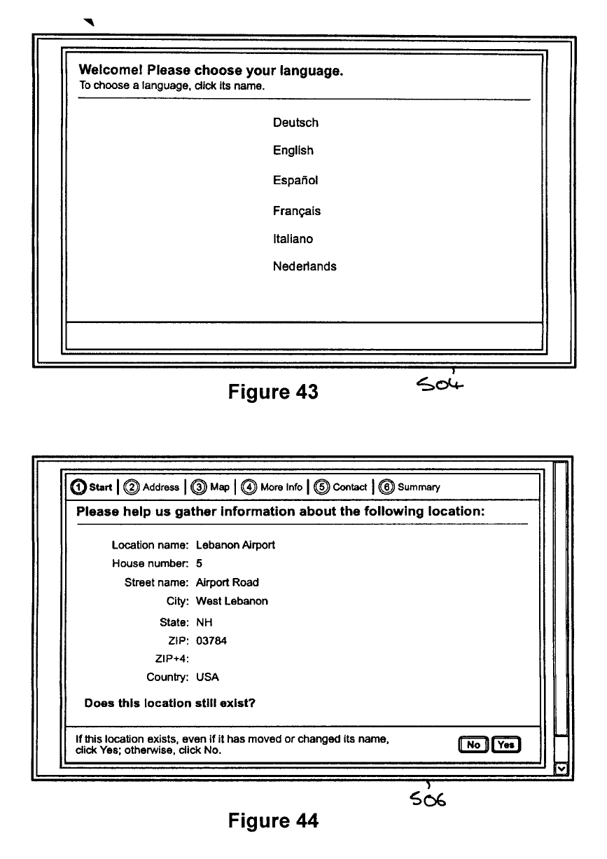

FIG. 44 shows a screenshot 506 of a POI content portal in accordance with an embodiment, including another screen for the Location Managers Validation Wizard that presents the address information of the location for confirmation of the location's continued existence.

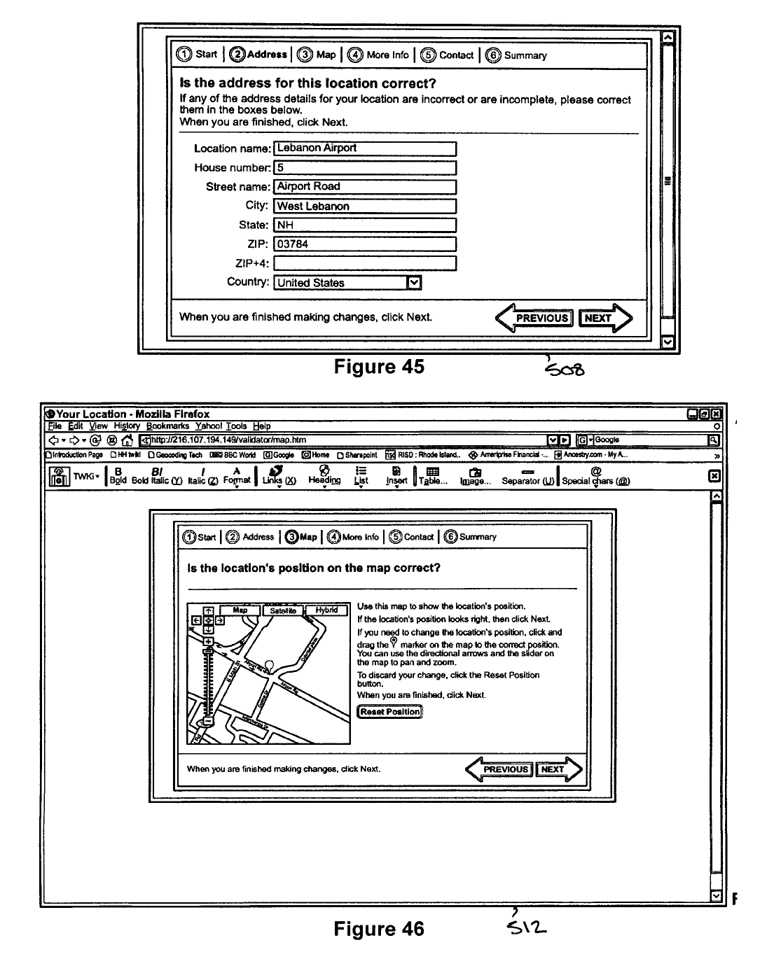

FIG. 45 shows a screenshot 508 of a POI content portal in accordance with an embodiment, including another screen for the Location Managers Validation Wizard that presents the address information of the location for confirmation and asks the location manager to confirm that the POI location still exists.

FIG. 46 shows a screenshot 512 of a POI content portal in accordance with an embodiment, including another screen for the Location Managers Validation Wizard that presents an interactive map showing the geocoded point of the location for confirmation, which can be corrected by the user by clicking on the map icon and moving that icon to the correct point.

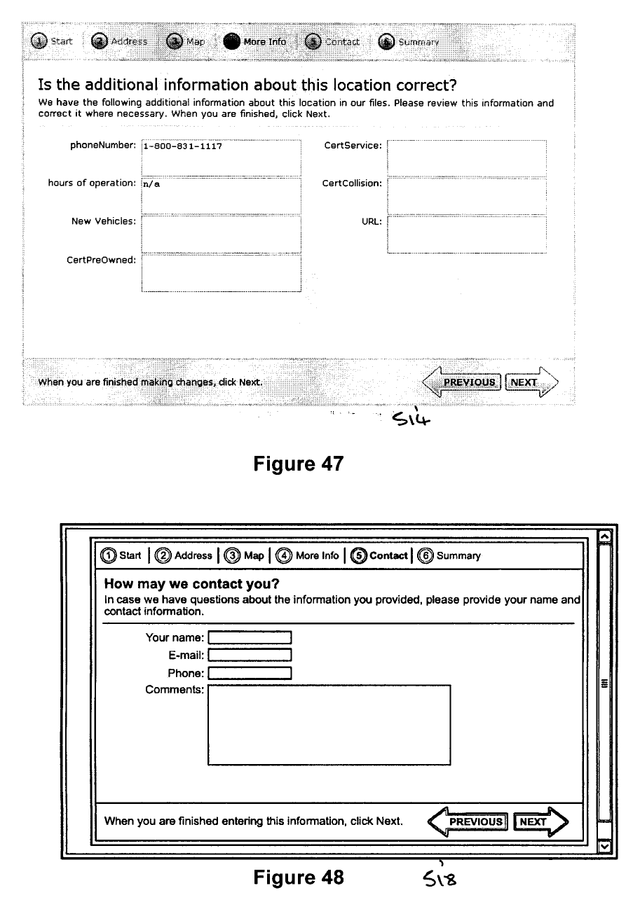

FIG. 47 shows a screenshot 514 of a POI content portal in accordance with an embodiment, including another screen for the Location Managers Validation Wizard, which, at the discretion of the provider, presents the attributes (non-geographic location information) to the user for confirmation and editing.

FIG. 48 shows a screenshot 518 of a POI content portal in accordance with an embodiment, including another screen for the Location Managers Validation Wizard presents a page that the user can optionally input contact information and additional information about the location.

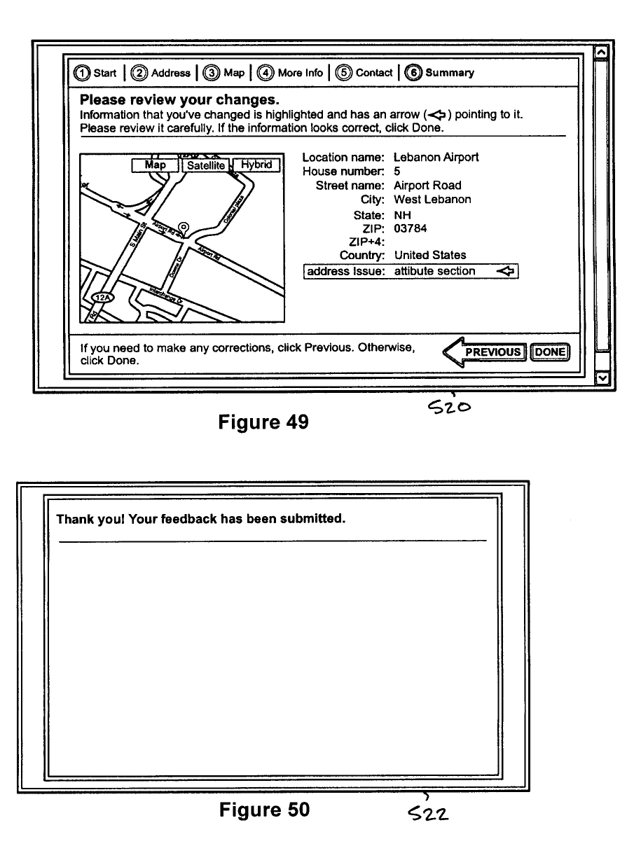

FIG. 49 shows a screenshot 520 of a POI content portal in accordance with an embodiment, including another screen for the Location Managers Validation Wizard, presents a summary of the information including any changes that have been made by the user.

FIG. 50 shows a screenshot 522 of a POI content portal in accordance with an embodiment, including another screen for the Location Managers Validation Wizard acknowledgment that the changes by the user have been submitted.

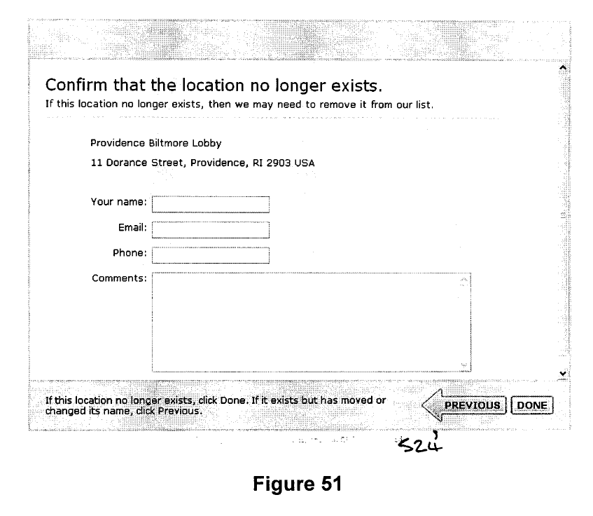

FIG. 51 shows a screenshot 524 of a POI content portal in accordance with an embodiment, including another screen for the Location Managers Validation Wizard that presents the address information of the location for confirmation that the location no longer exists.

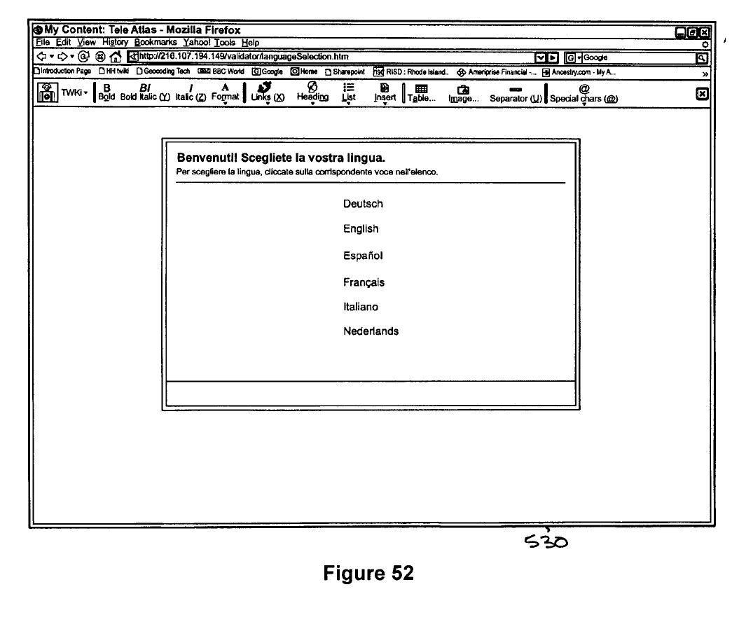

FIG. 52 shows a screenshot 530 of a POI content portal in accordance with an embodiment, including similar pages in the wizard for use in the Italian language.

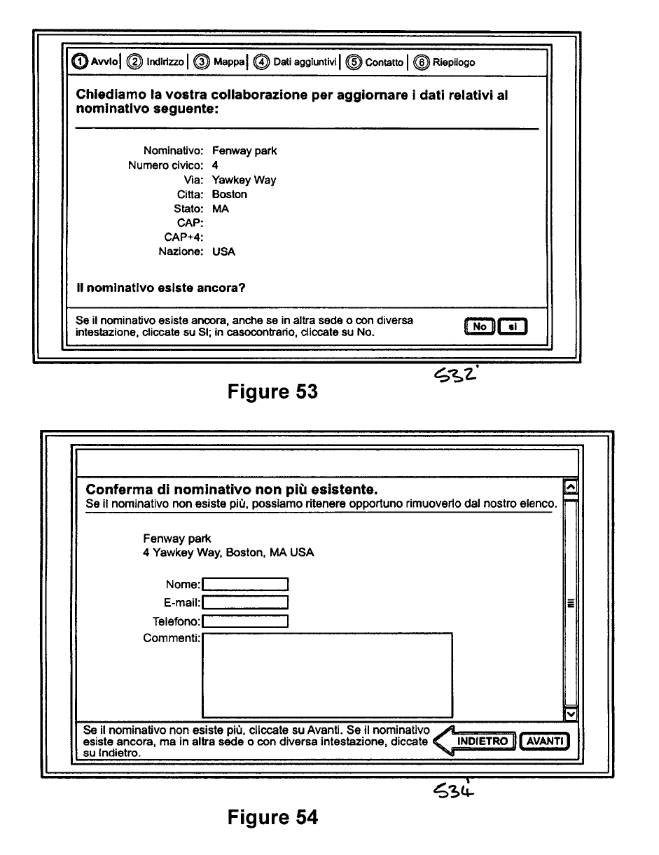

FIG. 53 shows another screenshot 532 of a POI content portal in accordance with an embodiment, for use in the Italian language.

FIG. 54 shows another screenshot 534 of a POI content portal in accordance with an embodiment, for use in the Italian language.

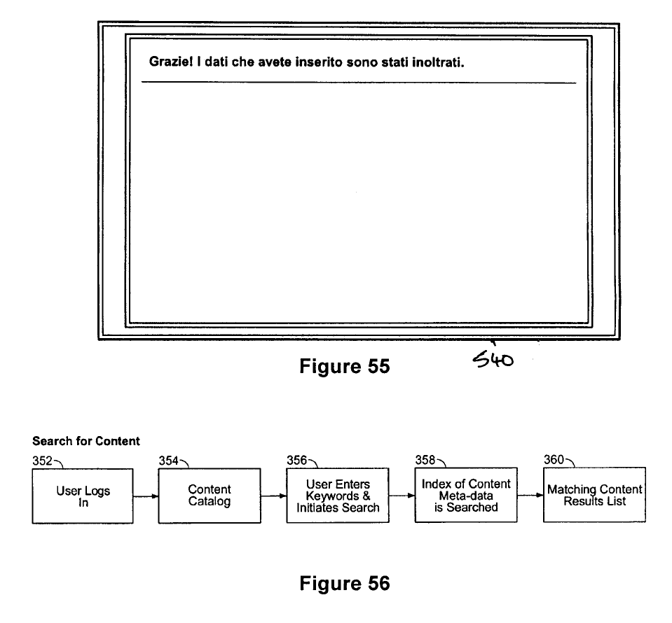

FIG. 55 shows another screenshot 540 of a POI content portal in accordance with an embodiment, for use in the Italian language.

FIGS. 56-68 show screenshots of a POI content portal in accordance with an embodiment that will go through the functionality for a user with Application Developer Access.

FIG. 56 shows a flowchart of a method for allowing a user or Application Developer to search for POI content at a central portal in accordance with an embodiment. As shown in FIG. 25, in step 352, the user logs into the system, and in step 354 navigates to the Content Catalog page. In step 356, the User enters keywords in the search box and initiates a search. In step 358, the system searches for the specified keywords in an index that contains all of the meta-data for all of the content. When the system has completed the search, in step 360, the user sees results that list all available content that meets their search criteria. In accordance with some embodiments, the user does not have to be logged in to utilize this search functionality. In an embodiment, the functionality attached to each content set that supports the search functionality in the catalog may be expanded to include other methods and options.

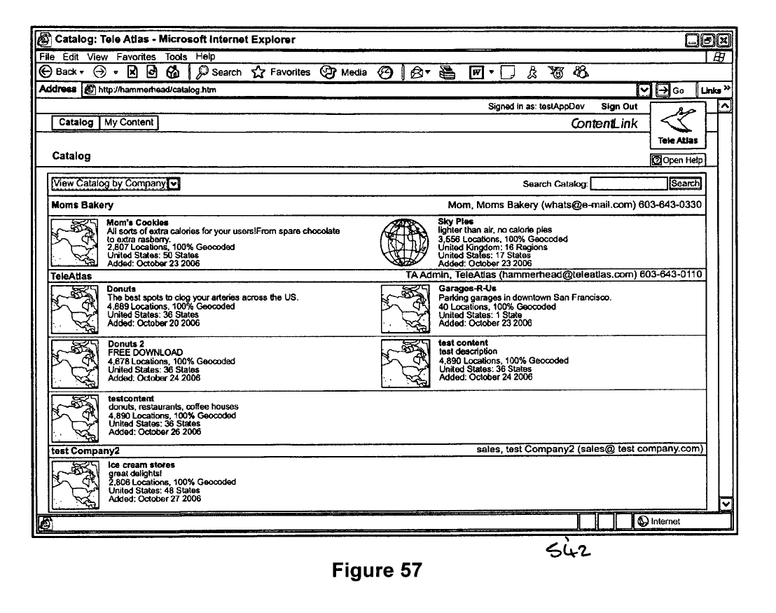

FIG. 57 shows a screenshot 542 of a POI content portal in accordance with an embodiment, including an Application Developer interaction screen for use by an Application Developer in viewing the catalog and available content data set offerings. As shown in FIG. 57, the Application Developer has logged into the system and has access to screens that will allow them to access content to which they have subscribed as well as to the catalog itself as well as to a screen that contains system announcements. The Application Developer's My Content screen also shows the contact information for each content set that is published in the catalog, as well as information regarding the currency of the content set, a brief description and summary of the geographic and geocoding information. As shown in FIG. 57 and the following figures, the system provides screens for use by an Application Developer that resemble those of the Content Provider screens, with the exception that certain features and much of the functionality is restricted to read-only access rather than create or edit access.

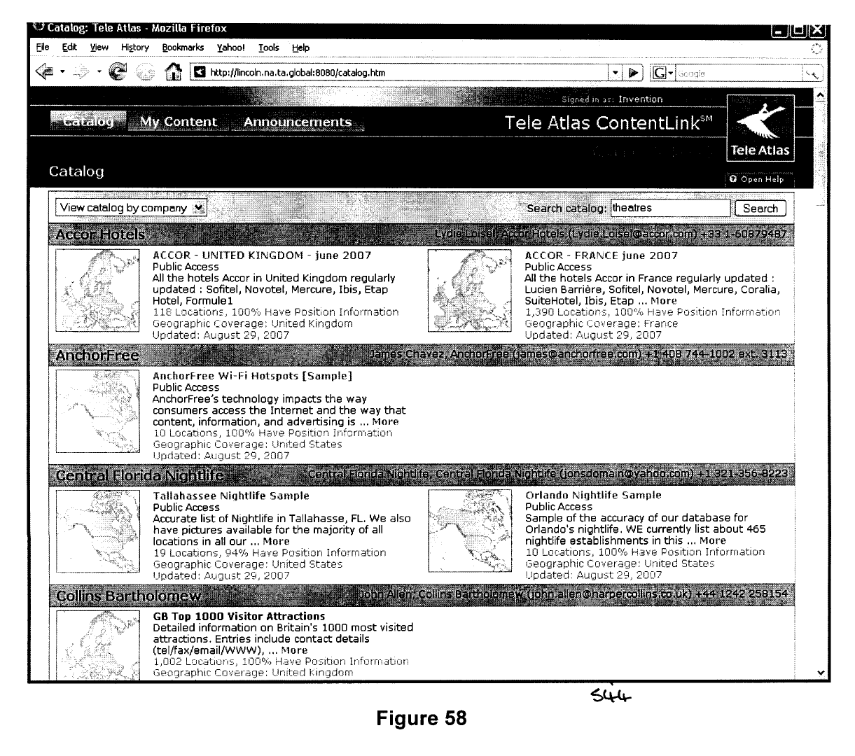

FIG. 58 shows a screenshot 544 of a POI content portal in accordance with an embodiment, including a screen that allows an Application Developer to search for a matching content data set within the catalog. In this case the Application Developer has initiated a keyword search for theatres. As shown in FIG. 58, the user can choose to view catalog sets by company (owner), or by date of content set, or by other criteria. In an embodiment, the functionality attached to each content set that supports the search functionality in the catalog may be expanded to include other methods and option.

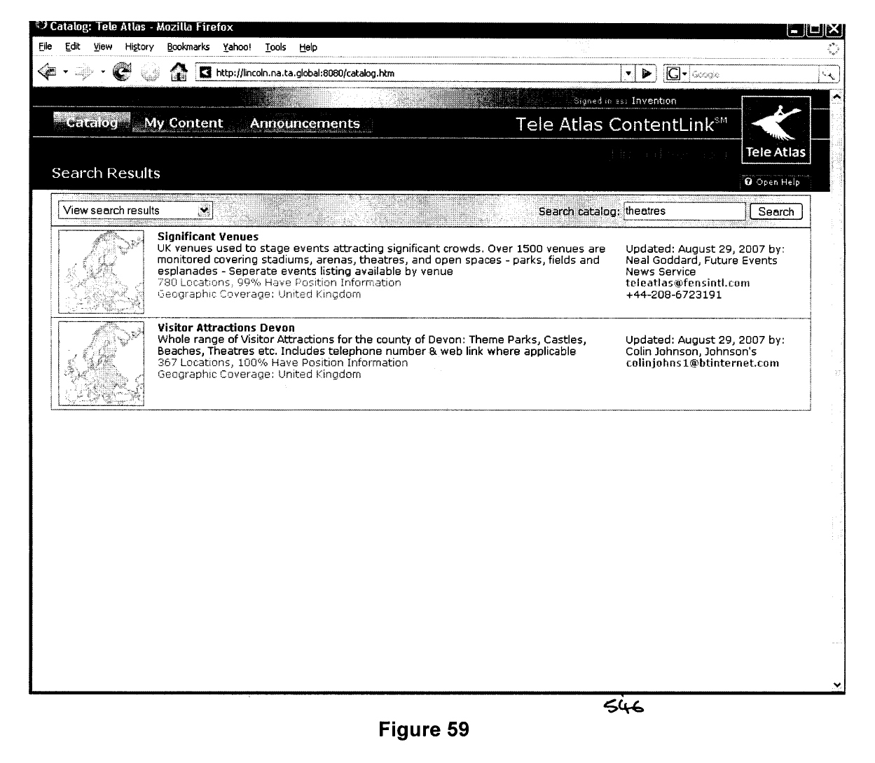

FIG. 59 shows a screenshot 546 of a POI content portal in accordance with an embodiment, including a screen that displays matching content data sets within the catalog that meet the search criteria. The screen also shows that the system will return the contact information for each set of content, as well as information regarding the currency of the content set, a brief description and summary of the geographic and geocoding information. In an embodiment, the functionality attached to each content set that supports the search functionality in the catalog may be expanded to include other methods and options.

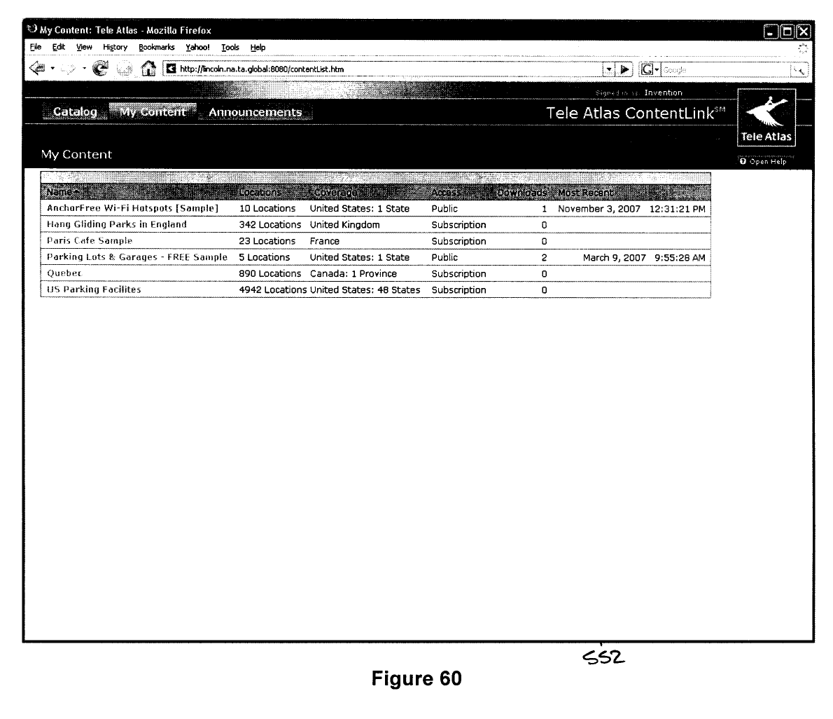

FIG. 60 shows a screenshot 552 of a POI content portal in accordance with an embodiment, including a screen that allows an Application Developer to view their subscribed or public content data sets together with a high level descriptive summary of each content, including the overall geographic coverage, access and the Application Developer's download history of content. As shown in FIG. 60, the screen also gives a summary of the number of times the Application Developer has downloaded the content as well the date of their last download. Once content has been downloaded or subscribed to, the Application Developer can easily view both their subscribed content, and any publicly available content that they have previously downloaded. This makes it easy for the Application Developer to manage their downloaded content data sets, and retrieve additional POI content as necessary to help build their own software application.

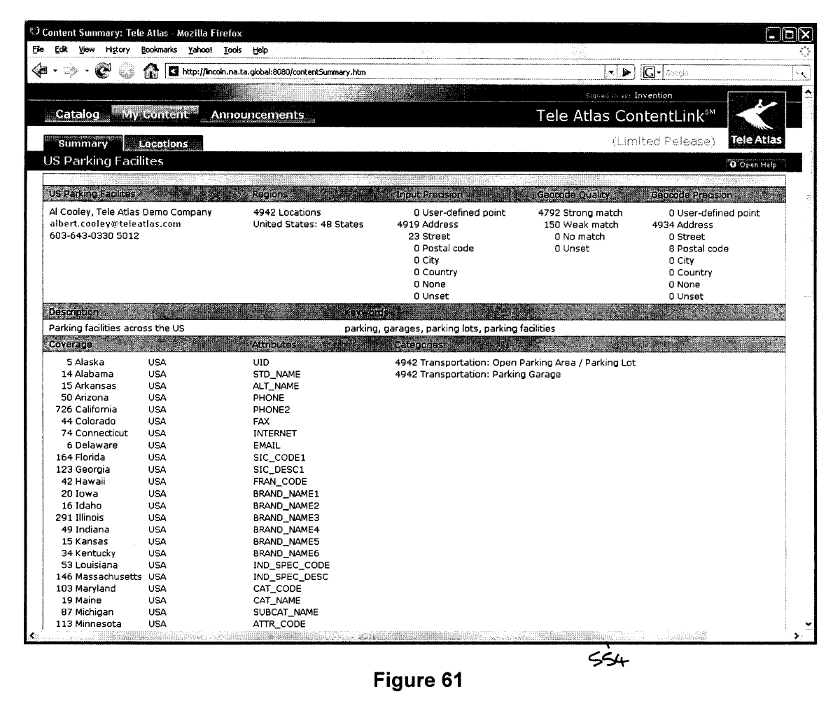

FIG. 61 shows a screenshot 554 of a POI content portal in accordance with an embodiment, including a content summary screen that allows an Application Developer or user to view contact information for the Content Provider company, a summary of the quality of the geocoding, content description and keywords, a summary of the geographic coverage, categories and attributes of the POI within a content data set they are subscribed to. In accordance with an embodiment, access to display and download the POI within a content data set must first be granted by the Content Provider.

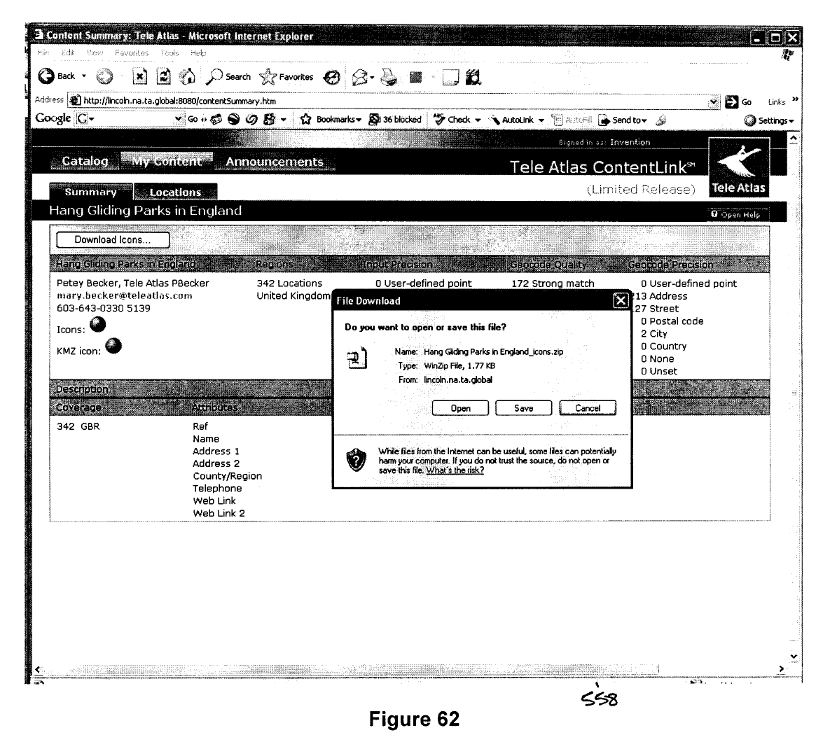

FIG. 62 shows a screenshot 558 of a POI content portal in accordance with an embodiment, including an Application Developer (App Dev) Content Summary page with associated icons and ability to download icons.

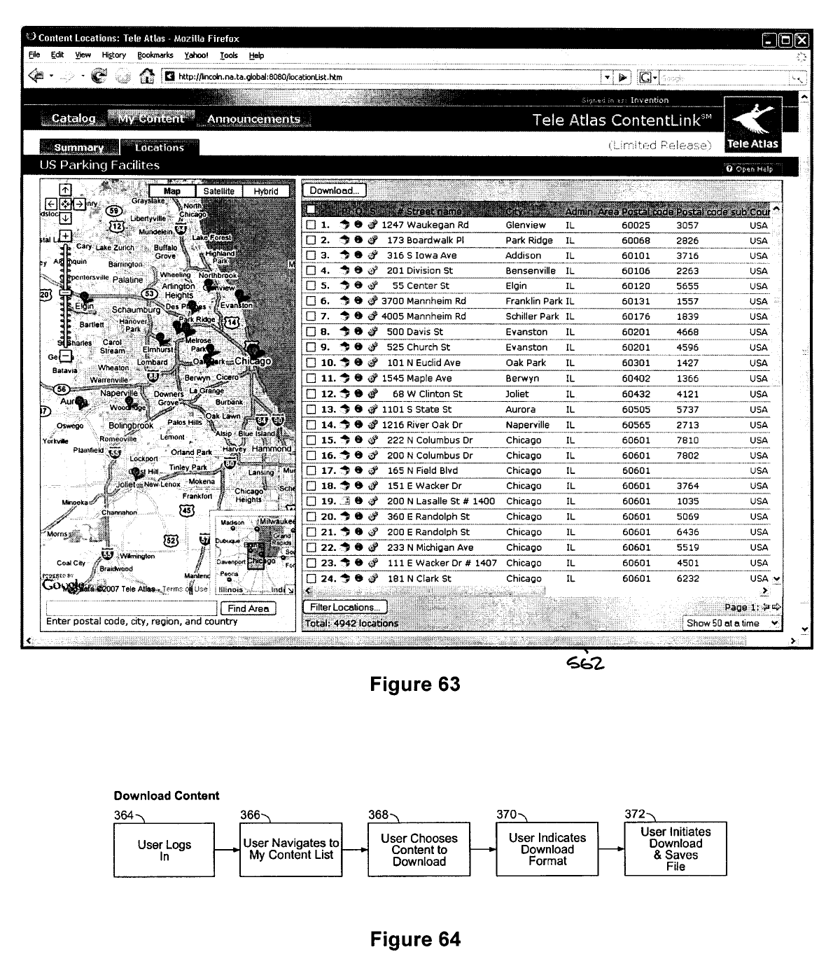

FIG. 63 shows a screenshot 562 of a POI content portal in accordance with an embodiment, including a content locations screen that allows an Application Developer to view a map of content they are subscribed to. The Application Developer can choose the number of POI locations shown on the map; in this case they have chosen to show 50 POI locations at a time. The Application Developer can also see the geocode quality, precision and source of each of the POI locations.

FIG. 64 shows a flowchart of a method for allowing a user or Application Developer to download POI content at a central portal in accordance with an embodiment. As shown in FIG. 64, in step 364, the user logs into the system and, in step 366, again navigates to the Content Catalog page. In accordance with an embodiment, the user can instead be taken directly to My Content page upon log in, bypassing step 366. In step 368, the user navigates to the Content Summary page for the content of interest. In step 370, the user indicates the desired format for the data file, and, in step 372, the user initiates the download, and then saves the downloaded file, for subsequent use in creating software applications.

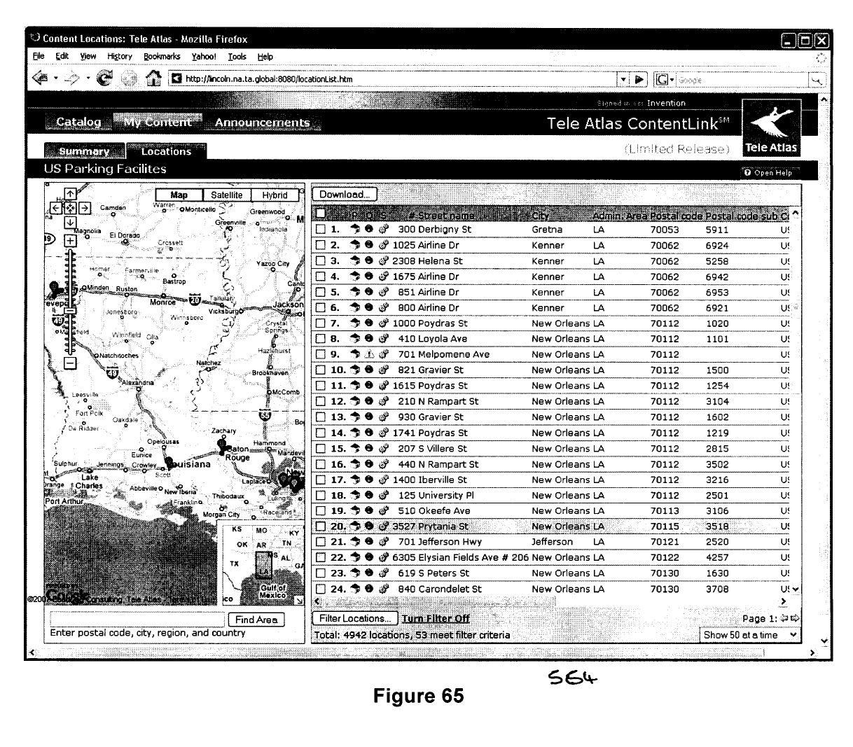

FIG. 65 shows a screenshot 564 of a POI content portal in accordance with an embodiment, including a screen that allows a subscribing Application Developer to view, filter and optionally download POI entries within a selected content data set.

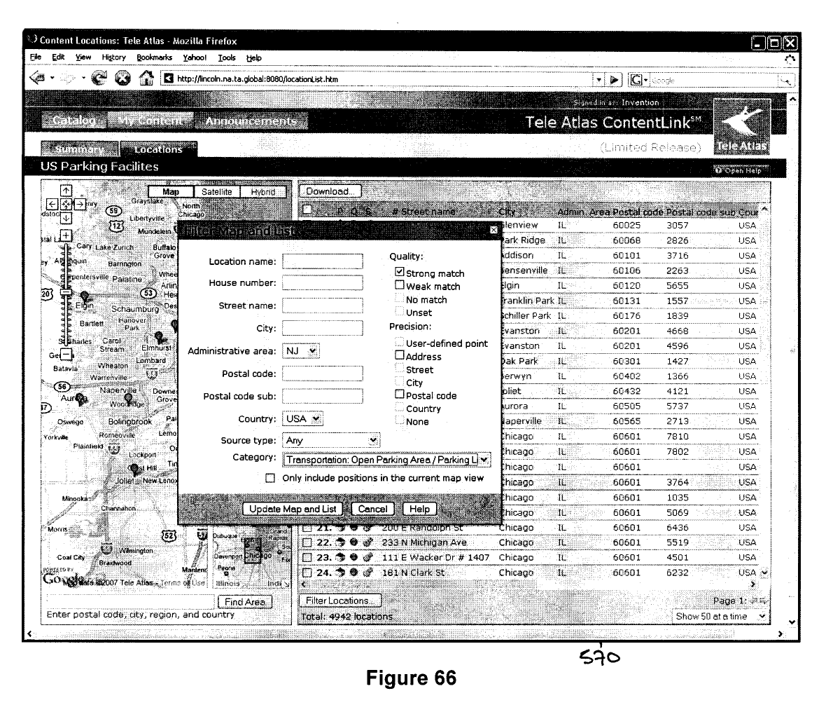

FIG. 66 shows a screenshot 570 of a POI content portal in accordance with an embodiment, including a screen that allows a subscribing Application Developer to filter the POI so that a subset of the POI is returned for review or for download of that subset. In this example the Application Developer set the filter to return POI in NJ with the category of Transportation/Open Parking Area/Parking Lot that have been geocoded to a strong match level.

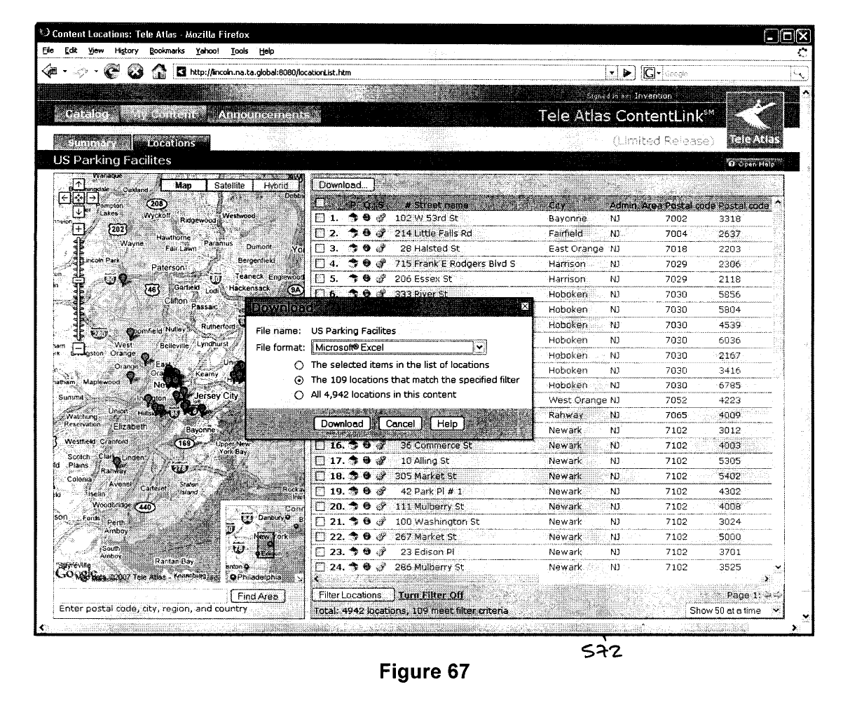

FIG. 67 shows a screenshot 572 of a POI content portal in accordance with an embodiment, including a screen that shows the returned results of the filter settings and a download dialog that allows a subscribing Application Developer to optionally download the filtered list, the entire list, or just a manually selected list.

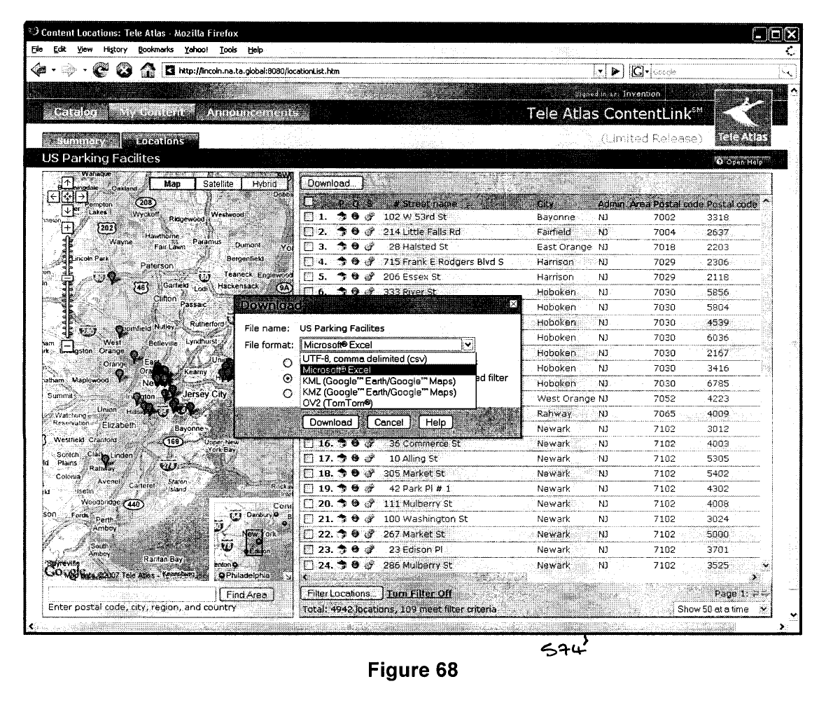

FIG. 68 shows a screenshot 574 of a POI content portal in accordance with an embodiment, including an Application Developer Download page, together with KML and KMZ options. It will be evident that other formats can be used in addition to those shown.

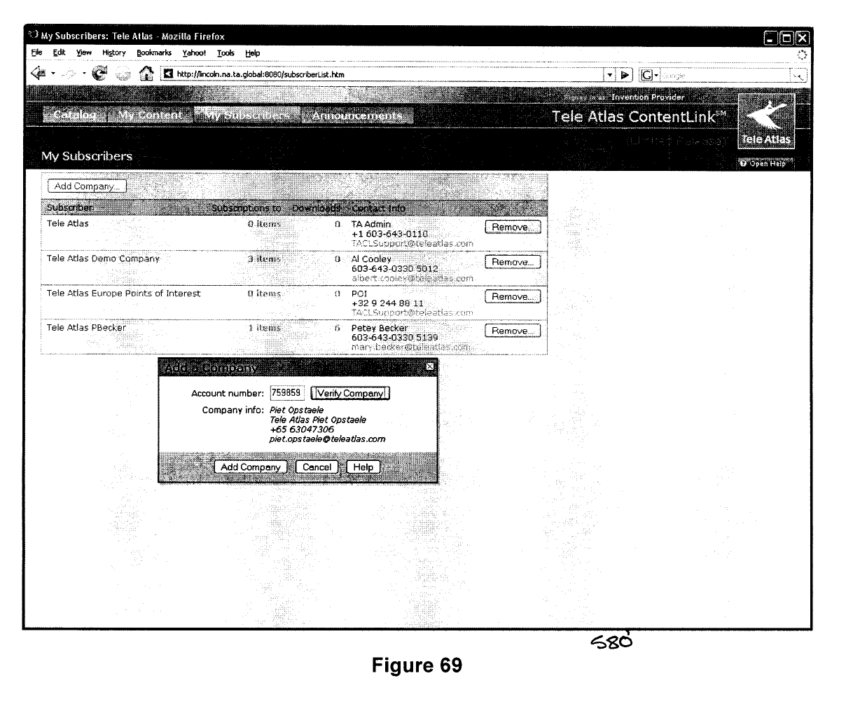

FIGS. 69-72 show screenshots of a POI content portal in accordance with an embodiment that allow a Content Provider to add subscribing companies, to grant access to content sets and to review user download history.

FIG. 69 shows a screenshot 580 of a POI content portal in accordance with an embodiment, including a screen that allows a Content Provider to manage each of their subscribers. As shown in FIG. 69, a Content Provider can add a new Application Developer's company or can remove an existing subscribing Application Developer's company from the master Subscribers tab. The system verifies the name associated with the system-generated account number given to the Content Provider by the Application Developer. As shown in FIG. 69, the system provides that each Application Developer or content subscriber is associated with a unique account number. This account number is then used by the portal to associate subscriptions with the correct POI content, and to record subscriber download activity. In accordance with an embodiment, the system allows a subscriber to be added when that company has been given the Application Developer Role by the Global Administrator. As shown in FIG. 69, the system gives the Content Provider a summary of the number of their content sets accessed by each subscribing company, the overall number of downloads by that subscribing company, as well as the contact information for the subscribing company. In accordance with an embodiment, a Content Provider can use the master subscriber tab to see the download history across multiple content data sets for a specified subscriber, and can access the individual subscriber tab by clicking on the subscriber name. In accordance with an embodiment, access is granted at the company level, not to an individual user, although in some instances the company may be a single person.

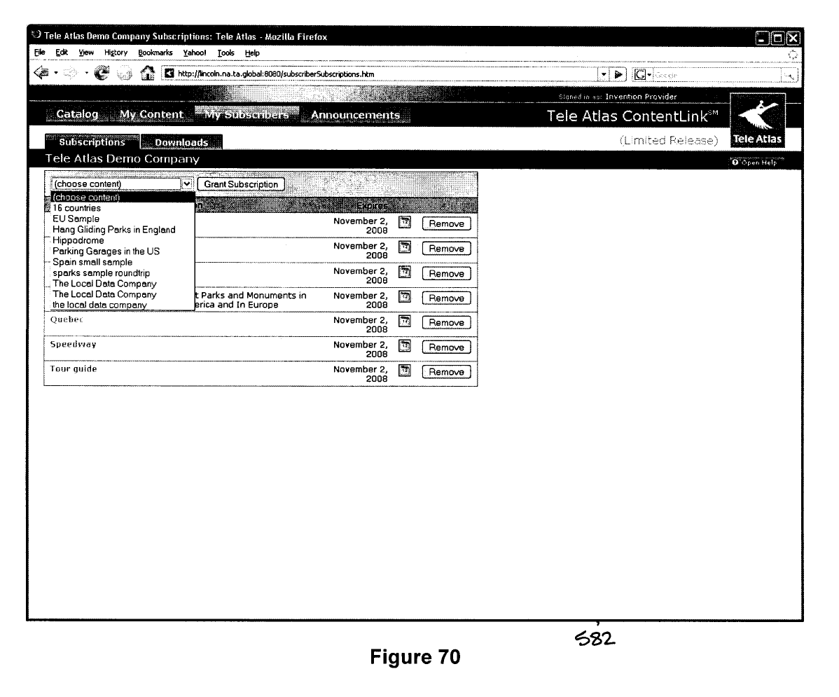

FIG. 70 shows a screenshot 582 of the POI content portal in accordance with an embodiment, including a screen that allows a Content Provider to see all of the content to which an individual Application Developer subscribing company, (in this example Tele Atlas Demo Company) has been granted access to. As shown in FIG. 70, this screen also allows a Content Provider to grant access to that subscribing company to more of the Content Provider's content sets and to also remove access. The Content Provider can also set an expiration date for the access for each content set for that subscribing company. In accordance with an embodiment, a content set does not have to be published to the catalog in order for a Content Provider to grant access to an Application Developer's company. This allows a Content Provider to build customized sets of content for a specific Application Developer's company and to provide access to that customized content via the portal.

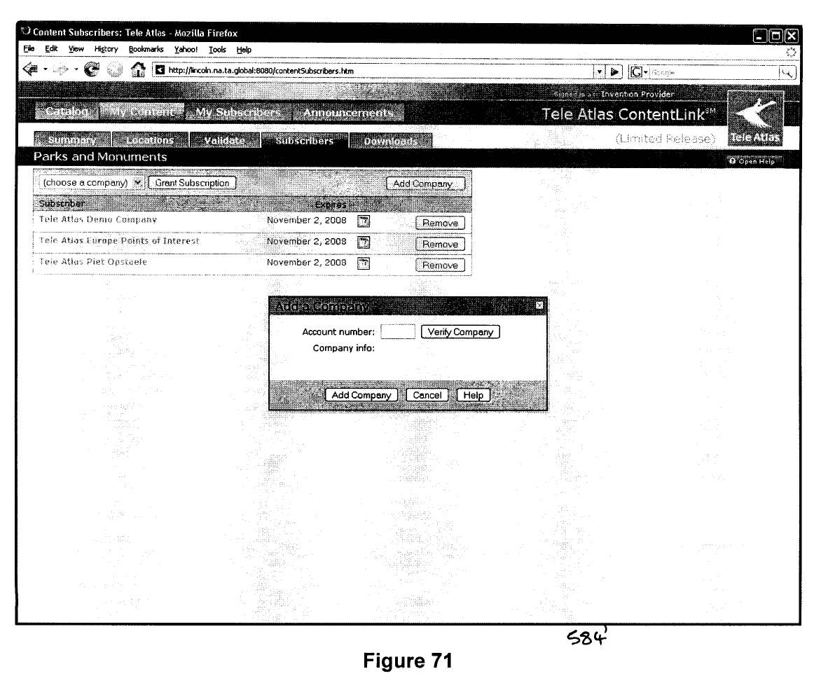

FIG. 71 shows a screenshot 584 of a POI content portal in accordance with an embodiment, including a screen that allows a Content Provider to view all subscribing Application Developer companies to a specific set of content, in this example, Parks and Monuments, and to add a subscribing Application Developer's company drawn from the Content Provider's master My Subscribers list. In accordance with an embodiment, the page used by the system to give a single subscriber access to multiple content data sets is accessed from the master subscribers tab, not from the content subscribers tab. In some embodiments, the system can also provide access to the subscribers tab from this page if the user clicks on the subscriber's name and the Content Provider can also add a new company to their master My Subscribers list from this page by clicking on the “Add Company” button. In accordance with an embodiment, access is granted at the company level, not to an individual user, although in some instances the company may be a single person.

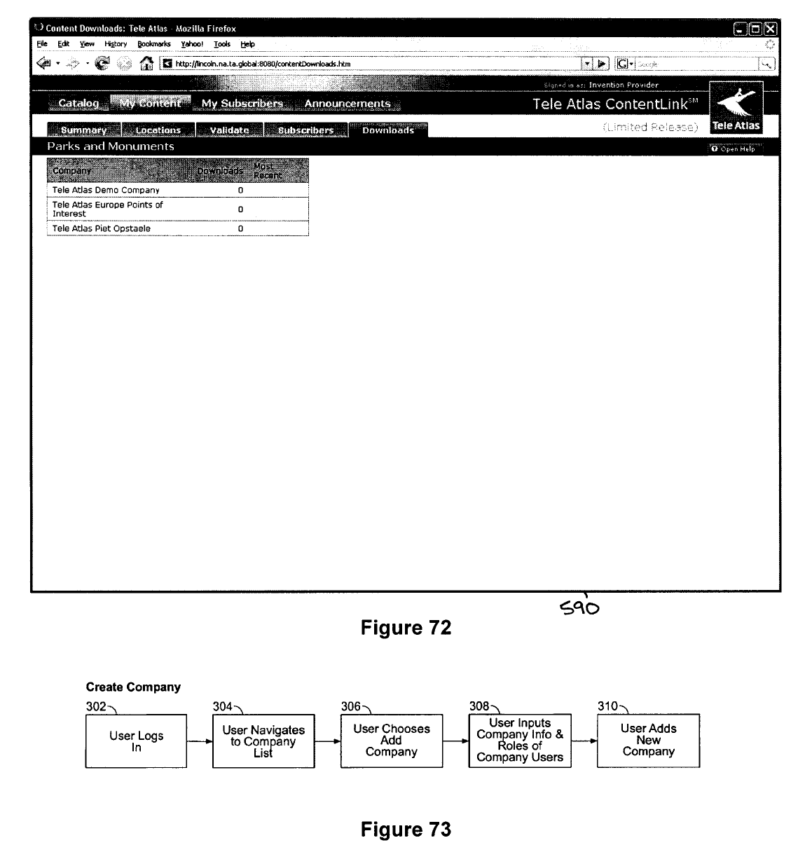

FIG. 72 shows a screenshot 590 of a POI content portal in accordance with an embodiment, including a screen that allows a Content Provider to view all downloads for a specific content set, in this example, Parks and Monuments.

As shown in FIG. 72, the system tracks each download at the portal, including the most recent download activity, for display to the Content Provider.

### Supplemental Administrative Interfaces

In accordance with some embodiments, the system allows for secondary or supplemental roles to be defined for the purpose of account management, in addition to that of the primary Content Provider user. These roles include an Administrator role that allows a user to manage company accounts, and to create additional user accounts; and a Company Administrator role that allows a user to manage user accounts within a single company. It will be evident that additional administrator, company, and other roles can be defined as necessary.

FIG. 73 shows a flowchart of a method in accordance with an embodiment for allowing one of the supplemental roles to interact with the system, particularly for allowing the Global Administrator to create a company to provide POI content at a central portal. As shown in FIG. 21, in step 302, the Global Administrator logs into the system. In step 304, the user then navigates to the Company List page. In step 306, the Global Administrator navigates to the Add Company page, and, in step 308, enters information about the new company, including which roles (for example, Content Provider and/or Application Developer) its users will assume. In step 310, the information is then saved in the portal. In accordance with some embodiments, the system restricts this screen and method to the Global Administrator only.

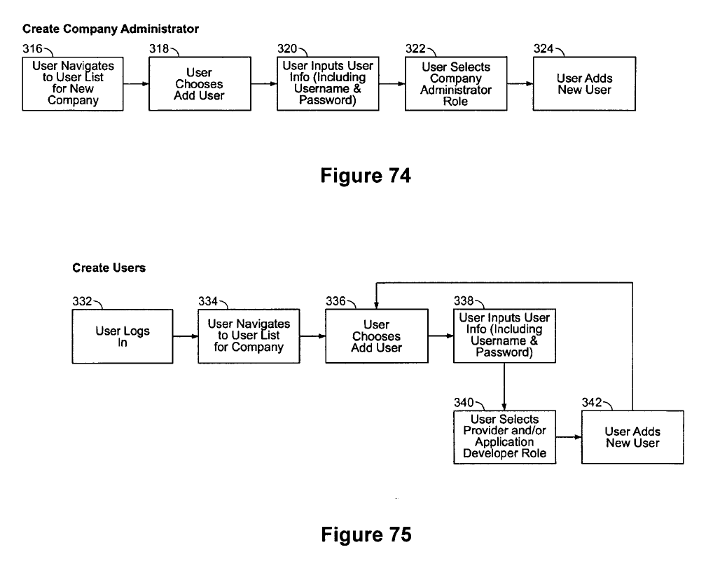

FIG. 74 shows a flowchart of a method for allowing either the Global Administrator, or an individual Company Administrator, to administer a company that provides POI content at a central portal in accordance with an embodiment. As shown in FIG. 22, in step 316, the user navigates to the User List page for the newly added company. In step 318, the user navigates to the Add User page. In step 320, the user enters information about the new user, including their name and password. In step 322, the user then selects Company Administrator as the role for this new user, and, in step 324, adds the Company Administrator user to the portal. This applies to companies no matter which role they have: i.e. Content Provider, or Application Developer, or combined roles. In some situations it is possible that a company may be both a Content Provider and an Application Developer.

FIG. 75 shows a flowchart of a method for creating users for a company at a central portal in accordance with an embodiment. In step 332, the user logs into the system and in step 334 navigates to the User List page. In step 336, the user navigates to the Add User page, and then in step 338 enters information about the new user, including their name and password. In step 340, the user specifies Content Provider, Application Developer, or both, as the role for this new user. In step 342, the user is then added to the portal. In accordance with an embodiment, while the Global Administrator can access all lists and files, an individual Company Administrator will never see the overall company list—instead the Company Administrator clicks on their own administration tab and then clicks on an edit company feature to modify their own company settings. Once the company and Company Administrator is created by the Global Administrator, the Content Provider or the Application Developer companies' Company Administrator can then create additional users. This can be performed by the overall Global Administrator for a company, or by the individual Company Administrator for their specified company.

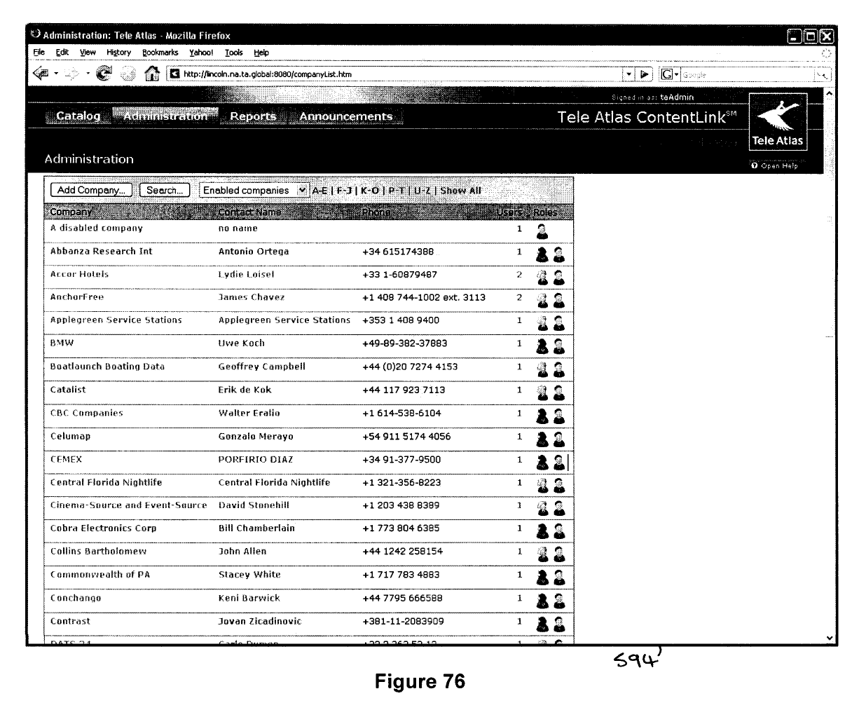

FIGS. 76-82 show screenshots of a POI content portal in accordance with an embodiment that allow a Global Administrator for the system to manage companies and users, to search for companies and users within the system, to create system announcements, and to view usage reports. These screens are available only to the Global Administrator.

FIG. 76 shows screenshot 594 of a POI content portal in accordance with an embodiment that allow a Global Administrator to manage companies and users in the system, as well as to access usage reports and to create system announcements. As shown in FIG. 76, the system allows a Global Administrator to add additional companies, who will subsequently upload and/or download POI content at the portal. The Global Administrator can also drill down to an individual company page to modify a company's contact information. In accordance with an embodiment, an individual Company Administrator can retrieve their own information (only) and can modify it. This page is not accessible to Content Provider companies or to Application Developer companies, but is instead provided to a Global Administrator to enter a company into the system once a reseller (or a Value Added Reseller (VAR)) has been engaged between the Administrator and a third party.)

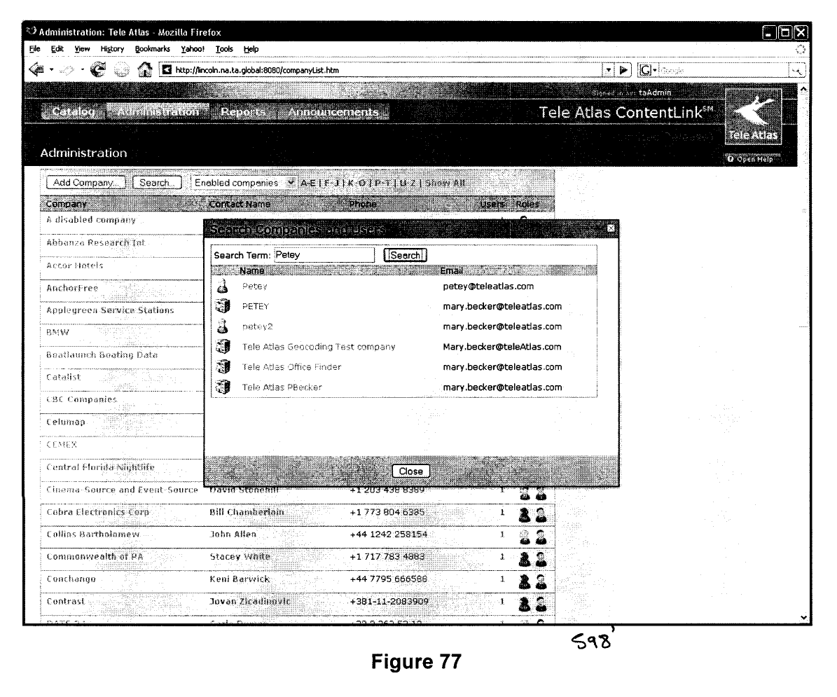

FIG. 77 shows screenshot 598 of a POI content portal in accordance with an embodiment that allow a Global Administrator to search for a company or user with the system. As shown in FIG. 77, the system allows a Global Administrator to enter a term and search for that term through company names and user information.

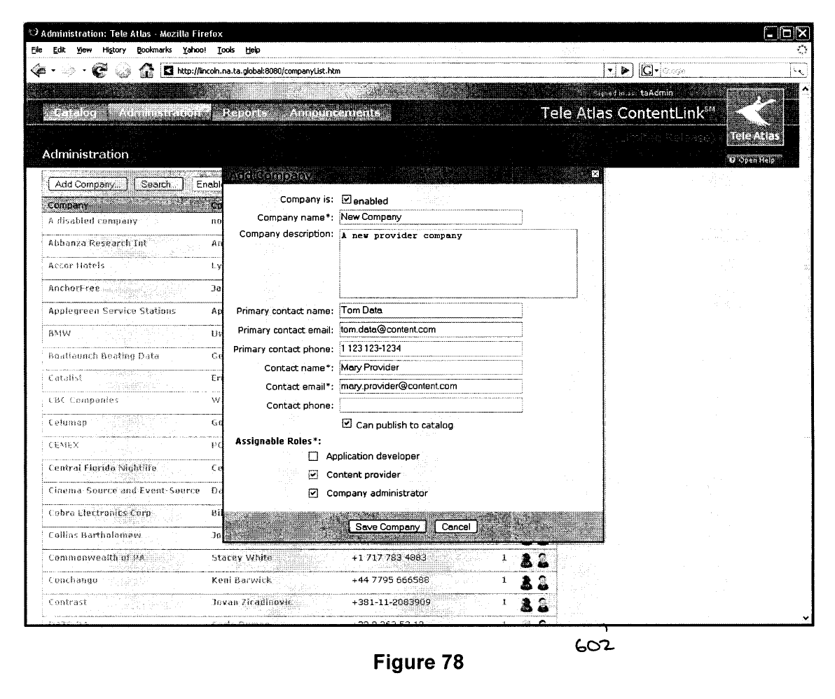

FIG. 78 shows screenshot 602 of a POI content portal in accordance with an embodiment that allow a Global Administrator to create a new company and assign roles to that company, in this example a Content Provider company. It will be evident that a company can have multiple roles and that each company will have a minimum of two roles, Company Administrator being required for all accounts and the role of Content Provider and/or Application Developer. As shown in FIG. 78, the Global Administrator can control access to publishing in the catalog as well.

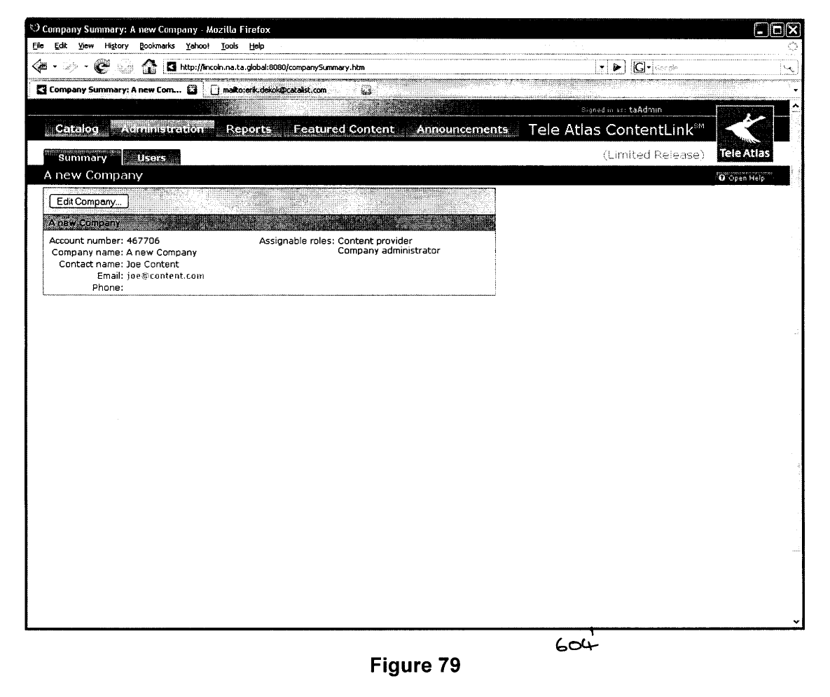

FIG. 79 shows screenshot 604 of a POI content portal in accordance with an embodiment that shows a summary of a new company's account, once the company has been created in the system. As shown in FIG. 79, the system assigns the new company a randomly generated account number. The account number is used by the system to associate subscriptions with the correct POI content, to associate content to the correct provider, and to record user activity.

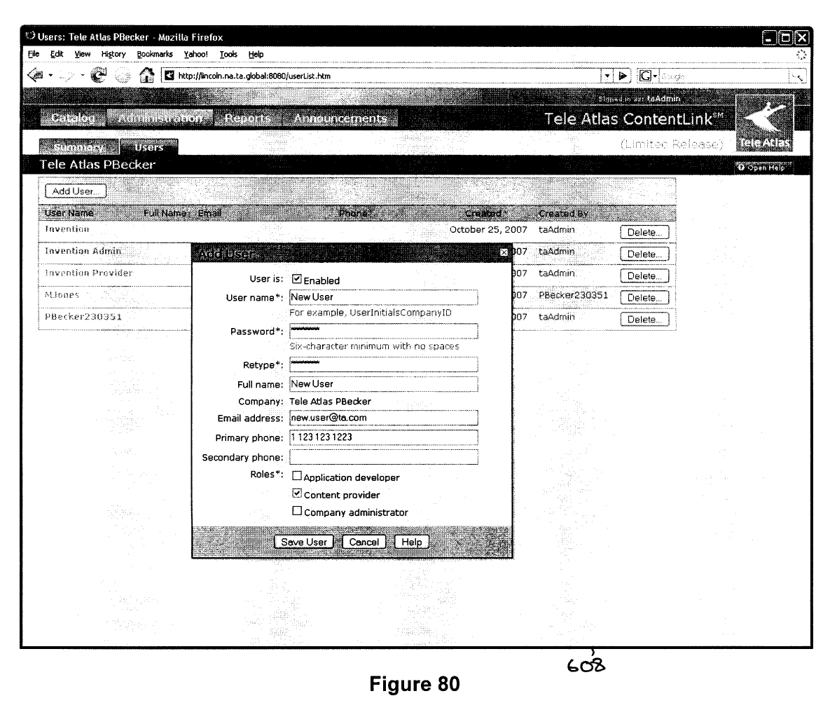

FIG. 80 shows screenshot 608 of a POI content portal in accordance with an embodiment that allow a Global Administrator to create users for a new company and assign those users the appropriate roles. In an embodiment, the Global Administrator can also inactivate a user, or delete them from the system. This functionality is available to a Company Administrator for their company only.

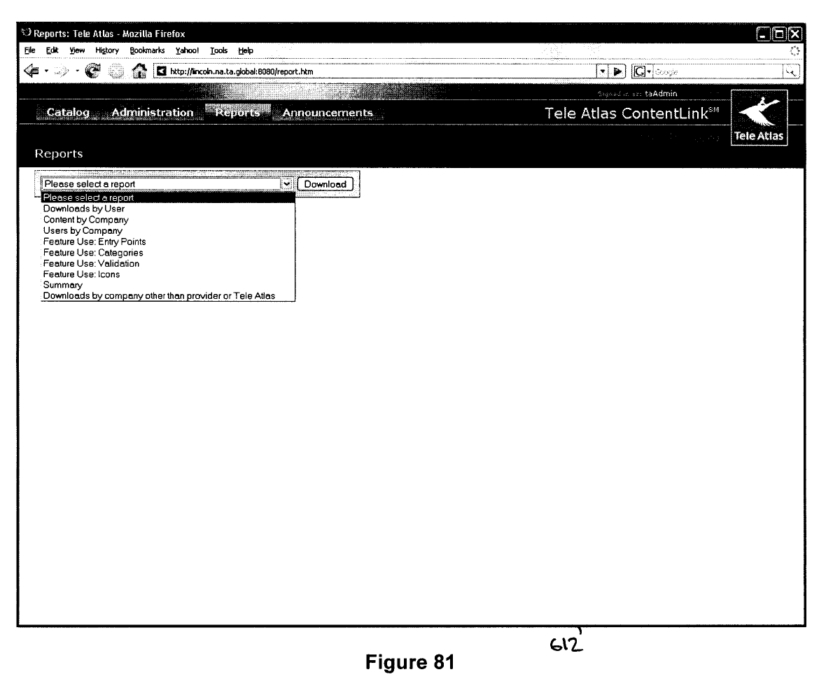

FIG. 81 shows screenshot 612 of a POI content portal in accordance with an embodiment that allow a Global Administrator to view and download system wide reports. These reports can include, but are not limited to, feature usage, download history, content within the system. These reports are available only to the Global Administrator.

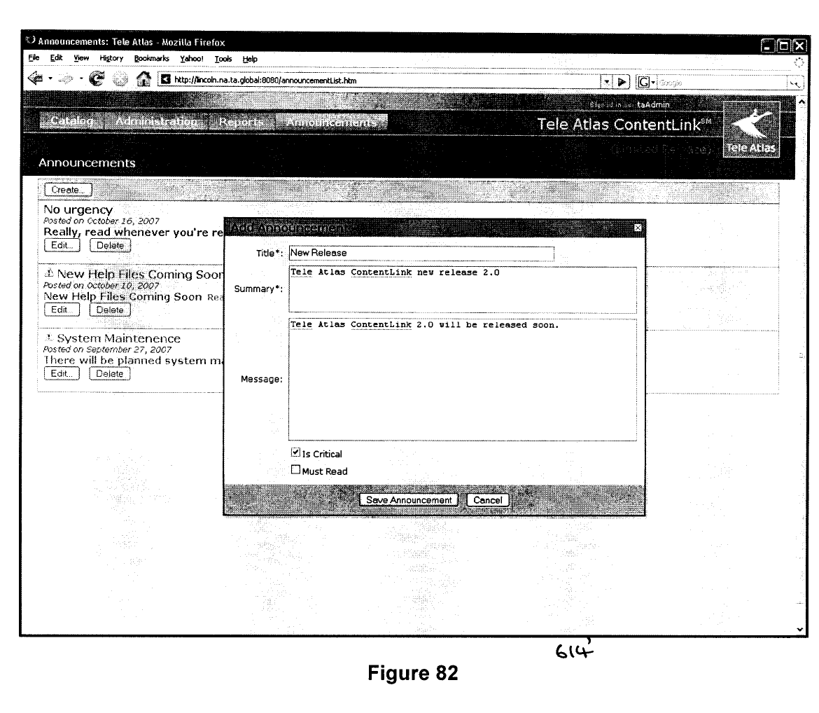

FIG. 82 shows screenshot 614 of a POI content portal in accordance with an embodiment that allow a Global Administrator to create and set priority levels for system announcements. All users of the portal can be driven to critical must-read announcements upon login. Once the users have landed on the announcements page, in subsequent log ins, they can access announcements by going to the Announcements tab once they have logged into the system.

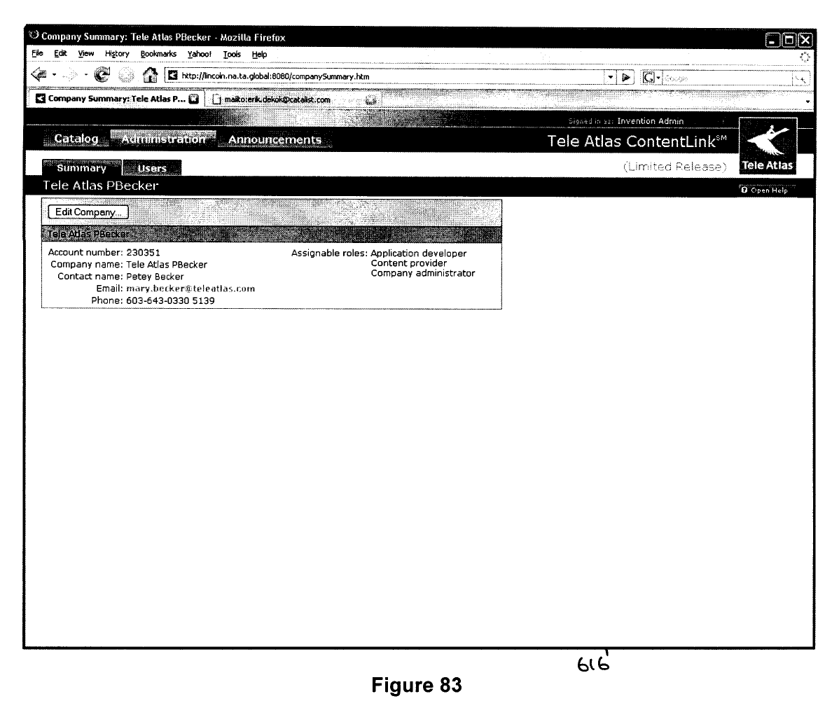

FIGS. 83-85 show screenshots of a POI content portal in accordance with an embodiment that allow a Company Administrator for system to manage users for their company's access to the system.

FIG. 83 shows screenshot 616 of a POI content portal in accordance with an embodiment that allow a Company Administrator to access screens to manage only their own company information and to their own manage users within their company's account in the system. This includes the ability of the Company Administrator to edit their company information, and to add users, to assign roles to their users, to disable a user, and to view system announcements. The Company Administrator can also create another Company Administrator for their company.

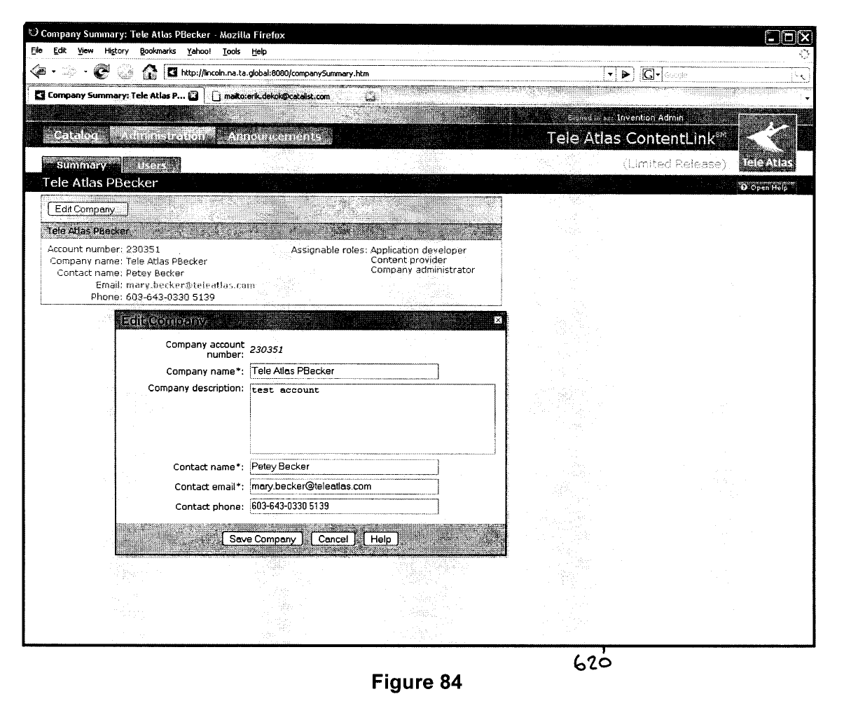

FIG. 84 shows screenshot 620 of a POI content portal in accordance with an embodiment that allows a Company Administrator to access a dialog that allows the Company Administrator to edit their company information.

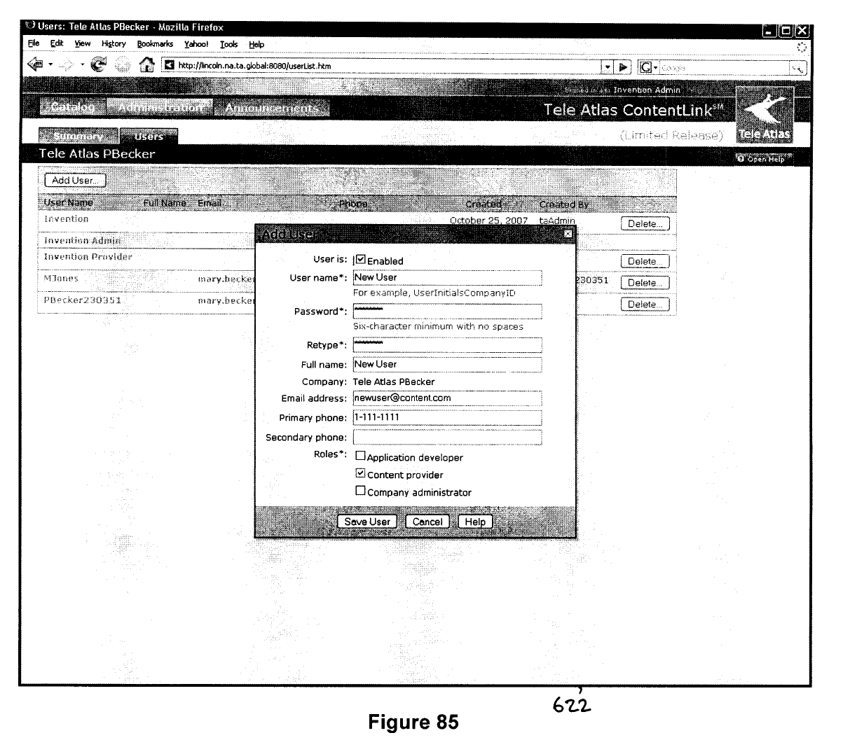

FIG. 85 shows screenshot 622 of a POI content portal in accordance with an embodiment that allows a Company Administrator to access a dialog that allows the Company Administrator manage their users within the system.

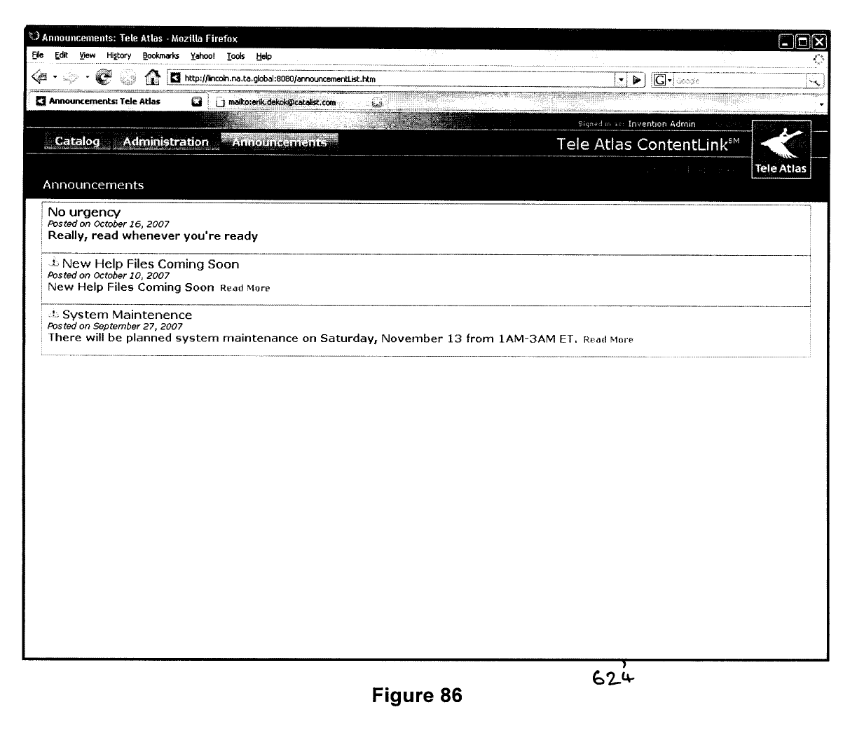

FIGS. 86-88 show screenshots of a POI content portal in accordance with an embodiment that show additional functionality.

FIG. 86 shows screenshot 624 of a POI content portal in accordance with an embodiment that allows all system users to access system announcements.

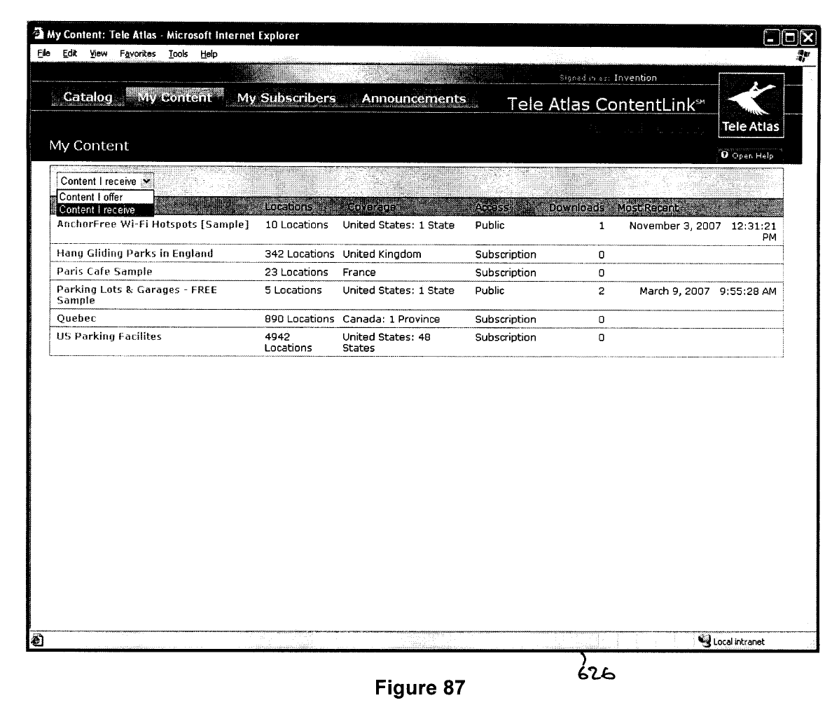

FIG. 87 shows a screenshot 626 in accordance with an embodiment where a user who has both the Content Provider and Application Developer roles has the ability to select a view and interact with content according to role. For example, the user can select the Content Provider role view (in this case, Content I Offer), and create, add, edit and manage the content and subscribers, whereas when the Application Developer role view is selected (in this case, Content I Receive), interaction with the content is limited to read-only access and other role specific restrictions.

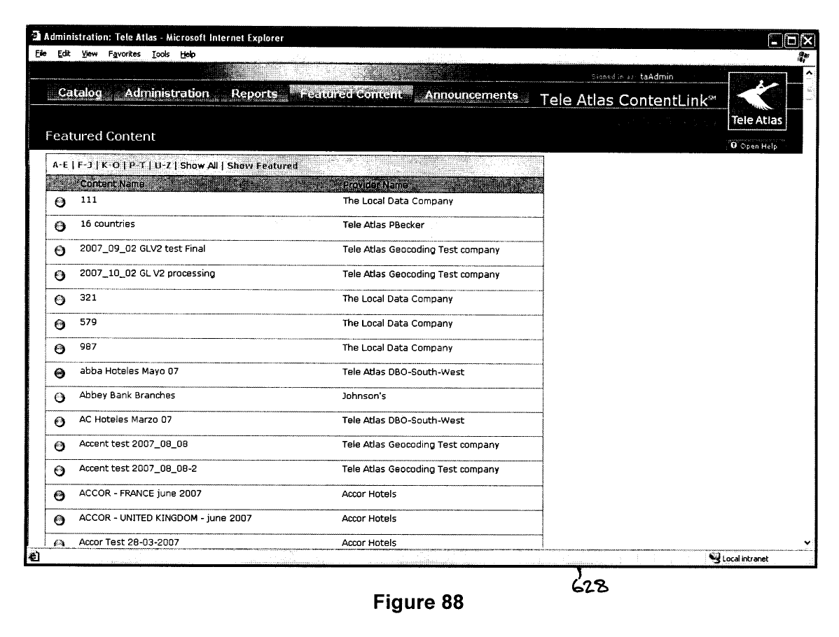

FIG. 88 shows a screenshot 628 in accordance with an embodiment where content can be designated as “Featured” or, in some embodiments, differentiated in a variety of ways to determine order and/or display characteristics in the catalog for the purpose of marketing campaigns or other businesses reasons.

### Additional Features

In accordance with some embodiments, additional features can be incorporated into the system and the portal in addition to those described above. For example, in accordance with an embodiment, the system allows a provider to upload their primary list of locations, and edit locations falling below a provider-determined level of precision by utilizing the POI editor function. The portal application can subsequently generate e-mails with secure map links and send them to additional POI data providers to allow them to tailor their own POI entries. For example, a central retail company can upload it's primary database of store information, but then send emails to individual store managers to solicit feedback from those individual store managers to correct (where appropriate) and augment the provider's master database. When accepted by the Content Provider, such updates and changes then automatically update the content (and its catalog descriptions if coverage and geocode information has changed).

In accordance with some embodiments, the system and the portal support the ability to build custom content data sets on the fly, by the aggregation of multiple content data sets, including the use of de-duplication and categorization tools. The system can provide the functionality to return a customized set of POI from across a selected set of databases for locations around a geographic point, enabling an Application Developer to create specific regional sets of data content.

In accordance with some embodiments, Application Developers can utilize the API functionality for real-time applications, calling upon the portals databases or content data sets, and the location information stored therein, via a web application for dynamic data that is updated on an hourly or even more frequent time-frame. This eliminates the need for downloading and/or regularly updating downloaded content data sets.

### Use Case Scenarios

The following use case scenarios illustrate some practical examples as to how embodiments of the system, together with a centrally accessible POI content portal, can be deployed and used, together with some of the various advantages thereof. It will be evident that additional systems, scenarios, and applications may be envisaged or implemented within the spirit and scope of the invention.

### Scenario 1—The Goodness Food Guide

After 21 years The Goodness Food Guide has became a well-known institution, known for its independent reporting on restaurants. The guide contains approximately 5,000 restaurant entries, together with detailed information, user reports and ratings. The printed guide is updated each year, but the publisher now also publishes more frequent updates online. Users can also contribute their own reports, ratings and photos online. The publisher of the Goodness Food Guide already makes the guide's restaurant listings available in an electronic format to mapping software providers. Until this point, the original Goodness Food Guide data is held in a single flat file database, and the publisher simply makes copies of this database or extracts in a spreadsheet format onto CDs for licensees. The publisher would be very interested in making this data available for use in more mapping and navigation products, but his small team has very limited technical experience, no IT infrastructure and little desire to make the investments required to become an online provider of POI data.

In accordance with an embodiment, the present system can allow the Goodness Food Guide team to upload its current flat file database to the portal environment, without any data model modifications, and make use of the geocoding facility at the portal. Application partners interested in the data can simply download the database in its entirety for use in their software. Using the portal's customer-facing Web Service APIs, application partners can also allow their software to perform real-time queries against the Goodness Food Guide data inside the portal environment.

### Scenario 2—Big Oil Company

Big Oil Company's Internet development team understands the importance of helping customers find gas stations along their travel route. In fact, improving the existing gas station finder on the Internet web site is the most frequent request received by the Internet team from its customer base and gas station owners. With the rapid growth of the personal navigation market, Big Oil Company is looking for ways to provide gas station locations to users of automobile navigation solutions, not just Internet users visiting the Big Oil website. In absence of a more elegant solution, the current approach only provides for simple transfer of data, for example providing a website where users can download a navigation file or a document that contains a list of the 500+ Big Oil gas stations.

In accordance with an embodiment, the centrally accessible POI content portal allows the Big Oil Company Internet team to maintain a flat file database in-house with all its gas stations recorded therein, together with attributes such as opening hours and products offered. This database can be synchronized with the database in the portal to enable software application partners to include the latest data in their own applications.

### Scenario 3—POI Datashare

POI Datashare is an online community of navigation enthusiasts that collect and share POIs amongst themselves and with the general public, for use with popular navigation solutions.

In accordance with an embodiment, moderators of POI communities such as POI Datashare can replicate their own data stores on the content portal and use the portal's geocoding and categorization to improve the quality and normalization of their data. They can also benefit from the increased visibility of their data to application providers, as enabled by the content catalogue.

### Scenario 4—Business Knowledge Inc.

Business Knowledge Inc. is a well-known provider of business listings in North America. They are a sophisticated user of database technology and other software systems. Although their data quality standards are high, they do not have a great deal of domain expertise in mapping solutions and therefore struggle to understand and deal with the specific map referencing and categorization requirements of data consumers.

In accordance with an embodiment, Business Knowledge Inc. can use the portal's geocoding service to ensure that their business listings are accurately referenced to the latest version of the base map. They can also use the portal's categorization scheme to migrate their larger database of listings into a classification model that makes better sense to other interested parties and Application Developers. Application Developers can then merge or supplement the data made available by Business Knowledge with business listings from other content suppliers. Publishing their data offerings in the catalogue also improves the visibility and discoverability of Business Knowledge data for potential development partners outside the US who might not otherwise be familiar with Business Knowledge Inc. as a company.

### Scenario 5—Top Atlas

Top Atlas is a Content Provider and a provider of digital base maps or files-of-reference. In addition to supplying a road network database, Top Atlas provides application partners with a variety of “additional” content. Some of this content is resold by Top Atlas, but in other cases Top Atlas adds value to the content (for example by adding verification, geocoding, normalization, etc.). Top Atlas has many of the same issues as other Content Providers—inefficient delivery logistics, difficulties in presenting the various offerings to partners, etc.

In accordance with an embodiment, the content portal can be used to market data offerings (via the catalog) and deliver data to software development partners (via data download). In some embodiments the portal can also expose Top Atlas point data via Web Service APIs, for direct consumption by partner applications.

The present invention can be conveniently implemented using a conventional general purpose or a specialized digital computer or microprocessor programmed according to the teachings of the present disclosure, as will be apparent to those skilled in the computer art. Appropriate software coding can readily be prepared by skilled programmers based on the teachings of the present disclosure, as will be apparent to those skilled in the software art. The invention can also be implemented by the preparation of application specific integrated circuits or by interconnecting an appropriate network of conventional component circuits, as will be readily apparent to those skilled in the art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD ROMs, microdrive, and magneto optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software can include, but is not limited to, device drivers, operating systems, and user applications. Ultimately, such computer readable media further includes software for performing the present invention, as described above.

The foregoing description of the present invention has been provided for the purposes of illustration and description. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for providing a centrally accessible portal for use by multiple participants in sharing geographic point of interest (POI) content, comprising:
a computer server and a database that contains point of interest (POI) content for sharing by participants, including Content Providers and Application Developers; a portal application that runs on the system and which is accessible to the Content Providers and the Application Developers, wherein the portal application provides a catalog of POI content stored in the database;
a content link interface that allows the Content Providers to access the portal to upload and edit sets of POI content to the database, and also allows the Application Developers to access the portal to retrieve and access sets of POI content from the database;
a categorization engine or service that defines a common taxonomy for assigning categories to POI content;
a geocoding engine or service that can be optionally used to geocode POI content; and
a subscription data that specifies subscriptions by the Application Developers to the sets of POI content, and enables the system to share POI content between the participants in accordance with the subscriptions.

2. The system of claim 1, wherein the portal application runs on the computer server as a Web application and is accessible by the participants using an Internet HTTP protocol and a Web browser.

3. The system of claim 1 wherein the portal application that provides a catalog of the sets of POI content stored in the database also includes a plurality of subcatalogs corresponding to different ones of the sets of POI content uploaded by the Content Providers to the database.

4. The system of claim 1 wherein the content link interface includes an Application Developers interface that allows the Application Developers to search for and to retrieve particular sets of POI content from the database, for subsequent incorporation into software applications being developed by the Application Developers.

5. The system of claim 1 wherein each set of POI content uploaded by the content provider participants includes data for multiple geographic locations, including attributes of each location, and where applicable multiple points of entry for that location.

6. The system of claim 1 wherein the geocoding engine or service is automatically invoked to geocode each location data in content data sets that are being uploaded by a content provider, and record the geocoded information together with the location in the database.

7. The system of claim 1 wherein the subscription data is used by the system to determine if and when to automatically communicate or send updated location information to those Application Developers who have subscribed to a particular content data set.

8. The system of claim 1 wherein each content data set includes location information of varying levels of precision, and wherein upon being uploaded the content data set is stored in the database at a predefined level of precision, and wherein additional attributes can then be added to each location by the content provider, to increase the precision of the information for that location.

9. A method for a providing a centrally accessible portal for use by multiple participants in sharing geographic point of interest (POI) content, comprising the steps of:
providing a computer server and a database that contains point of interest (POI) content for sharing by participants, including Content Providers and Application Developers;
providing access to a portal application that runs on the system and which is accessible to the Content Providers and the Application Developers, wherein the portal application provides a catalog of POI content stored in the database;
providing a content link interface that allows the Content Providers to access the portal to upload and edit sets of POI content to the database, and also allows the Application Developers to access the portal to retrieve and access sets of POI content from the database;
defining a common taxonomy for assigning categories to POI content; optionally geocoding some or all of the POI content; and
storing a subscription data that specifies subscriptions by the Application Developers to the sets of POI content, and allows for sharing of POI content between the participants in accordance with the subscriptions.

10. The method of claim 9, wherein the portal application runs on the computer server as a Web application and is accessible by the participants using an Internet HTTP protocol and a Web browser.

11. The method of claim 9 wherein the portal application that provides a catalog of the sets of POI content stored in the database also includes a plurality of subcatalogs corresponding to different ones of the sets of POI content uploaded by the Content Providers to the database.

12. The method of claim 9 wherein the content link interface includes an Application Developers interface that allows the Application Developers to search for and to retrieve particular sets of POI content from the database, for subsequent incorporation into software applications being developed by the Application Developers.

13. The method of claim 9 wherein each set of POI content uploaded by the content provider participants includes data for multiple geographic locations, including attributes of each location, and where applicable multiple points of entry for that location.

14. The method of claim 9 wherein the geocoding engine or service is automatically invoked to geocode each location data in content data sets that are being uploaded by a content provider, and record the geocoded information together with the location in the database.

15. The method of claim 9 wherein the subscription data is used by the system to determine if and when to automatically communicate or send updated location information to those Application Developers who have subscribed to a particular content data set.

16. The method of claim 9 wherein each content data set includes location information of varying levels of precision, and wherein upon being uploaded the content data set is stored in the database at a predefined level of precision, and wherein additional attributes can then be added to each location by the content provider, to increase the precision of the information for that location.

17. A system for storing geographic point of interest (POI) content, comprising: a computer server and a database that contains point of interest (POI) content for sharing by a plurality of participants, including Content Providers and Application Developers;
a content link interface that allows the Content Providers to access the portal and to upload and edit sets of POI content to the database, and also allows the Application Developers to access the portal and to retrieve sets of POI content from the database;
a categorization engine or service that defines a common taxonomy for assigning categories to a POI;
a portal application that runs on the system and which is accessible to the participants, including the Content Providers and the Application Developers, and allows users to store data according to the common taxonomy.

18. A system for validating geographic point of interest (POI) content, comprising:
a computer server and a database that contains point of interest (POI) content;
a software application together with a graphical user interface that allows a content provider to upload, view, and edit POI content to the database, including a map display for viewing POI locations together with their POI attributes and other information;
a geocoding engine or service that can be invoked by the content provider to geocode the POI content uploaded by the content provider, and display a measure of the quality regarding the POI location information, as determined by comparing the original POI location information with the output of the geocoding engine; and wherein the original POI location is displayed on the map, together with the output of the geocoding engine, to assist the content provider to view, validate, and edit the POI content as it will be stored in the database.

19. The system of claim 18, wherein the software application together with a graphical user interface runs on the computer server as a Web application and is accessible by the content provider using an Internet HTTP protocol and a Web browser.

20. The system of claim 18, wherein the map display for viewing POI locations together with their POI attributes and other information displays for a POI location being validated both a before or uncorrected location on the map, and also the same POI location in an after or corrected location on the map, and allows the content provider to review the proposed correction, and as appropriate accept or reject it.

21. A system for accessing geographic point of interest (POI) content in a software application development environment, comprising:
a computer server and a database that contains point of interest (POI) content;
a portal application that runs on the system and which is accessible to Application Developers, wherein the portal application provides a catalog of the POI content stored in the database, and allows the Application Developers to create subscriptions to selected sets of POI content;
a subscription data that specifies the subscriptions created by the Application Developers to the selected sets of POI content, and which is used by the system to automatically provide the POI content to the Application Developers in accordance with the subscriptions, including whenever the POI content is modified or otherwise edited.

22. The system of claim 21, wherein the portal application runs on the computer server as a Web application and is accessible by the Application Developers using an Internet HTTP protocol and a Web browser.

23. The system of claim 21, wherein the system includes an API, and wherein the POI content is automatically provided to the Application Developers in accordance with the subscriptions by specifying in those software applications that the content be dynamically retrieved using the API.
